(19) United States
(12) Patent Application Publication
(10) Pub. No.: US 2023/0099762 A1
(43) Pub. Date: Mar. 30, 2023

(54) Timing Advance Reporting in Non-Terrestrial Networks

(71) Applicant: Comcast Cable Communications, LLC, Philadelphia, PA (US)

(72) Inventors: Mohammad Ghadir Khoshkholgh Dashtaki, Burnaby, British Columbia (CA); Ali Cagatay Cirik, Chantilly, VA (US); Esmael Hejazi Dinan, McLean, VA (US); Hyoungsuk Jeon, Centreville, VA (US)

(21) Appl. No.: 17/956,959

(22) Filed: Sep. 30, 2022

Related U.S. Application Data
(60) Provisional application No. 63/250,360, filed on Sep. 30, 2021.

(51) Int. Cl. H04W 56/00; H04W 72/12

(52) U.S. Cl. CPC H04W 56/001; H04W 72/1205

(57) ABSTRACT

Timing advance (TA) reporting may be used in wireless communications. TA reporting information may be provided by a wireless device to align timing between the wireless device and a base station, such as in a non-terrestrial network. TA reporting information may be sent via a scheduling report (SR) procedure, a buffer status report (BSR) procedure, and/or a random access (RA) procedure. To avoid unnecessary transmissions of TA reporting information, TA reporting may be canceled based on one or more of a receipt of a timing offset and/or an expiration of a timer.

### CROSS-REFERENCE TO RELATED APPLICATIONS

This application claims the benefit of U.S. Provisional Application No. 63/250,360, filed on Sep. 30, 2021. The above referenced application is hereby incorporated by reference in its entirety.

### BACKGROUND

Timing advance (TA) is used by a wireless device while the wireless device communicates with a base station. A wireless device determines a device-specific TA value that is applied specifically to that wireless device. The wireless device sends, to the base station, information associated with the device-specific TA value.

### SUMMARY

The following summary presents a simplified summary of certain features. The summary is not an extensive overview and is not intended to identify key or critical elements.

A wireless device may be synchronized (e.g., time aligned) with a base station by using a timing advance (TA). In at least some wireless communications, such as in a non-terrestrial network (NTN), TA reporting information associated with a current TA (e.g., device-specific TA) may be sent (e.g., by a wireless device) via a TA reporting procedure. The TA reporting information may be used (e.g., by a base station) to determine a timing offset. The timing offset may be provided to the wireless device to facilitate determination of an updated TA and/or an uplink timing (e.g., either/both of which may be used by the wireless device for transmission of uplink signals). Rather than continuing TA reporting (e.g., indefinitely and/or after a TA may no longer be valid), a timer may be started based on a TA reporting procedure being triggered. The TA reporting procedure may be completed and/or canceled, for example, based on a timing offset being received and/or the timer expiring. In this way, a wireless device may avoid sending TA reporting information unnecessarily and may therefore reduce power consumption and/or reduce interference to other wireless devices. Additionally or alternatively, a scheduling request (SR) procedure for TA reporting may be used to facilitate TA reporting. For example, at least one SR configuration parameter may correspond to TA reporting such that an SR may be used for sending TA reporting information without triggering a buffer status report (BSR) procedure. Using an SR procedure to send TA reporting information may provide advantages such as reduced overhead and/or reduced delay in TA reporting information transmission.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17 shows examples of various downlink control information (DCI) formats.

FIG. 18 shows examples of physical downlink shared channel (PDSCH) processing time.

FIG. 19 shows examples of physical uplink shared channel (PUSCH) preparation/processing time.

FIG. 20 shows an example of a random access (RA) procedure.

FIG. 21 shows various non-terrestrial network (NTN) examples.

FIG. 22 shows example communications in an NTN.

FIG. 23 shows examples of various propagation delays.

FIG. 24 shows an example of time advance (TA) reporting in an NTN.

FIG. 25 shows an example of TA reporting.

FIG. 26 shows an example TA reporting.

FIG. 27 shows an example of TA reporting.

FIG. 28 shows an example of TA reporting.

FIG. 29 shows an example of TA reporting.

FIG. 30 shows an example of TA reporting.

FIG. 31 shows an example of TA reporting.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems, which may be used in the technical field of multicarrier communication systems. More particularly, the technology disclosed herein may relate to a small data transmission (SDT) procedure for wireless communication.

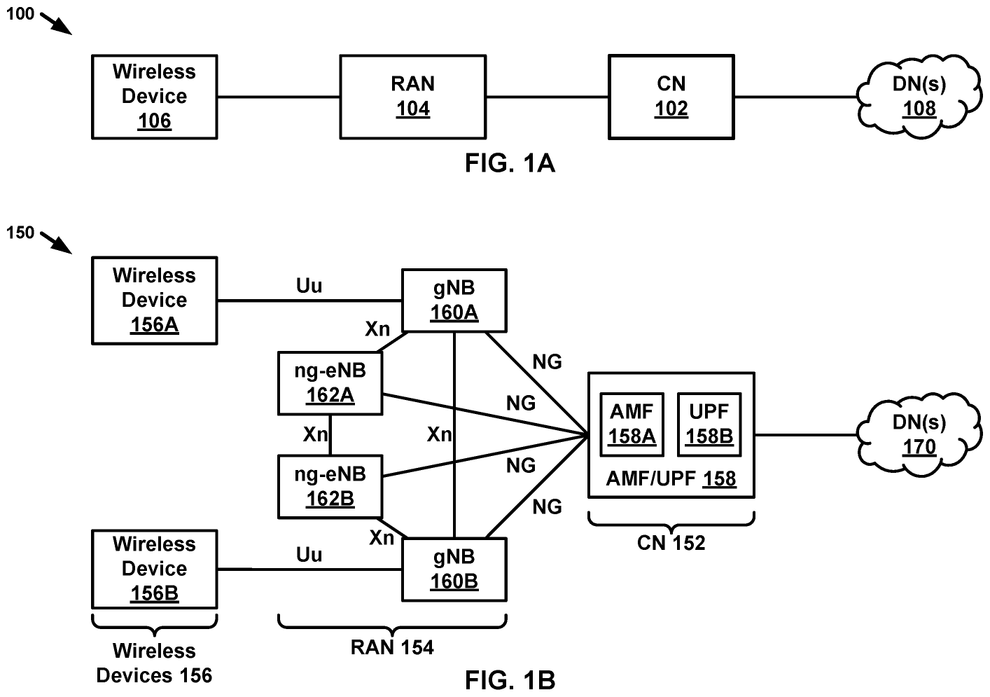

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNs (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a gNB, an ng-eNB, a relay node (e.g., an integrated access and backhaul (JAB) node), a donor node (e.g., a donor eNB, a donor gNB, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRHs), a repeater node or relay node used to extend the coverage area of a donor node, a Next Generation Evolved Node B (ng-eNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNs (e.g., the Internet), private DNs, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QoS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng eNBs comprising an ng-eNB 162A and an ng-eNB 162B (collectively ng eNBs 162)). The RAN 154 may comprise one or more of any quantity of types of base station. The gNBs 160 and ng eNBs 162 may be referred to as base stations. The base stations (e.g., the gNBs 160 and ng eNBs 162) may comprise one or more sets of antennas for communicating with the wireless device(s) 156 wirelessly (e.g., an over an air interface). One or more base stations (e.g., the gNBs 160 and/or the ng eNBs 162) may comprise multiple sets of antennas to respectively control multiple cells (or sectors). The cells of the base stations (e.g., the gNBs 160 and the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

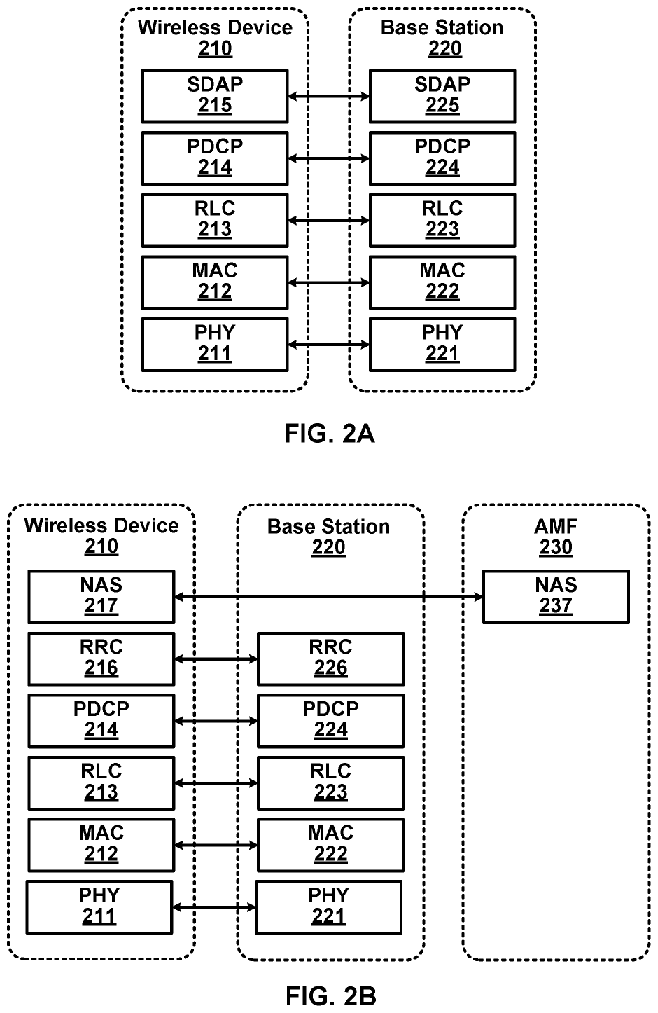

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

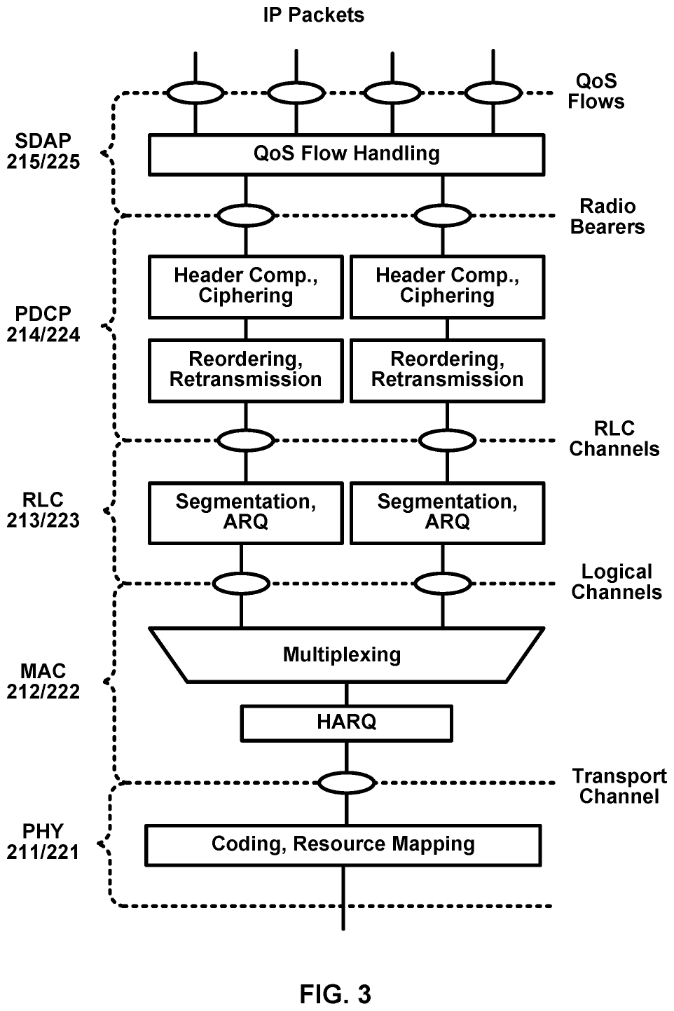

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QoS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted over the air interface, ciphering/deciphering to prevent unauthorized decoding of data transmitted over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

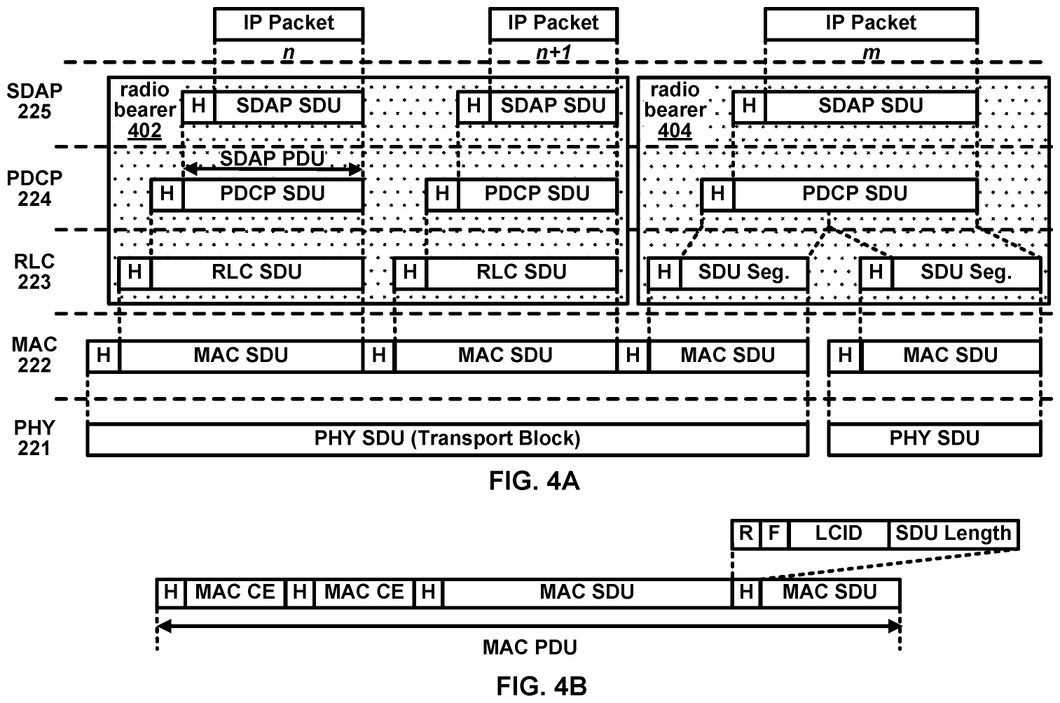

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 223 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

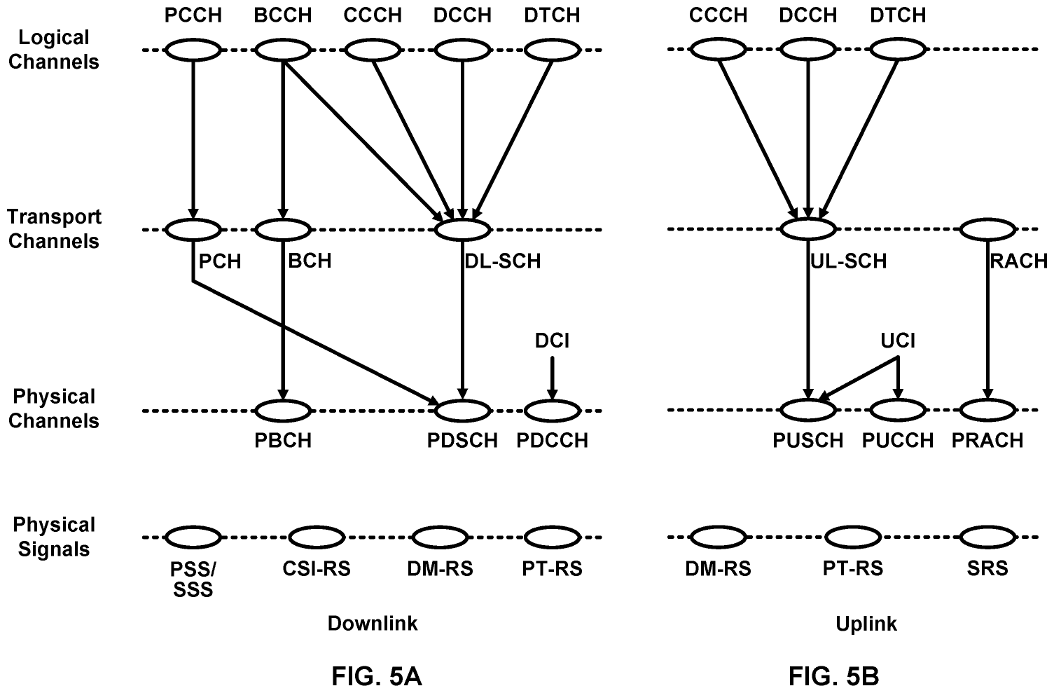

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

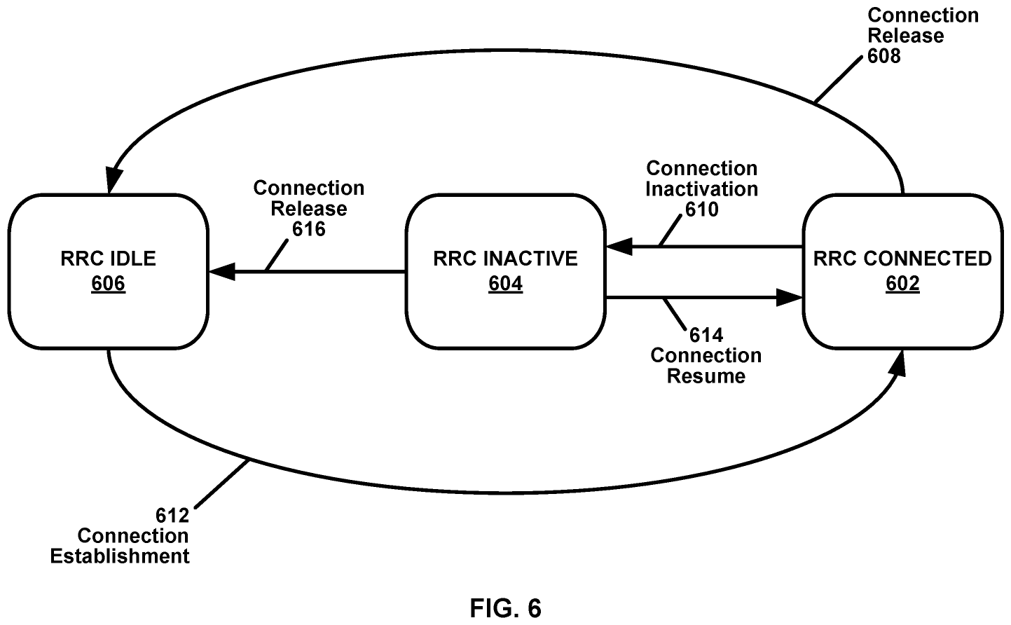

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by a RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 606) via a connection release procedure 608. The RRC state may transition from the RRC connected state (e.g., RRC connected 602) to the RRC inactive state (e.g., RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., each discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be the same as or similar to connection release procedure 608.

An RRC state may be associated with a mobility management mechanism. During the RRC idle state (e.g., RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC idle state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the UE registration area, for example, if the wireless device moves (e.g., via a cell reselection) to a cell associated with a TAI that may not be included in the list of TAIs associated with the UE registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 604).

A base station (e.g., gNBs 160 in FIG. 1B or any other base station) may be split in two parts: a central unit (e.g., a base station central unit, such as a gNB CU) and one or more distributed units (e.g., a base station distributed unit, such as a gNB DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbols may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

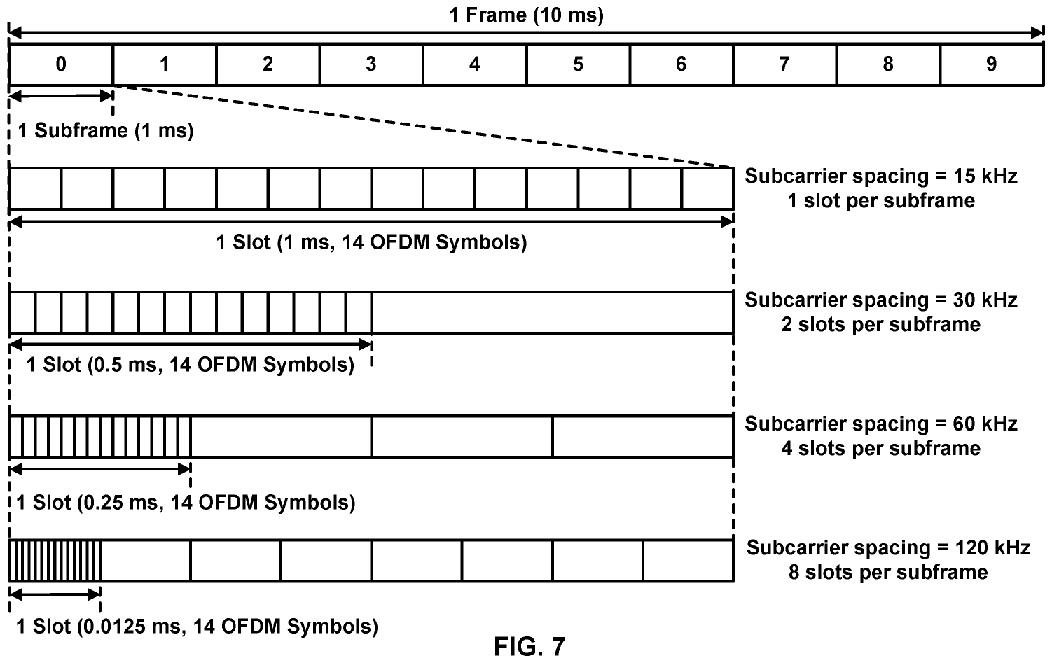

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

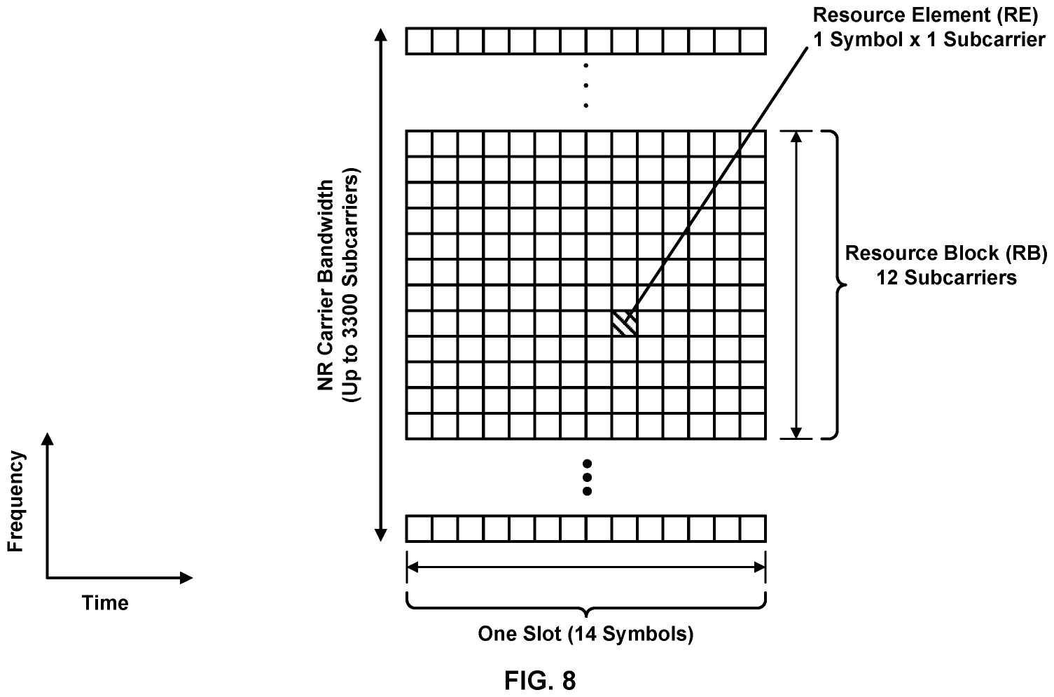

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, after (e.g., based on or in response to) receiving DCI indicating the second BWP as an active BWP. A wireless device may switch an active BWP from a first BWP to a second BWP, for example, after (e.g., based on or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

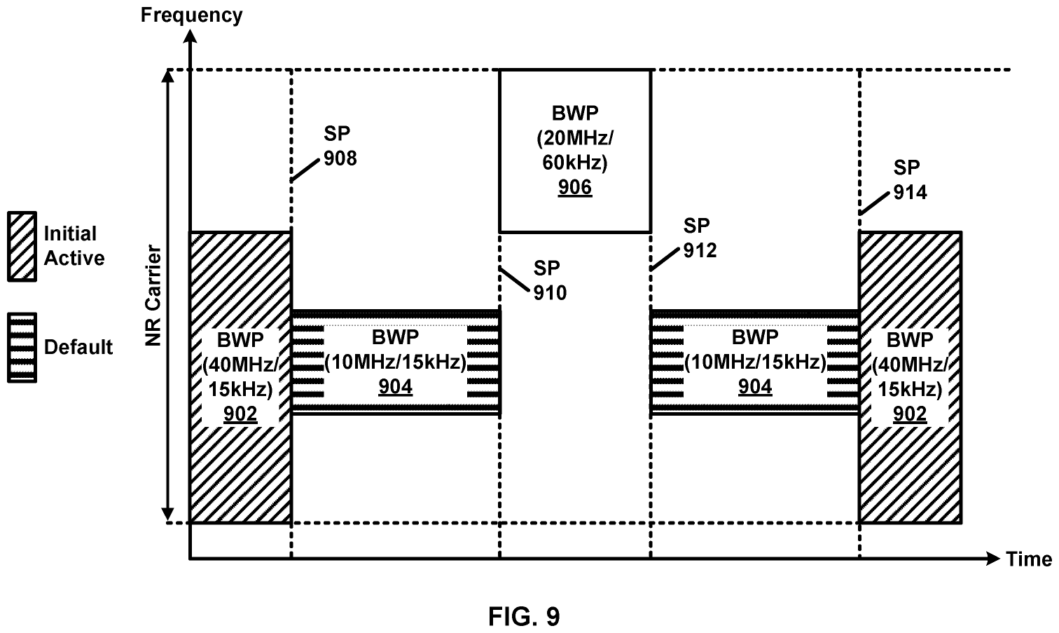

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, after (e.g., based on or in response to) an expiry of a BWP inactivity timer (e.g., indicating switching to the default BWP). The switching at the switching point 908 may occur, for example, after (e.g., based on or in response to) receiving DCI indicating BWP 904 as the active BWP. The wireless device may switch at a switching point 910 from an active BWP 904 to the BWP 906, for example, after or in response receiving DCI indicating BWP 906 as a new active BWP. The wireless device may switch at a switching point 912 from an active BWP 906 to the BWP 904, for example, after (e.g., based on or in response to) an expiry of a BWP inactivity timer. The wireless device may switch at the switching point 912 from an active BWP 906 to the BWP 904, for example, after or in response receiving DCI indicating BWP 904 as a new active BWP. The wireless device may switch at a switching point 914 from an active BWP 904 to the BWP 902, for example, after or in response receiving DCI indicating the BWP 902 as a new active BWP.

Wireless device procedures for switching BWPs on a secondary cell may be the same/similar as those on a primary cell, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

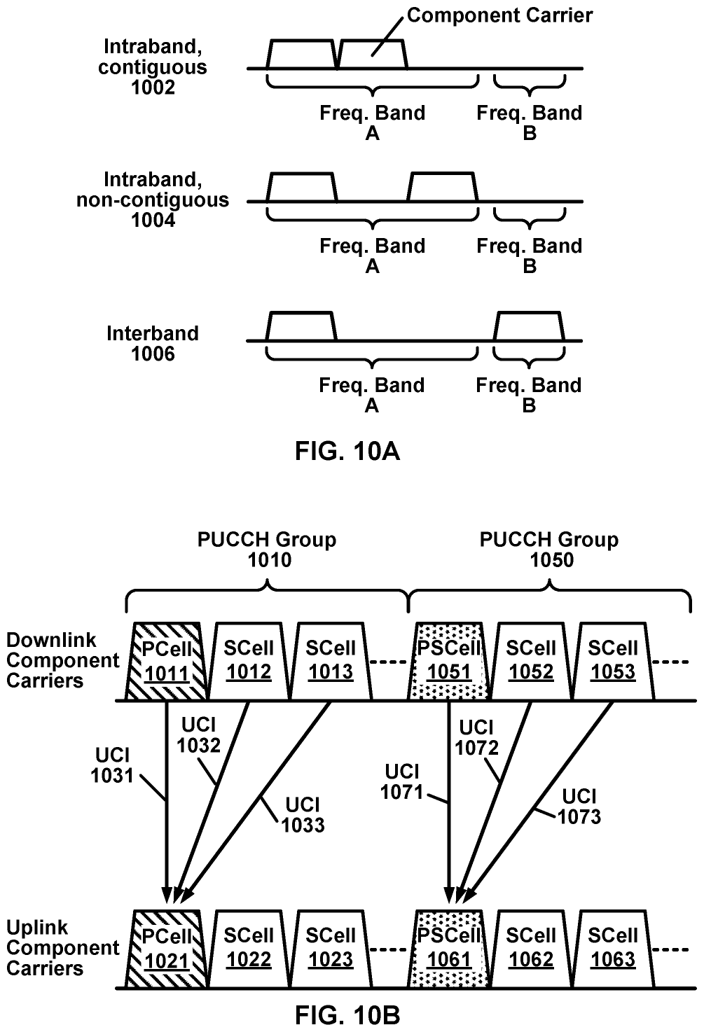

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, after (e.g., based on or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

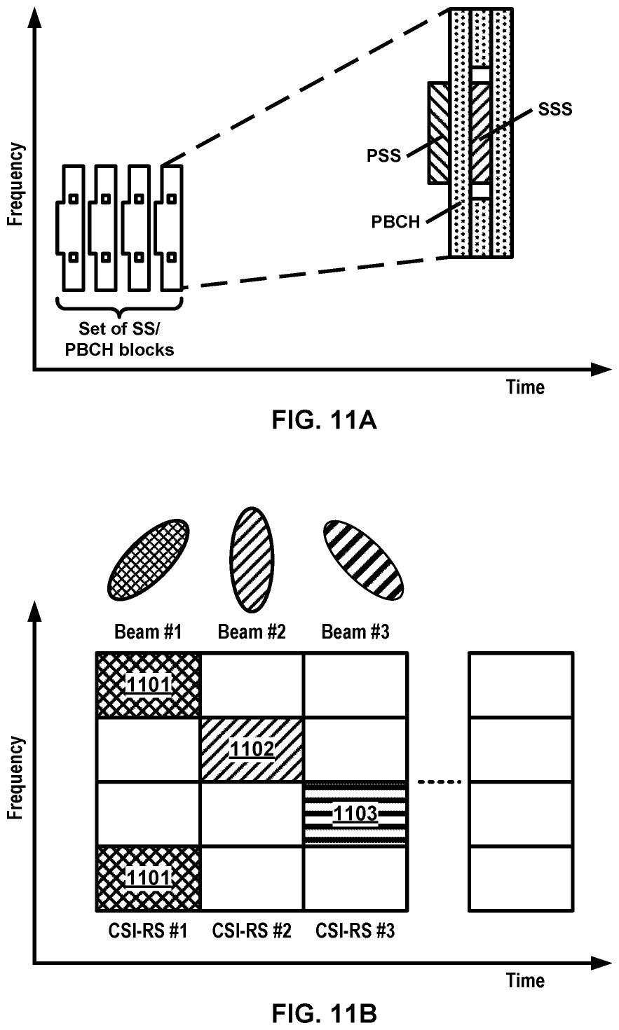

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indexes. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO). A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in an SRS resource set of the one or more SRS resource sets (e.g., with the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as quasi co-located (QCLed), for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

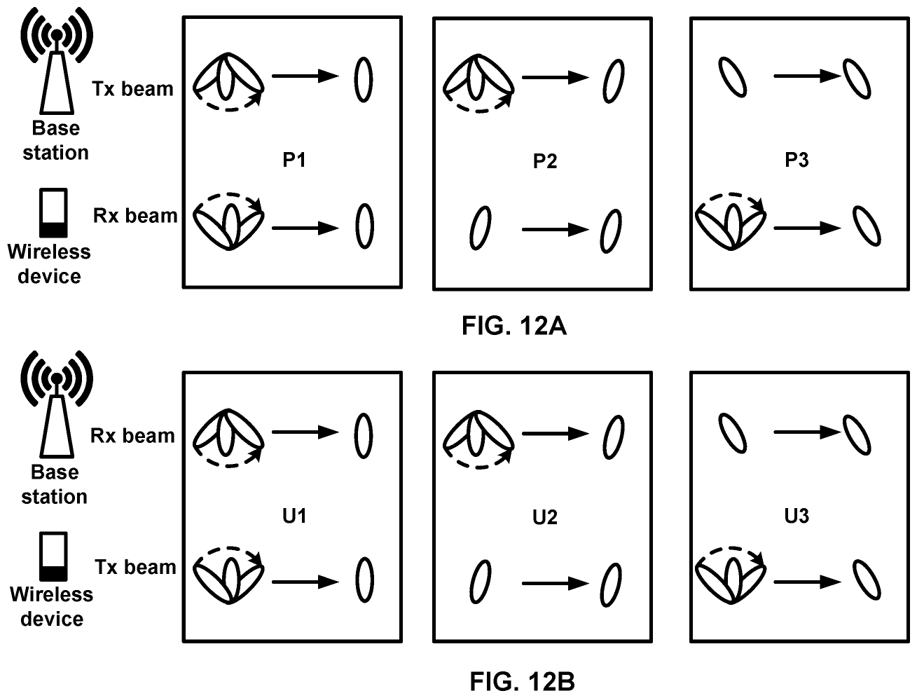

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the UE uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more system information blocks (SIBs) (e.g., other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

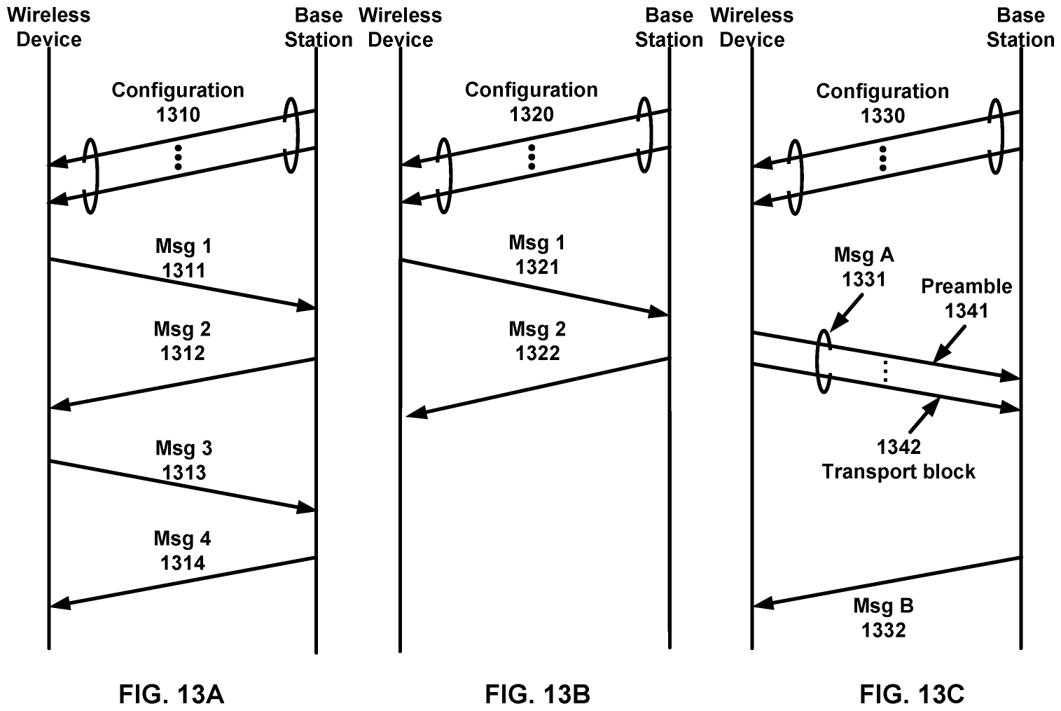

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received after (e.g., based on or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, after (e.g., based on or in response to) the sending/sending (e.g., transmitting) of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/sending (e.g., transmitting) the first message (e.g., Msg 11311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. Radio network temporary identifiers (RNTIs) may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

RA-RNTI=1+s_id+14×t_id+14×80×f_id+14×80×8×ul_carrier_id

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, after (e.g., based on or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, after (e.g., based on or in response to) the sending/sending (e.g., transmitting) of the third message (e.g., Msg 3 1313). The base station may address the wireless on the PDCCH (e.g., the base station may send the PDCCH to the wireless device) using a C-RNTI, for example, If the C-RNTI was included in the third message (e.g., Msg 3 1313). The random access procedure may be determined to be successfully completed, for example, if the unique C RNTI of the wireless device is detected on the PDCCH (e.g., the PDCCH is scrambled by the C-RNTI). fourth message (e.g., Msg 4 1314) may be received using a DL-SCH associated with a TC RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 11311) and/or the third message (e.g., Msg 3 1313)) may remain on, or may be performed via, the selected carrier. The wireless device may switch an uplink carrier during the random access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, after (e.g., based on or in response to) sending (e.g., transmitting) the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending (e.g., transmitting) a beam failure recovery request (e.g., the window may start any quantity of symbols and/or slots after sending (e.g., transmitting) the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, after (e.g., based on or in response to) sending (e.g., transmitting) first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1331 may be sent/transmitted in an uplink transmission by the wireless device. Msg A 1331 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, after (e.g., based on or in response to) sending (e.g., transmitting) the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCI messages may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCI messages with one or more DCI formats, for example, depending on the purpose and/or content of the DCI messages. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

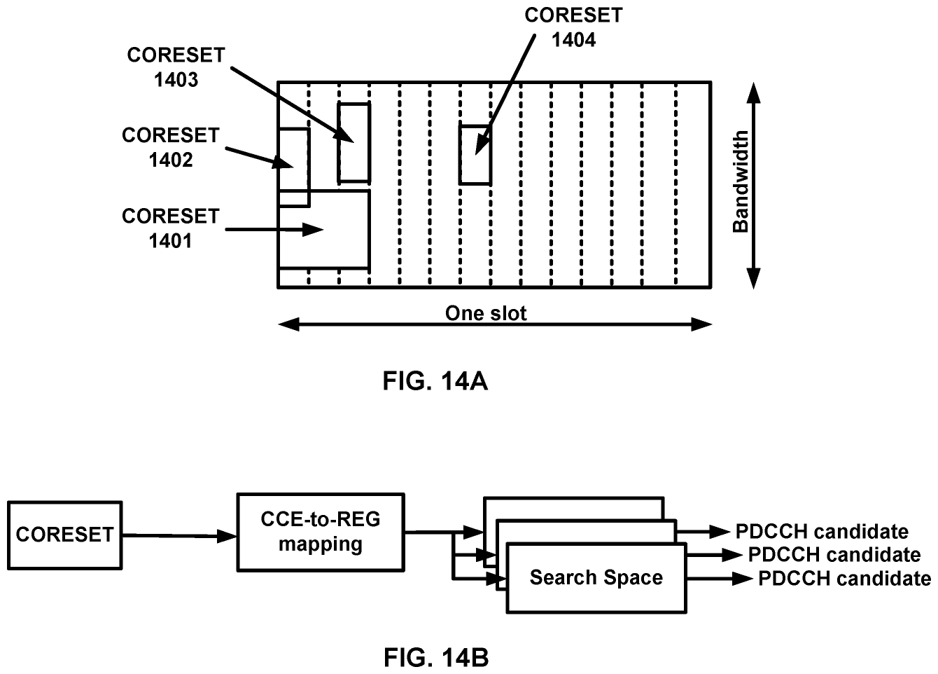

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCI messages. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the number of CCEs, the number of PDCCH candidates in common search spaces, and/or the number of PDCCH candidates in the wireless device-specific search spaces) and possible (or configured) DCI formats. The decoding may be referred to as blind decoding. The wireless device may determine DCI as valid for the wireless device, for example, after (e.g., based on or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, after (e.g., based on or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a number of OFDM symbols (e.g., between four and fourteen OFDM symbols) and may comprise two or fewer bits. The wireless device may use PUCCH format 1, for example, if the transmission is over/via four or more symbols and the number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

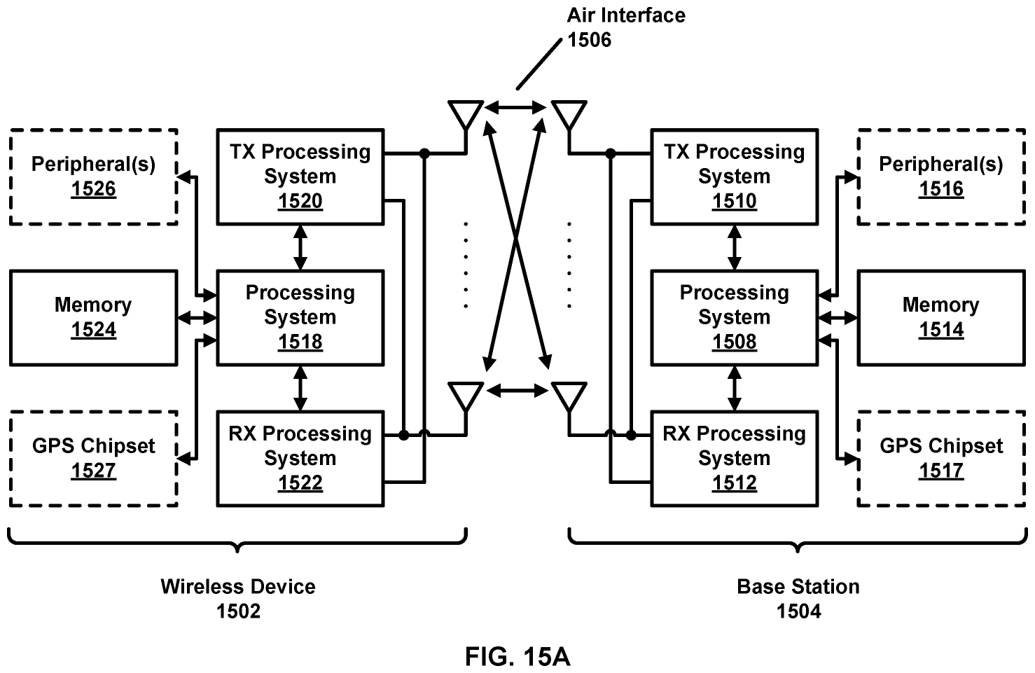

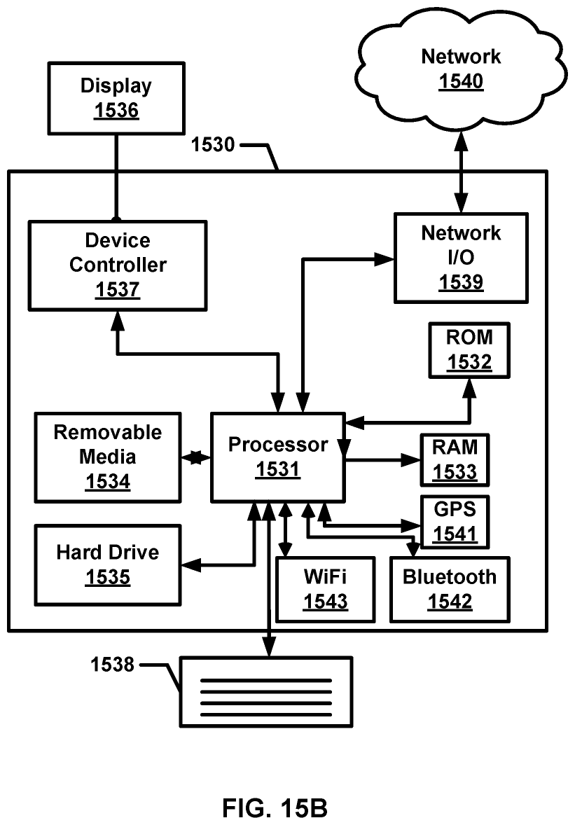

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For sending/transmission processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, and/or 1504, the wireless device 106, 156A, 156B, 210, and/or 1502, or any other base station, wireless device, AMF, UPF, network device, or computing device described herein. The computing device 1530 may include one or more processors 1531, which may execute instructions stored in the random-access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

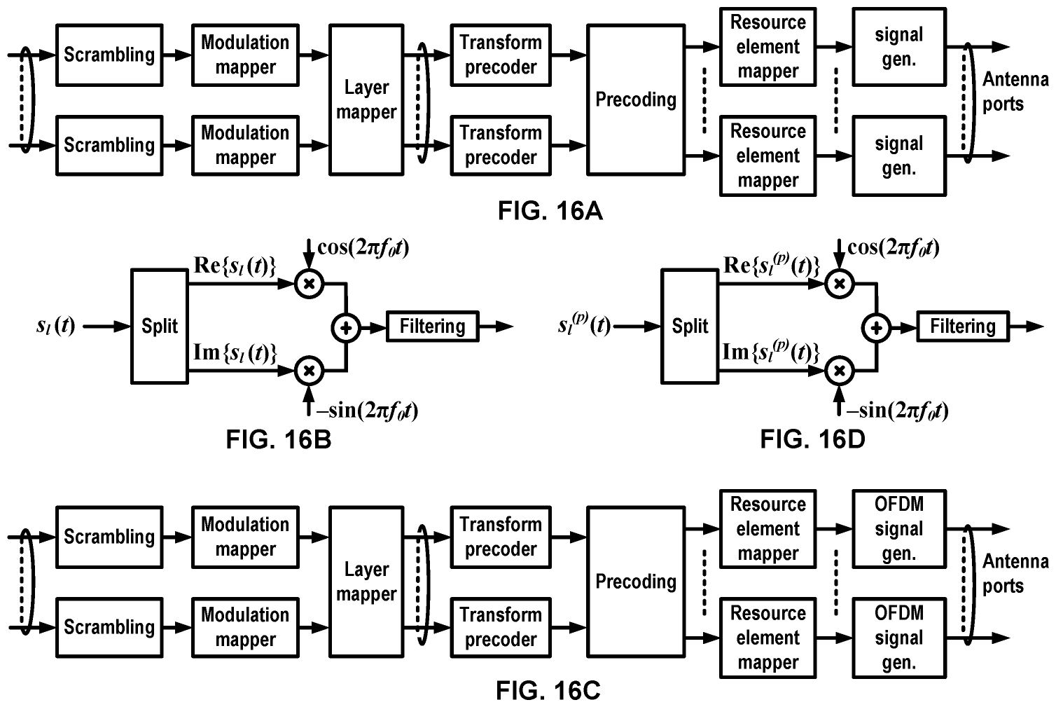

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, if it is started, and continue running until it is stopped or until it expires. A timer may be started, for example, if it is not running or restarted if it is running. A timer may be associated with a value (e.g., the timer may be started or restarted from a value or may be started from zero and expire if it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit. In an example, a MAC SDU may be included in a MAC PDU from the first bit onward. A MAC control element (CE) may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format filed (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of a base station may transmit one or more MAC CEs to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, a secondary cell (SCell) activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of a base station to a MAC entity of a wireless device, may have an LCID in the MAC subheader corresponding to the MAC CE. Different MAC CE may have different LCID in the MAC subheader corresponding to the MAC CE. For example, an LCID given by 111011 in a MAC subheader may indicate that a MAC CE associated with the MAC subheader is a long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a short truncated BSR, and/or a long truncated BSR. In an example, a MAC CE may have an LCID in the MAC subheader corresponding to the MAC CE. Different MAC CE may have different LCID in the MAC subheader corresponding to the MAC CE. For example, an LCID given by 111011 in a MAC subheader may indicate that a MAC CE associated with the MAC subheader is a short-truncated command MAC CE. For example, semi-persistent reporting on PUCCH, the PUCCH resource used for sending (e.g., transmitting) a CSI report may be configured by reportConfigType. Semi-persistent reporting on PUCCH may be activated by a MAC CE activation command for selecting one of the semi-persistent Reporting Settings for use by the wireless device on the PUCCH.

In carrier aggregation (CA), two or more component carriers (CCs) may be aggregated. A wireless device may simultaneously receive or transmit on one or more CCs, depending on capabilities of the wireless device, using the technique of CA. In an example, a wireless device may support CA for contiguous CCs and/or for non-contiguous CCs. CCs may be organized into cells. For example, CCs may be organized into one primary cell (PCell) and one or more SCells. When configured with CA, a wireless device may have one RRC connection with a network. In an example, a base station may transmit, to a wireless device, one or more messages comprising configuration parameters of a plurality of one or more SCells, depending on capabilities of the wireless device. When configured with CA, a base station and/or a wireless device may employ an activation/deactivation mechanism of an SCell to improve battery or power consumption of the wireless device. When a wireless device is configured with one or more SCells, a base station may activate or deactivate at least one of the one or more SCells. Upon configuration of an SCell, the SCell may be deactivated unless an SCell state associated with the SCell is set to “activated” or “dormant.” A wireless device may activate/deactivate an SCell in response to receiving an SCell Activation/Deactivation MAC CE.

A base station may configure a wireless device with uplink (UL) bandwidth parts (BWPs) and downlink (DL) BWPs to enable bandwidth adaptation (BA) on a PCell. If carrier aggregation is configured, the base station may further configure the wireless device with at least DL BWP(s) (i.e., there may be no UL BWPs in the UL) to enable BA on an SCell. For the PCell, an initial active BWP may be a first BWP used for initial access. In paired spectrum (e.g., FDD), a base station and/or a wireless device may independently switch a DL BWP and an UL BWP. In unpaired spectrum (e.g., TDD), a base station and/or a wireless device may simultaneously switch a DL BWP and an UL BWP.

In an example, a base station and/or a wireless device may switch a BWP between configured BWPs by means of a DCI or a BWP invalidity timer. When the BWP invalidity timer is configured for a serving cell, the base station and/or the wireless device may switch an active BWP to a default BWP in response to an expiry of the BWP invalidity timer associated with the serving cell. The default BWP may be configured by the network. In an example, for FDD systems, when configured with BA, one UL BWP for each uplink carrier and one DL BWP may be active at a time in an active serving cell. In an example, for TDD systems, one DL/UL BWP pair may be active at a time in an active serving cell. Operating on the one UL BWP and the one DL BWP (or the one DL/UL pair) may improve wireless device battery consumption. BWPs other than the one active UL BWP and the one active DL BWP that the wireless device may work on may be deactivated. On deactivated BWPs, the wireless device may: not monitor PDCCH; and/or not transmit on PUCCH, PRACH, and UL-SCH. In an example, a MAC entity may apply normal operations on an active BWP for an activated serving cell configured with a BWP comprising: sending (e.g., transmitting) on UL-SCH; sending (e.g., transmitting) on RACH; monitoring a PDCCH; sending (e.g., transmitting) PUCCH; receiving DL-SCH; and/or (re-)initializing any suspended configured uplink grants of configured grant Type 1 according to a stored configuration, if any. In an example, on an inactive BWP for each activated serving cell configured with a BWP, a MAC entity may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

In an example, a set of PDCCH candidates for a wireless device to monitor is defined in terms of PDCCH search space sets. A search space set comprises a common search space (CSS) set or a user search space (USS) set. A wireless device monitors PDCCH candidates in one or more of the following search spaces sets: a TypeO-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a TypeOA-PDCCH CSS set configured by searchSpaceOtherSystemInformation in PDCCH-ConfigCommon for a DCI format with CRC scrambled by a SI-RNTI on the primary cell of the MCG, a Type1-PDCCH CSS set configured by ra-SearchSpace in PDCCH-ConfigCommon for a DCI format with CRC scrambled by a RA-RNTI, a MSGB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, only for the primary cell, C-RNTI, MCS-C-RNTI, or CS-RNTI(s), and a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

In an example, a wireless device may monitor a set of PDCCH candidates according to configuration parameters of a search space set comprising a plurality of search spaces (SSs). The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common SSs, and/or number of PDCCH candidates in the UE-specific SSs) and possible (or configured) DCI formats. The decoding may be referred to as blind decoding.

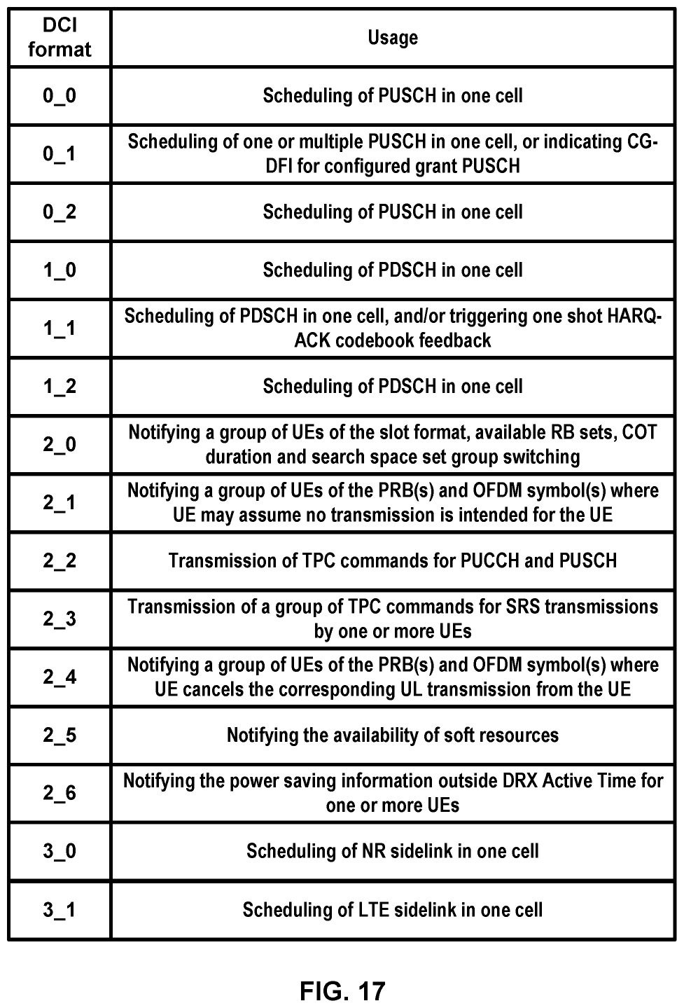

FIG. 17 shows examples of various DCI formats. The various DCI formats may be used, for example, by a base station to send (e.g., transmit) control information to (e.g., a wireless device and/or to be used by the wireless device). The control information may be used for PDCCH monitoring. Different DCI formats may comprise different DCI fields and/or have different DCI payload sizes. Different DCI formats may have different signaling purposes. DCI format 0_0 may be used to schedule PUSCH transmission in one cell. DCI format 0_1 may be used to schedule one or multiple PUSCH transmissions in one cell and/or to indicate configured grant-downlink feedback information (CG-DFI) for configured grant PUSCH transmission, etc. A priority index may be provided by a priority indicator field. A priority index may be provided, for example, if a wireless device monitors, in an active DL BWP, PDCCH for DCI detection (e.g., detection of DCI corresponding to DCI format 0_1, DCI format 1_1, DCI format 0_2, and/or DCI format 1_2). A first DCI format (e.g., DCI format 0_1 and/or a DCI format 0_2) may schedule a PUSCH transmission of any priority, and/or a second DCI format (e.g., DCI format 1_1 and/or a DCI format 1_2) may schedule a PDSCH reception, for example, if a wireless device indicates a capability to monitor, in an active UL BWP, PDCCH for detection of the first DCI format and/or the second DCI format. The second DCI format (e.g., DCI format 1_1 and/or the DCI format 1_2) may trigger a PUCCH transmission with corresponding HARQ-ACK information of any priority. The DCI format 1_1 may trigger a PUCCH transmission with corresponding HARQ-ACK information of any priority.

A wireless device may assume that flexible symbols in a CORESET, configured for the wireless device for PDCCH monitoring, are downlink symbols. The wireless device may assume that the flexible symbols are downlink symbols, for example, if the wireless device does not detect a slot format indicator (SFI) indicator/index field value in DCI (e.g., DCI format 2_0) indicating one or more symbols of a slot as flexible or uplink and/or if the wireless device does not detect DCI (e.g., DCI format 0_0, DCI format 0_1, DCI format 1_0, DCI format 1_1, or DCI format 2_3) indicating to the wireless device to send/transmit an SRS, a PUSCH transmission, a PUCCH transmission, and/or a PRACH transmission in the one or more symbols.

The wireless device may receive a downlink transmission scheduled via DCI. The wireless device may attempt to decode a transport block (TB) that the downlink transmission is carrying. The attempt to decode may be based on receiving a downlink transmission scheduled via a DCI. The attempt to decode may occur, for example, based on (e.g., after) soft combining with previous attempts/receptions of the TB. One or more new downlink transmissions may be scheduled in a same framework with one or more downlink retransmissions. The wireless device may determine whether a downlink transmission is a new transmission or a retransmission, for example, based on a new data indicator (NDI) field in DCI indicating/scheduling the downlink transmission. A time gap/interval/offset (e.g., K₁) from downlink data reception (e.g., via a DL-SCH resource) to a transmission of a HARQ ACK/NACK corresponding to the downlink data may be fixed. For example, the time gap may comprise one or more subframes, slots, and/or symbols. This scheme with pre-defined timing instants for the HARQ ACK/NACK may not blend well with dynamic TDD and/or unlicensed operation. A more flexible scheme, capable of dynamically controlling the HARQ ACK/NACK transmission timing may be adopted. For example, a DCI format may comprise a PDSCH-to-HARQ_feedback timing field to control and/or indicate a transmission timing of an HARQ ACK/NACK corresponding to a data scheduled by the DCI in an uplink transmission (e.g., PUCCH). The PDSCH-to-HARQ_feedback timing field in the DCI may be used as an index of one or more indexes of K₁ values in a pre-defined and/or an RRC-configured table (e.g., a HARQ timing table). The K₁ value may provide information of a gap/interval/offset between a second time to send (e.g., transmit) the HARQ ACK/NACK relative to a first time of the downlink data reception. The wireless device may determine a resource for HARQ ACK/NACK transmission (e.g., frequency resource, PUCCH format, and/or code domain), for example, based on a location of a PDCCH (e.g., a starting control channel element (CCE) index) carrying the DCI format. The DCI format may comprise a field (e.g., PUCCH resource indicator (PRI) field) that indicates a frequency resource for an uplink transmission of the HARQ ACK/NACK transmission. The PRI field may be an index selecting one of a plurality of pre-defined and/or RRC-configured PUCCH resource sets.

A wireless device may be scheduled to send (e.g., transmit) a TB without a CSI report. The wireless device may be scheduled to send (e.g., transmit) a TB and one or more CSI reports on PUSCH by DCI. The ‘Time domain resource assignment’ field value m of the DCI may provide a row index m+1 to an allocated table. The indexed row may define the slot offset K₂, the start and length indicator SLIV (or the start symbol S and the allocation length L), the PUSCH mapping type, and/or the number of repetitions (e.g., if numberOfRepetitions is present in the resource allocation table) to be applied in the PUSCH transmission. The wireless device may be scheduled to send (e.g., transmit) a PUSCH with no TB and with one or more CSI reports by a ‘CSI request’ field on DCI. The ‘Time domain resource assignment’ field value m of the DCI may provide a row index m+1 to the allocated table. The indexed row may define the start and length indicator SLIV (or the start symbol S and the allocation length L). The wireless device may determine the PUSCH mapping type to be applied in the PUSCH transmission and the K₂ value, for example, based on one or more higher layer parameters. K₂ may indicate the slot where the wireless device sends (e.g., transmit) a first PUSCH of a multiple PUSCHs, for example, if pusch-TimeDomainAllocationListForMultiPUSCH in pusch-Config contains row indicating resource allocation for two to eight contiguous PUSCHs. Each PUSCH may have a separate SLIV and/or mapping type. The number of scheduled PUSCHs may be signaled by the number of indicated valid SLIVs in the row of the pusch-TimeDomainAllocationListForMultiPUSCH signaled in DCI format 0_1.

A wireless device may be configured with minimumSchedulingOffsetK2, for example, in an active UL BWP. The minimumSchedulingOffsetK2 (e.g., in an active UL BWP) may be applied a minimum scheduling offset restriction indicated by the ‘Minimum applicable scheduling offset indicator’ field in DCI format 0_1 or DCI format 1_1. The wireless device may apply a minimum scheduling offset restriction indicated based on ‘Minimum applicable scheduling offset indicator’ value ‘0’, for example, if the wireless device is configured with minimumSchedulingOffsetK2 in an active UL BWP and it has not received ‘Minimum applicable scheduling offset indicator’ field in DCI format 0_1 or 1_1. If the minimum scheduling offset restriction is applied, the wireless device may not expect to be scheduled with a DCI in slot n to send (e.g., transmit) a PUSCH scheduled with C-RNTI, CS-RNTI, MCS-C-RNTI or SP-CSI-RNTI with K₂ smaller than

$$⌈ {K}_{2 min} \cdot \frac{{2}^{{μ}^{′}}}{{2}^{μ}} ⌉ ,$$

where K₂ₘᵢₙ may be the applied minimum scheduling offset restriction,μ may be the numerology of the active UL BWP of the scheduled cell when receiving the DCI in slot n, μ′ may be the numerology of the new active UL BWP, for example, for active UL BWP change in the scheduled cell. At least in some examples, μ′ may be equal to μ. The wireless device may not apply the minimum scheduling offset restriction if PUSCH transmission is scheduled by a RAR UL grant, a fallbackRAR UL grant for RACH procedure, or PUSCH is scheduled with TC-RNTI.

Semi-persistent scheduling (SPS) may be supported in the downlink, where the wireless device may be configured with a periodicity of the data transmission using RRC signaling. Activation of semi-persistent scheduling may be done using PDCCH. For example, CS-RNTI may be used for dynamic scheduling. The PDCCH may carry information associated with time-frequency resources and other parameters. A HARQ process number/ID may be derived from a time, for example, when the downlink data transmission starts. The wireless device may receive downlink transmission periodically after activation of semi-persistent scheduling. The downlink transmission may be received, for example, according to an RRC-configured periodicity. The RRC-configured periodicity may be included in the transmission parameters indicated in the PDCCH activating the transmission.

In the uplink, two schemes for transmission without a dynamic grant may be supported. The two schemes may differ in the way they are activated. The first scheme may be activated by configured grant type 1 (or Type 1 configured grant), where an uplink grant is provided by RRC, including activation of the grant. The second scheme may be activated by configured grant type 2 (or Type 2 configured grant), where the transmission periodicity is provided by RRC and/or L1/L2 control signaling is used to activate/deactivate the transmission in a similar way as in a downlink case. The two schemes may reduce control signaling overhead, and/or the latency before uplink data transmission, as no scheduling request-grant cycle is needed prior to data transmission. Configured grant type 2 may be similar to downlink SPS. RRC signaling may be used to configure the periodicity. PDCCH activation may provide transmission parameters. The wireless device may send (e.g., transmit), after receiving the activation command, data in the buffer, for example, based on the preconfigured periodicity. If there are no data in the buffer, the wireless device may, similarly to type 1, send (e.g., transmit) nothing. The wireless device may acknowledge the activation/deactivation of type 2 by sending a MAC CE in the uplink. In both schemes, multiple wireless devices with overlapping time-frequency resources in the uplink may be configured. The network may differentiate between transmissions from different wireless devices, for example, if multiple wireless devices with overlapping time-frequency resources in the uplink is configured. PUSCH resource allocation may be semi-statically configured, for example, by higher layer parameter configuredGrantConfig in BWP-UplinkDedicated information element.

A wireless device may support a baseline processing time/capability, and/or additional aggressive/faster processing time/capability. The wireless device may report to a base station a processing capability (e.g., per sub-carrier spacing). The wireless device may determine, for example, based on PDSCH processing time, a first uplink symbol of a PUCCH (e.g., determined based on a HARQ-ACK timing K₁, one or more PUCCH resources to be used, and/or the effect of the TA) comprising the HARQ-ACK information of the PDSCH (e.g., scheduled by DCI). The first uplink symbol of the PUCCH may start at or later than a time gap (e.g., T_{proc,1}) after a last symbol of the PDSCH reception associated with the HARQ-ACK information. The first uplink symbol of the PUCCH which carries the HARQ-ACK information may start at or later than symbol L₁ start, where L₁ is defined as the next uplink symbol with its Cyclic Prefix (CP) starting after the time gap after the end of the last symbol of the PDSCH. The time gap may be calculated based on T_{proc,1}=(N₁+d_{1,1}+d₂)(2048+144). a₁. Parameter a₁ may depend on a numerology μ. The time gap may be given based on the wireless device PDSCH processing capability in the corresponding frequency band. d_{1,1} may depend on the PDSCH mapping (e.g., a mapping type A or mapping type B) and the length of the PDSCH (in the number of symbols). The wireless device may set d₂=0.

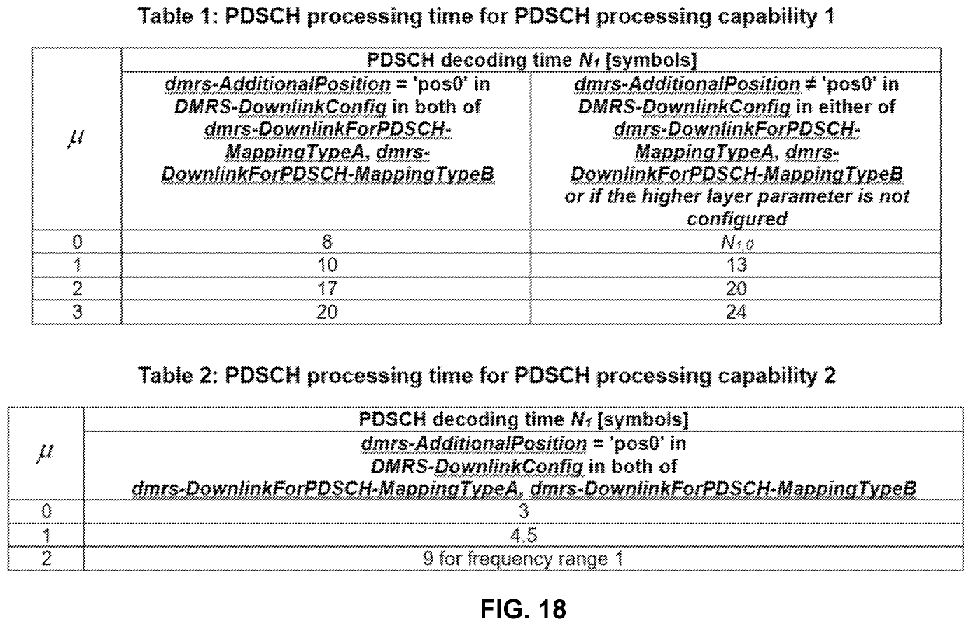

FIG. 18 shows example PDSCH processing times. Table 1 shows PDSCH decoding time (referred to as “N1”) for PDSCH processing capability 1. Table 2 shows PDSCH decoding time N1 for PDSCH processing capability 2. Any other processing capability may be used, for example, which may correspond to any other PDSCH processing time. The PDSCH decoding time N1 may be represented by number of symbols. The PDSCH decoding time N1 may be for different numerologies. As shown in FIG. 18, for PDSCH processing capability 1, PDSCH decoding time N₁ is more than 14 OFDM symbols if SCS is higher than 60 kHz (μ=2). For PDSCH processing capability 2, PDSCH decoding time N₁ is 9 OFDM symbols for 60 kHz SCS. The PDSCH decoding time N₁, for 480 kHz and 960 kHz SCS may be more than 14 OFDM symbols (1 slot). N₁ may be based on μ for the respective wireless device processing capability, where μ may correspond to the one of μ_{PDCCH}, μ_{PDSCH}, μ_{UL}. The μ_{PDCCH} may correspond to the subcarrier spacing of the PDCCH scheduling the PDSCH, the μ_{PDSCH} may correspond to the subcarrier spacing of the scheduled PDSCH, and the μ_{UL} may correspond to the subcarrier spacing of the uplink channel with which a HARQ-ACK is to be transmitted.

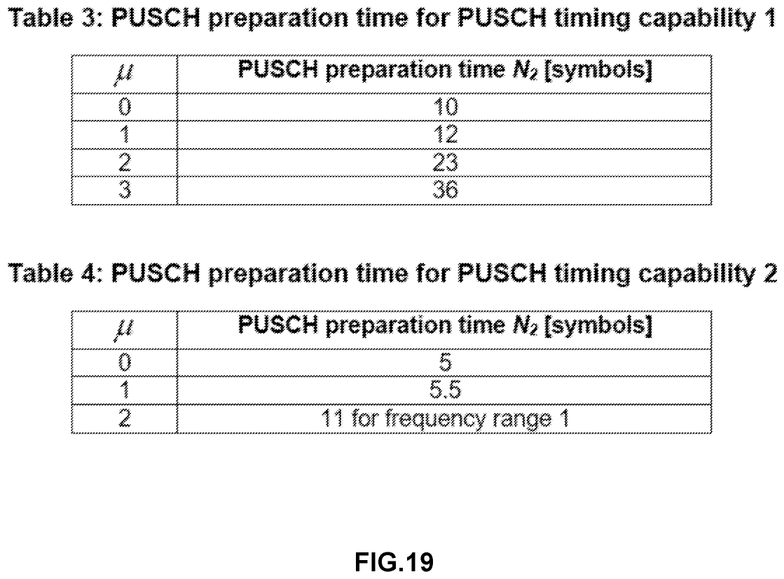

The transmission time of an UL data may be determined, for example, based on PUSCH preparation/processing time. The wireless device may send (e.g., transmit) the PUSCH, for example, if the first uplink symbol in the PUSCH allocation for a transport block (including the DM-RS) is no earlier than at symbol L2. The symbol L2 may be determined (e.g., by a wireless device) based on a slot offset (e.g., K2), SLIV of the PUSCH allocation indicated by time domain resource assignment of a scheduling DCI. K2 and/or SLIV may be described in connection with FIG. 17. The symbol L2 may be specified as the next uplink symbol with its CP starting after a time gap with length T_{proc,2}=max((N₂+d_{2,1}+d₂)(2048+144). a₁, d_{2,2}), where N2 may be described in connection with FIG. 19 below. The time gap may start after the end of the reception of the last symbol of the PDCCH carrying the DCI scheduling the PUSCH. The wireless device may set d_{2,1}=0, otherwise d_{2,1}=1, for example, if the first symbol of the PUSCH allocation consists of DM-RS only. Parameter a₁ may depend on a numerology μ. Numerology μ may corresponding to and/or depend upon μ_{UL} and/or μ_{PDCCH}.

FIG. 19 shows examples of PUSCH preparation/processing time. Table 3 shows example PUSCH preparation/processing time in number of slots (referred to as “N₂”) for a wireless device with PUSCH timing capability 1. Table 4 shows example PUSCH preparation/processing time in number of slots (N₂) for a wireless device with PUSCH timing capability 2. PUSCH timing capacity 1 and 2 may be described in connection with FIG. 18. N₂ may depend on the numerology μ, where μ may correspond to the subcarrier spacing of the downlink with which a PDCCH carrying DCI that schedules a PUSCH transmission. The numerology μ may correspond to the subcarrier spacing of the uplink channel with which the PUSCH is to be transmitted.

The wireless device may decode, based on a corresponding PDCCH transmission, a PDSCH in a serving cell scheduled by a PDCCH with C-RNTI, CS-RNTI or MCS-C-RNTI and one or multiple PDSCH(s) to be received (e.g., via CA) in the same serving cell, for example, if the PDSCHs partially or fully overlap in time. The wireless device may decode the PDSCH without the corresponding PDCCH transmission, for example, if the PDCCH scheduling the PDSCH ends at least 14 symbols before the earliest starting symbol of the PDSCH(s). The symbol duration may be determined, for example, based on the smallest numerology between the scheduling PDCCH and the PDSCH. The wireless device may refrain from decoding a PDSCH scheduled with C-RNTI, MCS-C-RNTI, or CS-RNTI, for example, if another PDSCH in the same cell scheduled with RA-RNTI or MSGB-RNTI partially or fully overlap in time. The wireless device may, based on detection of a PDCCH with a configured DCI format 0_0, 0_1 or 0_2, send (e.g., transmit) the corresponding PUSCH as indicated by that DCI, unless the wireless device does not generate a transport block.

A wireless device may be configured with one or more SRS resource configuration parameters. The one or more SRS resource configuration parameters may indicate configuration of SRS resource sets. The higher layer parameter resourceType in SRS-Resource or SRS-PosResource may be set to ‘aperiodic’ (for an aperiodic SRS transmission). The wireless device may receive downlink DCI, a group common DCI, or an uplink DCI based command where a codepoint of the DCI may trigger one or more SRS resource sets. The minimal time interval, between the last symbol of a PDCCH triggering the aperiodic SRS transmission and the first symbol of SRS resource, may be determined based on N₂ symbols and/or an additional time duration for BWP switching, for example, if SRS in the resource set with usage is set to ‘codebook’ or ‘antennaSwitching’. The minimal time interval between the last symbol of the PDCCH triggering the aperiodic SRS transmission and the first symbol of SRS resource may be set to N₂+14 symbols, or N₂+14 plus an additional time duration for BWP switching, for example, if SRS in the resource set with usage is set to other values. The wireless device may send (e.g., transmit) every aperiodic SRS resource in each of the triggered SRS resource set(s) in slot m, for example, if the wireless device receives the DCI triggering aperiodic SRS in slot n and SRS is configured with the higher layer parameter SRS-PosResource. The slot m may be determined (e.g., by the wireless device) based on a higher layer parameter slotOffset for each aperiodic SRS resource in each triggered SRS resources set, the subcarrier spacing of the triggered SRS transmission, the subcarrier spacing configurations for triggered SRS, and/or the subcarrier spacing of the PDCCH carrying the triggering command.

The wireless device may adjust uplink timing for PUSCH/SRS/PUCCH transmission on the serving cells (e.g., all the serving cells) in the TA group (TAG), for example, after or in response to reception of a TAC MAC CE for a TAG. The TAC MAC CE for a TAG may indicate the change of the uplink timing relative to a current uplink timing for the TAG. The wireless device may receive a Msg2 1312 (or a MsgB 1332) comprising a TA command field (e.g., an absolute TA command field). The wireless device may set a TA value by an initial value based on the received TA command (e.g., the absolute TAC MAC CE). After initial access, a TAC MAC CE for a TAG may indicate adjustment of the TA value (e.g., a current TA value). Adjustment of the current TA value by a positive amount (e.g., received via the TAC MAC CE) may indicate advancing the uplink transmission timing for the TAG by a corresponding amount. Adjustment of the current TA value by a negative amount (received via the TAC MAC CE) may indicate delaying the uplink transmission timing for the TAG by a corresponding amount.

The base station may configure (e.g., via RRC) timeAlignmentTimer (e.g., per TAG) for the maintenance of UL time alignment. The timeAlignmentTimer may control how long the Serving Cells that belongs to the associated TAG is considered (e.g., by the MAC entity) as uplink time aligned.

The wireless device, after or in response to receiving a TAC MAC CE, may apply the TA Command for the indicated TAG and start (or restart) the timeAlignmentTimer associated with the indicated TAG. If a TA Command may be received in a random access response message (e.g., a Msg2 1312) for a Serving Cell belonging to a TAG or in a MsgB 1321 for an SpCell. the wireless device may apply the TA Command for this TAG and start or restart the timeAlignmentTimer associated with this TAG. If an Absolute TA Command is received (e.g., based on or in response to) a MSGA transmission including C-RNTI MAC CE, the wireless device may apply the TA Command for primary TAG and start (or restart) the timeAlignmentTimer associated with the primary TAG.

If a timeAlignmentTimer expires, the wireless device may, based on the timeAlignmentTimer being associated with a primary TAG, perform at least one of the following: flush HARQ buffers for Serving Cells (e.g., all HARQ buffers for all Serving Cells); send RRC to release PUCCH for Serving Cells (e.g., all Serving Cells), if configured; send RRC to release SRS for Serving Cells (e.g., all Serving Cells), if configured; clear configured downlink assignments and configured uplink grants; clear PUSCH resource for semi-persistent CSI reporting; determine running timeAlignmentTimers (e.g., which may correspond to a secondary TAG) as expired; maintain one or more current TA values of one or more TAGs (e.g., all TAGs). A wireless device may have more than one running timeAlignmentTimer(s). A wireless device may determine/assume each timeAlignmentTimer (e.g., associated with a secondary TAG) has expired, for example, if a first timeAlignmentTimer (e.g., associated with a primary TAG) has expired.

If a timeAlignmentTimer expires, the wireless device may, based on the timeAlignmentTimer being associated with a secondary TAG, perform at least one of the following: flush HARQ buffers (e.g., all HARQ buffers); send RRC to release PUCCH, if configured; send RRC to release SRS, if configured; clear configured downlink assignments and configured uplink grants; clear PUSCH resource for semi-persistent CSI reporting; and/or maintain a current TA value of this secondary TAG.

The wireless device may perform the Random Access Preamble (e.g., Msg1 1311) and/or MsgA 1331 transmission to a Serving Cell if a timeAlignmentTimer associated with the TAG to which the Serving Cell belongs is not running. The wireless device may transmit a random access preamble (e.g., Msg1 1311) and/or MsgA 1331 transmission on the SpCell, if a timeAlignmentTimer associated with a primary TAG is not running. The wireless device may refrain from performing other uplink transmissions to the Serving Cell if a timeAlignmentTimer associated with the TAG to which the Serving Cell belongs is not running.

One or more timing relationships (e.g., with respect to a TA value) may comprise one or more MAC CE timing relationships and/or one or more UL timing relationships. The one or more timing relationships may be based on one or more timing relationship rules. The one or more timing relationship rules may indicate UL transmission timing adjustments (e.g., based on the TA value) and/or uplink timing for PUSCH/SRS/PUCCH transmission. The one or more timing relationship rules may indicate an activation time (or the wireless device assumption in the downlink configuration or in the uplink configuration) of a MAC CE, for example, based on the received time/occasion of a PDSCH carrying the MAC CE in the downlink. The MAC CE may become activated X milliseconds after the wireless device sends (e.g., transmits) a HARQ-ACK corresponding to the PDSCH.

The one or more timing relationship rules may indicate the transmission timing of one or more UL grants (e.g., PUSCH, aperiodic SRS, and/or reporting SRS over PUSCH). The UL grants may be indicated by DCI. The one or more timing relationship rules may indicate the transmission timing of an UL transmission (e.g., PUSCH, SRS, PUCCH). The UL transmission may include a PUSCH scheduled by a RAR UL grant, a fallbackRAR UL grant, and/or a PUCCH with HARQ-ACK information (e.g., in response to a successRAR). The wireless device may receive a TAC MAC CE on uplink slot n. The one or more timing relationship rules may indicate the adjustment of the UL transmission based on the uplink slot n+k+1, where k may be determined based on a PDSCH processing time for PDSCH processing capability 1 (e.g., as indicated in Table 1 of FIG. 18), a PUSCH preparation time for PUSCH timing capability 1 (e.g., as indicated in Table 3 of FIG. 19), and/or a maximum TA value that may be provided via a TAC MAC CE. The TAC MAC CE may comprise 12 bits. One or more timing relationship rules may indicate the transmission timing of an UL transmission scheduled by a RAR UL grant, a fallbackRAR UL grant, and/or a PUCCH with HARQ-ACK information (e.g., in response to a successRAR).

A wireless device may receive a MAC CE activation command in the downlink for one of the one or more TCI states. The wireless device may send (e.g., transmit) a PUCCH with HARQ-ACK information (e.g., for a PDSCH providing the activation command in slot k). The one or more timing relationship rules may indicate that the wireless device may apply the activation command in a first uplink slot that is after slot k+3Nₛₗₒₜ^{subframe,μ} where μ is the SCS configuration for the PUCCH.

A wireless device may receive a PDSCH carrying an activation command in the downlink indicating semi-persistent Reporting Setting. The wireless device may send (e.g., transmit) a PUCCH with HARQ-ACK information in an uplink slot n corresponding to the PDSCH. The one or more timing relationship rules may indicate that the indicated semi-persistent Reporting Setting may be applied starting from the first uplink slot that is after slot n+3Nₛₗₒₜ^{subframe,μ} where □ is the SCS configuration for the PUCCH.

A wireless device may receive an activation command for one or more CSI-RS resource sets for channel measurement and/or CSI-IM/NZP CSI-RS resource sets for interference measurement (e.g., associated with one or more configured CSI resource settings). The wireless device may send (e.g., transmit) a PUCCH with HARQ-ACK information in an uplink slot n corresponding to a PDSCH carrying the selection command in the downlink. The one or more timing relationship rules may indicate that the corresponding action(s) and/or the wireless device assumptions (e.g., corresponding to quasi-collocation assumptions provided by a list of reference to TCI-State's one per activated resource) on CSI-RS/CSI-IM transmission may be applied starting from the first slot that is after slot n+3Nₛₗₒₜ^{subframe,μ} where □ is the SCS slot configuration for the PUCCH. The CSI-RS/CSI-IM transmission may correspond to the configured CSI-RS/CSI-IM resource configuration(s). The wireless device may receive a deactivation command of the one or more CSI-RS/CSI-IM resource sets. The wireless device may send (e.g., transmit) a PUCCH with HARQ-ACK information in slot n corresponding to a PDSCH carrying the deactivation command. The one or more timing relationship rules may indicate that the wireless device assumption on cessation of CSI-RS/CSI-IM transmission may apply starting from the first slot that is after slot n+3Nₛₗₒₜ^{subframe,μ} where □ is the SCS configuration for the PUCCH. The CSI-RS/CSI-IM transmission may correspond to the one or more CSI-RS/CSI-IM resource sets.

A wireless device may send (e.g., transmit) a PUCCH with HARQ-ACK information in slot n corresponding to a PDSCH carrying an activation command indicating performing semi-persistent CSI reporting on a PUCCH. The one or more timing relationship rules may indicate that the wireless device may perform semi-persistent CSI reporting on the PUCCH applied starting from the first slot that is after slot n+3Nₛₗₒₜ^{subframe,μ} where □ is the SCS configuration for the PUCCH.

A wireless device may receive an activation command for an SRS resource. The wireless device may send (e.g., transmit) a PUCCH with HARQ-ACK information in slot n corresponding to a PDSCH carrying the activation command in slot n. The one or more timing relationship rules may indicate that the action time of the activation command (and/or the wireless device assumptions on SRS transmission corresponding to the configured SRS resource set) may be applied starting from the first slot that is after slot n+3Nₛₗₒₜ^{subframe,μ} where □ is the SCS configuration for the PUCCH.

A wireless device may receive a deactivation command for an activated SRS resource set. The wireless device may send (e.g., transmit) a PUCCH with HARQ-ACK information in slot n corresponding to a PDSCH carrying the deactivation command. The one or more timing relationship rules may indicate that the action time of the deactivation command (and/or the wireless device assumption on cessation of SRS transmission) corresponding to the deactivated SRS resource set may apply starting from the first slot that is after slot n+3Nₛₗₒₜ^{subframe,μ} where □ is the SCS configuration for the PUCCH.

A wireless device may send (e.g., transmit) a PUCCH with HARQ-ACK information in uplink slot n corresponding to a PDSCH carrying the ZP CSI-RS Resource Set Activation MAC CE for one or more ZP CSI-RS resources. The one or more timing relationship rules may indicate that the corresponding action time of the ZP CSI-RS Resource Set Activation MAC CE (and/or the wireless device assumption on the PDSCH resource element mapping) corresponding to the activated one or more ZP CSI-RS resources may be applied starting from an uplink first slot that is after slot n+3Nₛₗₒₜ^{subframe,μ} where □ is the SCS configuration for the PUCCH. The wireless device may send (e.g., transmit) a PUCCH with HARQ-ACK information in uplink slot n corresponding to a PDSCH carrying the ZP CSI-RS Resource Set Deactivation MAC CE for the one or more ZP CSI-RS resources. The one or more timing relationship rules may indicate that the corresponding action and the wireless device assumption on the PDSCH resource element mapping corresponding to the deactivated ZP CSI-RS resources may be applied starting from an uplink first slot that is after slot n+3Nₛₗₒₜ^{subframe,μ} where □ is the SCS configuration for the PUCCH.

A wireless device may be configured with configuration parameters of a buffer status report (BSR). The configuration parameters may comprise at least one of: a periodic BSR timer (e.g., periodicBSR-Timer), a BSR retransmission timer (e.g., retxBSR-Timer), a SR delay timer application indicator (e.g., logicalChannelSR-DelayTimerApplied), a SR delay timer (e.g., logicalChannelSR-DelayTimer), a SR mask parameter (e.g., logicalChannelSR-Mask), or a logical channel group (LCG) group indication (e.g., logicalChannelGroup).

A wireless device may trigger a first BSR, for example, based on (e.g., in response to) a MAC entity of the wireless device having new UL data available for a logical channel (LCH). The LCH may belong to an LCG. The new UL data may belong to an LCH with higher priority than the priority of other LCHs, comprising available UL data, that belongs to other LCGs. Or, the new UL data may belong to the only LCH that currently comprising available UL data. The first BSR procedure may be referred to as a regular BSR (or a first type of BSR) herein.

A wireless device may trigger a second BSR, for example, based on (e.g., in response to) UL resources being allocated and the number of padding bits being equal to or larger than the size of a BSR MAC CE plus its subheader. The second BSR may be referred to as a padding BSR (or a second type of BSR) herein.

A wireless device may trigger a third BSR based on (e.g., in response to) a timer (e.g., retxBSR-Timer) expiring and at least one of the LCHs which belong to an LCG comprising UL data. The third BSR may be the same type of BSR as the first BSR procedure. The third BSR may be referred to as a regular BSR herein. A MAC entity of a wireless device may restart retxBSR-Timer after or in response to reception of an UL grant for transmission of new data on any UL-SCH. A MAC entity of the wireless device may determine that an LCH that triggered the third BSR is the highest priority LCH that has data available for transmission at the time the BSR is triggered (e.g., for a BSR triggered by a BSR retransmission timer (e.g., retxBSR-Timer) expiry). A wireless device may trigger a fourth BSR based on (e.g., in response to) a timer (e.g., periodicBSR-Timer) expiring. The fourth BSR may be referred to as a periodic BSR (or a third type of BSR) herein.

A wireless device may start or restart a SR delay timer (e.g., logicalChannelSR-DelayTimer) based on (e.g., in response to) a BSR being triggered for a first LCH. The first LCH may be associated with a logicalChannelSR-DelayTimerApplied being set to value true. The wireless device may refrain from triggering an SR for the pending BSR, for example, based on determining that the associated SR delay timer is running. The wireless device may stop a running SR delay timer, for example, based on (e.g., in response to) the BSR being triggered for a second LCH for which a logicalChannelSR-DelayTimerApplied is not configured or is set to value false.

A wireless device may report Long BSR for LCGs (e.g., all LCGs) that have data available for transmission, for example, based on (e.g., in response to) more than one LCG having data available for transmission when the MAC PDU comprising the BSR (e.g., a regular BSR or a periodic BSR) is to be built. The wireless device may report Short BSR, for example, based on no more than LCG having data available for transmission when the MAC PDU comprising the BSR is to be built.

A wireless device may report Short Truncated BSR for the LCG with the highest priority logical channel among LCGs that have data available for transmission, for example, if: the number of padding bits is equal to or larger than the size of the Short BSR plus its subheader but smaller than the size of the Long BSR plus its subheader, more than one LCG has data available for transmission when the BSR (e.g., a padding BSR) is to be built, and/or the number of padding bits is equal to the size of the Short BSR plus its subheader.

A wireless device may report Long Truncated BSR of the LCG(s) with the LCHs having data available for transmission based on a decreasing order starting from the highest priority LCH (with or without data available for transmission) if: the number of padding bits is equal to or larger than the size of the Short BSR plus its subheader but smaller than the size of the Long BSR plus its subheader, more than one LCG has data available for transmission when the BSR (e.g., a padding BSR) is to be built, and/or the number of padding bits is greater than the size of the Short BSR plus its subheader. If two or more LCGs have equal priority, the transmission may be further based on an increasing order of LCGID.

A wireless device may report Short BSR if: the number of padding bits is equal to or larger than the size of the Short BSR plus its subheader but smaller than the size of the Long BSR plus its subheader, and/or at most one LCG has data available for transmission when the BSR (e.g., a padding BSR) is to be built. A wireless device may report Long BSR for all LCGs which have data available for transmission if the number of padding bits is equal to or larger than the size of the Long BSR plus its subheader.

A wireless device may trigger a Multiplexing and Assembly procedure to generate BSR MAC CE(s), start (or restart) a periodic BSR timer (e.g., periodicBSR-Timer) and/or start or restart a BSR retransmission timer (e.g., retxBSR-Timer) based on (e.g., in response to): at least one BSR having been triggered and not been cancelled, and/or UL-SCH resources being available for a new transmission and the UL-SCH resources accommodating the BSR MAC CE plus its subheader as a result of logical channel prioritization. The wireless device may refrain from triggering a Multiplexing and Assembly procedure to generate BSR MAC CE(s), start (or restart) a periodic BSR timer (e.g., periodicBSR-Timer) and/or start or restart a BSR retransmission timer (e.g., retxBSR-Timer), for example, if all generated BSRs are long BSRs or all generated BSRs are short truncated BSRs.

A wireless device may trigger a SR based on (e.g., in response to): at least one BSR having been triggered and not been cancelled, a regular BSR of the at least one BSR having been triggered and a logicalChannelSR-DelayTimer associated with an LCH for the regular BSR not being running, and/or no UL-SCH resource being available for a new transmission. No UL-SCH being available for new transmission may comprise the MAC entity being configured with configured uplink grant(s) and the Regular BSR being triggered for an LCH for which logicalChannelSR-Mask is set to false, or the UL-SCH resources available for a new transmission not meeting the LCP mapping restrictions configured for the LCH that triggered the BSR.

A wireless device may determine that UL-SCH resources are available if a MAC entity of the wireless device has an active configuration for either type (type 0 or type 1) of configured uplink grants, and/or the MAC entity has received a dynamic uplink grant. The wireless device may determine that one or more UL-SCH resources are available if the MAC entity has been configured with, received, and/or determined an uplink grant. If the MAC entity has determined (e.g., at a given point in time) that UL-SCH resources are available, this need not imply that UL-SCH resources are available for use at that point in time.

A MAC PDU may comprise at most one BSR MAC CE, if multiple events have triggered a BSR. The Regular BSR and the Periodic BSR may have precedence (e.g., higher priority) over the padding BSR. A wireless device may cancel triggered BSRs (e.g., all triggered BSRs) if the UL grant(s) is able to accommodate all pending data available for transmission but is not sufficient to accommodate the BSR MAC CE plus its subheader. A wireless device may cancel BSRs (e.g., all BSRs) triggered prior to MAC PDU assembly, for example, if a MAC PDU is sent (e.g., transmitted), the MAC PDU comprises a Long or Short BSR MAC CE, and the BSR MAC CE comprises buffer status up to (and including) the last event that triggered a BSR prior to the MAC PDU assembly.

A MAC PDU assembly may happen at any point in time between uplink grant reception and actual transmission of the corresponding MAC PDU. BSR and SR may be triggered after the assembly of a MAC PDU that comprises a BSR MAC CE, but before the transmission of this MAC PDU. BSR and SR may be triggered during MAC PDU assembly.

A base station may send (e.g., transmit) to a wireless device one or more RRC messages comprising configuration parameters of one or more PUCCH resources and/or configuration parameters of a plurality of SR configurations. A first SR configuration of the plurality of SR configurations may correspond to one or more first LCHs of a plurality of LCHs. The base station may send (e.g., transmit) to a wireless device at least one message comprising parameters indicating one or more SR configurations. Each SR configuration may correspond to one or more LCHs. Each logical channel may be mapped to no more than one SR configuration. A SR configuration, of a LCH, that triggers a BSR may be considered as a corresponding SR configuration for a triggered SR.

The one or more configuration parameters may comprise at least one of: a SR prohibit timer (e.g., sr_ProhibitTimer); a maximum number of SR transmission (e.g., sr_TransMax); a parameter indicating a periodicity and offset of SR transmission in slots (e.g., periodicityAndOffset) for a PUCCH transmission conveying SR; and/or a PUCCH resource; a number of symbols for a PUCCH transmission (e.g., nrofSymbols). A SR configuration may comprise a set of PUCCH resources for SR. The set of PUCCH resources may be on and/or may correspond to one or more BWPs and/or one or more cells. On a BWP, at most one PUCCH resource for SR may be configured. A wireless device may be configured by a priority index 0 or a priority index 1 for the SR (e.g., by phy-PriorityIndex in SchedulingRequestResourceConfig). If the wireless device not being provided a priority index for SR, the priority index may be 0.

The wireless device may trigger a BSR based on (e.g., in response to) data that becomes available for the LCH. The wireless device may determine that a SR configuration of an LCH that triggers a BSR is a corresponding SR configuration for a triggered SR. The wireless device may trigger a SR (e.g., SR for BSR) for requesting UL-SCH resource if the wireless device has new transmission. A wireless device may determine the SR as pending after the SR is triggered and until the SR is cancelled. One or more pending SRs (e.g., all pending SRs) may be cancelled, for example, if one or more UL grants accommodate one or more pending data (e.g., all pending data) available for transmission.

A SR prohibit timer may be a duration during which the wireless is not allowed to send (e.g., transmit) an SR. The wireless device may stay active while sr_ProhibitTimer is running and may monitor PDCCH for detecting DCI that indicate uplink scheduling grant(s). The maximum number of SR transmissions (e.g., sr_TransMax) may be a number for which the wireless device is allowed to send (transmit) the SR at most.

The wireless device may determine whether at least one valid PUCCH resource for a pending SR is available for SR transmission. The wireless device may initiate a RA procedure on a PCell or a PSCell, for example, based on determining that no valid PUCCH resource is available. The wireless device may cancel the pending SR, for example, based on initiating the RA procedure. The wireless device may determine at least one valid PUCCH resource for the pending SR is available, for example, if the at least one valid PUCCH resource does not overlap with a measurement gap. The wireless device may determine to transmit an SR on the at least one valid PUCCH resource, for example, based on the periodicity and the offset of the corresponding SR configuration. The wireless device may send (e.g., transmit) the PUCCH using PUCCH format 0 or PUCCH format 1, for example, based on the PUCCH configuration.

The wireless device may determine not to send (e.g., may refrain from sending) another SR based on determining that the SR prohibit timer being running. The wireless device may wait for another SR transmission after the SR prohibit timer expires. A wireless device may maintain a SR transmission counter (e.g., SR_COUNTER) associated with an SR configuration for counting the number of times that the SR is sent (or resent). A wireless device may set the SR_COUNTER of the SR configuration to a first value (e.g., 0), for example, if an SR of a SR configuration being triggered, and there are no other SRs pending corresponding to the same SR configuration.

If the SR prohibit timer not being running and the SR_COUNTER being less than the maximum number of SR transmission, the wireless device may instruct the physical layer of the wireless device to send (e.g., signal) the SR on the at least one valid PUCCH resource for the pending SR, increment the SR_COUNTER (e.g., by one), and start the SR prohibit timer. The wireless device may start monitoring a PDCCH for detecting DCI for uplink grant (e.g., while the SR prohibit timer is running), for example, based on (e.g., in response to) the SR is sent. The wireless device may cancel the pending SR and/or stop the SR prohibit timer, for example, if one or more uplink grants that may accommodate pending data (e.g., all pending data) available for transmission is received.

A wireless device may cancel pending SR(s) (e.g., all pending SR(s)) for BSR triggered before the MAC PDU assembly and/or stop each respective sr-ProhibitTimer based on (e.g., after or in response to) the MAC PDU is sent and the MAC PDU comrprises a Long or Short BSR MAC CE which comprise buffer status up to (and including) the last event that triggered a BSR prior to the MAC PDU assembly. The wireless device may cancel pending SR(s) (e.g., all pending SR(s)) for BSR and stop each respective sr-ProhibitTimer by determining that the UL grant(s) accommodating all pending data available for transmission.

If no uplink grants that accommodate all pending data available for transmission is received until the expiration of the SR prohibit timer, the wireless device may repeat one or more actions comprising: determining the at least one valid PUCCH resource for the transmission of the SR; checking whether the SR prohibit timer is running; whether the SR_COUNTER is equal or greater than the maximum number of SR transmission; incrementing the SR COUNTER, sending (e.g., transmitting) the SR, starting the SR prohibit timer; and/or monitoring a PDCCH for uplink grant.

A wireless device may, for example, based on determining that the SR_COUNTER indicating a number equal to or greater than the maximum number of SR transmission, release PUCCH and/or SR(s) for one or more serving cells, clear one or more configured downlink assignments and/or uplink grants, initiate an RA procedure on a PCell, and/or cancel the pending SR.

The wireless device (e.g., a MAC entity of the wireless device) may stop an ongoing RA procedure, for example, based on a pending SR has no valid PUCCH resources configured and the SR was initiated by the MAC entity of the wireless device prior to a MAC PDU assembly. The wireless device may stop the ongoing RA procedure, for example, based on an SR for BSR not being configured with valid PUCCH resource. The ongoing RA procedure may be canceled after or in response tosending (e.g., transmitting) a MAC PDU via a first UL grant (e.g., other than a UL grant provided by a RAR of the RA procedure). The MAC PDU may comprise a BSR MAC CE which comprises buffer status up to (and comprising) a last event that triggered the BSR prior to the MAC PDU assembly. The ongoing Ra procedure may be canceled if the UL grant(s) that accommodate all pending data available for transmission is received.

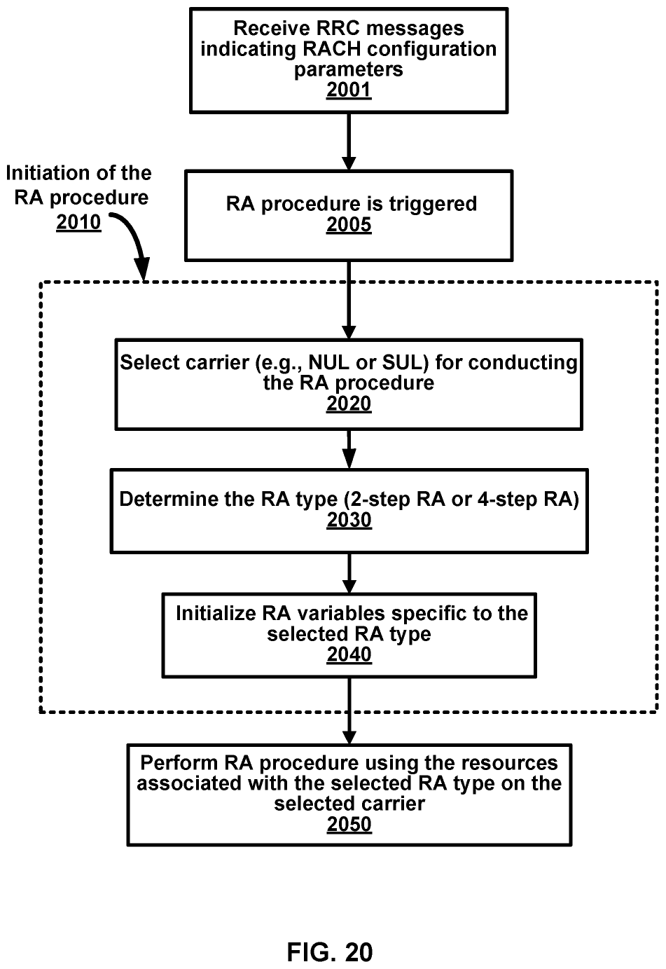

FIG. 20 shows an example of an RA procedure. Multiple uplink carriers and multiple RA types may be configured. At step 2001, a base station may send (e.g., transmit) one or more RACH configuration messages (e.g., RRC messages) comprising one or more parameters of RACH configuration. The one or more RACH configuration messages may comprise messages 1310, 1320 and/or 1330 as described in connection with FIG. 13. The one or more RACH configuration messages may be received prior to initiation of an RA procedure. The cell may comprise an SUL and/or an NUL. A RACH configuration may indicate 2-step RA and/or 4-step RA. A wireless device may receive, from a base station, configuration parameters indicating different (e.g., independent) PRACH occasions between 2-step RA and 4-step RA. A base station may configure one or more PRACH occasions shared between 2-step RA and 4-step RA and preambles partitioned for the 2-step RA and the 4-step RA. The wireless device may be configured with a 4-step RACH configuration regardless of whether 2-step RACH configuration exists or not. The wireless device may select which type of RACH (2-step or 4-step) to use to initiate a RA procedure, if the base station configures the wireless device with both 4-step and 2-step RACH resources/configurations. The wireless device supporting 2-step RA may select 2-step RA type, for example, if a received target power for the preamble and PUSCH transmission may be achieved. The wireless device may select between a 2-step RA type and a 2-step RA type based on RSRP.

The one or more RACH configuration messages may comprise one or more common configuration parameters (e.g., RA-ConfigCommon IE and/or RA-ConfigCommonTwoStepRA-r16 IE) and/or one or more configuration parameters configuring MsgA 1331 (e.g., MsgA-PUSCH-Config IE). The one or more RACH configuration messages may comprise generic configuration parameters (e.g., RACH-ConfigGeneric IE or RACH-ConfigGenericTwoStepRA IE), one or more cell specific random access configuration messages (e.g., RACH-ConfigCommon and/or RACH-ConfigGeneric), and/or one or more dedicated random access configuration messages (e.g., RACH-ConfigDedicated). The MsgA-PUSCH-Config IE may comprise a list of MsgA PUSCH resources (e.g., msgA-PUSCH-ResourceList) that the wireless device may use when performing MsgA 1331 transmission. The MsgA payload may comprise BSR MAC CE, power headroom report (PHR) MAC CE, RRC messages, and/or connection request.

Lower layers (e.g., the physical layer) of the wireless device may receive, from higher layers (e.g., the MAC layer), one or more SS/PBCH block indexes and/or one or more PRACH transmission parameters. The one or more PRACH transmission parameters may indicate PRACH preamble format, preamble index, a corresponding RA-RNTI (or MSGB-RNTI), time and/or frequency resources for PRACH preamble transmission, and/or parameters for determining one or more PRACH preamble sequences and shifts in the PRACH preamble sequence set (e.g., set type). The physical layer may provide, to higher layers (e.g., the MAC layer), one or more corresponding sets of RSRP measurements and/or one or more indications.

At step 2005, the wireless device may trigger an RA procedure, for example, based on the one or more RACH configuration messages. The wireless device may trigger the RA procedure based on (e.g., in response to): initial access to the cell; a positioning procedure; an uplink coverage recovery procedure; initiating a beam failure recovery; receiving (e.g., from a base station) a RRC reconfiguration message for a handover to a second cell; receiving (e.g., from a base station) a PDCCH order; re-synchronizing the wireless device status (e.g., after new data arrives and the wireless status is out-of-sync); new data arrives at the buffer of the wireless device and no scheduling request (SR) resources are configured; and/or pending data exists in the buffer of the wireless device and the wireless device has reached a maximum allowable times for sending (e.g., resending) an SR (e.g., during an SR failure). A MAC entity of the wireless device may limit the number of ongoing RA procedure to one at a given point in time. If an RA procedure is ongoing and a new RA procedure is triggered, the wireless device may determine (e.g., based on the implementation of the wireless device), whether to continue with an ongoing RA procedure or initiate (or initialize) the new RA procedure.

At step 2010, the wireless device may initialize an RA procedure based on (e.g., in response to) the RA procedure is triggered. The initializing the RA procedure may comprise at least one of: step 2020, determining a carrier (SUL or NUL) for performing the RA procedure (e.g., based on measured RSRP); step 2030, selecting RA type (e.g., determining a 2-step RA type or a 4-step RA type) for performing the RA procedure; and/or step 2040, initializing one or more RA parameters (e.g., variables) specific to the selected RA type. The wireless device may use one or more parameters for the initiated RA procedure. The one or more parameters may comprise at least one of: RA_TYPE; PREAMBLE_INDEX; PREAMBLE_TRANSMISSION_COUNTER; PREAMBLE_POWER_RAMPING_COUNTER; PREAMBLE_POWER_RAMPING_STEP; PREAMBLE_RECEIVED_TARGET_POWER; PREAMBLE_BACKOFF; PCMAX; SCALING_FACTOR_BI; POWER_OFFSET_2STEP_RA; MSGA_PREAMBLE_POWER_RAMPING_STEP; and TEMPORARY_C-RNTI. The wireless device may set one or more of the RA procedure parameters. The wireless device may set the value of PCMAX, for example, based on the selected carrier (SUL or NUL). The wireless device may flush the Msg3 buffer after initiating the RA procedure 2010. The wireless device may flush the MsgA buffer, after triggering the RA procedure.

At step 2050, the wireless device may perform RA procedure, for example, using selected RA resources with the selected RA carrier and RA type. The RA procedure may be performed after the RA procedure is initiated. If the RA procedure is a 4-step RA procedure, performing the RA procedure may comprise one or more of the following: selecting the RA resources and sending (e.g., transmitting) one or more PRACH preambles, monitoring one or more PDCCHs for receiving one or more random access responses (RARs), one or more retransmissions of the one or more PRACH preambles, transmission of Msg3, and/or contention resolution procedure. If the RA procedure is a 2-step RA procedure, performing the RA procedure may comprise one or more of the following: selecting the RA resources, sending (e.g., transmitting) one or more PRACH preambles and/or one or more MsgA payloads, monitoring one or more PDCCHs for receiving one or more RARs, one or more retransmissions of the one or more PRACH preambles and/or MsgA payloads, switching to a 4-step RA procedure, and/or performing fallback procedure (e.g., sending Msg3 based on receiving a MsgB comprising fallback MAC subPDU).

Referring back to step 2030, the wireless device may select the RA type, for example, after selecting the uplink carrier (e.g., SUL or NUL). The wireless device may select the RA type based on one or more of: the RSRP value, delay requirement, distance to the serving (or target) base station, and/or logical channel priority triggering a BSR. The wireless device may select 2-step RA type (e.g., RA_TYPE=2-stepRA) for performing the RA procedure on the selected uplink carrier, for example, if the RSRP being greater than a RSRP threshold, the. The wireless device may select the 4-step RA type for performing the RA procedure, for example, if the RA procedure is triggered/initiated for system information (SI) acquisition.

Referring back to step 2040, the wireless device may initialize one or more RA parameters specific to the selected RA type, for example, after determining the RA type. The wireless device may initialize one or more parameters (e.g., transmission counter, transmission timer, transmission power settings, and/or response windows) of the RA procedure. If the selected RA type is a 2-step RA procedure (i.e., RA_TYPE=2-stepRA), the one or more RA parameters may comprise at least the following: PREAMBLE_POWER_RAMPING_STEP, msgA-TransMax, preambleTransMax, and/or SCALING_FACTOR_BI. If the selected RA type is a 4-step RA procedure (i.e., RA_TYPE=4-stepRA), the one or more RA parameters may comprise at least the following: PREAMBLE_POWER_RAMPING_STEP, preambleTransMax, and/or SCALING_FACTOR_BI. If the selected RA type is a 2-step RA procedure (i.e., RA_TYPE=2-stepRA), the wireless device may set PREAMBLE_POWER_RAMPING_STEP to msgA-PreamblePowerRampingStep.

The wireless device may set POWER_OFFSET_2STEP_RA based on at least one or more configured parameters, for example, if RA_TYPE is switched from 2-stepRA to 4-stepRA during the ongoing/current RA procedure. The at least one or more configured parameters may comprise PREAMBLE_POWER_RAMPING_COUNTER and/or PREAMBLE_POWER_RAMPING_STEP. The wireless device may initialize the RA variables specific to a 4-step RA type (described in connection with step 2040) and perform the RA procedure (described in connection with step 2050), for example, based on (e.g., in response to) switching the RA type from 2-stepRA to 4-stepRA during the ongoing/current RA procedure.

The wireless device may perform a RAP transmission, for example, based on a selected PREABLE_INDEX and/or PRACH occasion. The wireless device may perform a RAP transmission based on a selected preamble index and PRACH occasion and/or perform a MsgA payload transmission based on a selected MsgA PUSCH occasion. For example, the wireless device may increment PREAMBLE_POWER_RAMPING_COUNTER (e.g., by one or to the next value), for example, based on a notification of suspending power ramping counter not being received from lower layers (e.g., the physical layer); and/or based on an SSB and/or a CSI-RS selected not being changed (e.g., same as the previous RAP transmission). The counter step size may be predefined and/or semi-statically configured.

The wireless device may start a RAR window (e.g., ra-ResponseWindow or msgB-ResponseWindow) at a first downlink control channel occasion, for example, from an end of the RAP transmission (e.g., Msg1 1311 or Msg1 1321 for a four-step RA procedure) or from an end MsgA payload transmission (e.g., TB 1342 for a 2-step RA procedure). The wireless device may, for example, while the RAR window is running, monitor a first DCI of the SpCell RARs identified by a particular RNTI (e.g., a random access-radio network temporary identifier (RA-RNTI), a temporary cell-radio network temporary identifier (TC-RNTI), a C-RNTI, and/or a MSGB-RNTI). The first DCI may comprise at least one of the following fields: one or more RA preamble index, SS/PBCH index, PRACH mask index, UL/SUL indicator, frequency and time domain resource assignments, modulation and/or coding schemes. The wireless device may monitor a set of candidates for the one or more downlink control channels in a Type1-PDCCH common search space set. The Type1-PDCCH common search space set may be configured by the one or more search space sets (e.g., the ra-searchSpace in the PDCCH-ConfigCommon).

In a 2-step RA procedure, the wireless device may receive two separate responses corresponding to a MsgA transmission. The two responses may comprise a first response for a RAP (e.g., MsgA preamble) transmission and a second response for a transmission of one or more TBs (e.g., MsgA payload). The wireless device may monitor a PDCCH (e.g., common search space and/or a wireless device specific search space) to detect the first response. The first response may comprise the MSGB-RNTI, for example, based on time and/or frequency indices of PRACH resource where the wireless device may send (e.g., transmit) the RAP. The wireless device may monitor a common search space and/or a wireless device specific search space to detect the second response.

A wireless device may send (e.g., transmit) a MsgA preamble (e.g., as part of MsgA transmission), for example, based on determining that the corresponding PRACH or the MsgA preamble is not mapped to a valid MsgA PUSCH occasion. The wireless device may, based on determining that the MsgA preamble is mapped to an invalid MsgA PUSCH occasion, detect the first DCI with CRC scrambled by a corresponding MSGB-RNTI during the RAR window.

A wireless device may receive a PDCCH, for example, based on the RA-RNTI or the MSGB-RNTI. The PDCCH may indicate a downlink assignment, for example, based on which the wireless device may receive one or more TBs comprising a MAC PDU. The MAC PDU may comprise at least one MAC subPDU with a corresponding subheader. The subheader may comprise a RA Preamble identifier (e.g., RAPID) matched to a preamble that a wireless device sends (e.g., transmits) to the base station. The wireless device may determine that a RAR reception is successful, for example, if the PDCCH (e.g., indicating/scheduling the MAC PDU and/or the at least one MAC subPDU) is received. The at least one MAC subPDU may comprise one RAPID. The RAPID may correspond to a random access procedure being started, by a wireless device, based on a SI request.

A wireless device may stop the RAR window (e.g., ra-ResponseWindow or msgB-ResponseWindow) after and/or in response to receiving one or more RARs and the RARs are determined as successful. A reception of the one or more RARs may be determined as successful, for example, if the one or more RARs comprise a RAPID corresponding to a preamble that the wireless device sends (e.g., transmits) to a base station (e.g., MsgA preamble). The one or more RARs may comprise an uplink grant indicating one or more uplink resources granted to the wireless device. The wireless device may send (e.g., transmit) one or more transport blocks (e.g., Msg3) via the one or more uplink resources. The wireless device may use the downlink assignment to identify parameters for decoding/detecting the one or more TBs. The downlink assignment may indicate at least one of following: time and/or frequency resource allocation of a PDSCH carrying the one or more TBs, and/or a size of the PDSCH and/or MCS.

An RAR message may be in a form of MAC PDU comprising one or more MAC subPDUs and/or optionally padding. A MAC subPDU may comprise at least one of following: a MAC subheader with Backoff Indicator; a MAC subheader with RAPID (e.g., acknowledgment for SI request); and/or a MAC subheader with RAPID and MAC RAR. A MAC RAR may be fixed size and may comprise at least one of the following fields: an R field that may indicate a Reserved bit; a TAC MAC CE field that may indicate the index value TA (e.g., to control the amount of timing adjustment); an UL grant field that may indicate the resources to be used on the uplink; and/or an RNTI field (e.g., Temporary C-RNTI and/or C-RNTI) that may indicate an identity that is used during the RA procedure. For a 2-step RA procedure, a RAR may comprise at least one of following: a wireless device contention resolution identity, an RV ID for retransmission of one or more TBs, and/or decoding success or failure indicator of one or more TB transmission.

A wireless device may determine that a RAR reception not being successful, for example, based on determining that at least one RAR comprising one or more RAPIDs, matching the transmitted PREAMBLE_INDEX, is not received until the expiration of the RAR window. The wireless device may perform, for example, based on (e.g., in response to and/or after) determining that the RAR reception not being successful, one or more retransmissions of one or more PRACH preambles during the RA procedure. The wireless device may determine retransmissions of the one or more MsgA (e.g., MsgA preamble and/or MsgA payload), for example, based on (e.g., in response to) not receiving at least one MsgB, until the expiration of the RAR window. The at least one MsgB may comprise the contention resolution identifier, which the wireless device may include in MsgA payload during prior transmission. The wireless device may determine one or more retransmissions of one or more preambles of MsgA, for example, based on (e.g., in response to) determining that a contention resolution not being successful. The wireless device may determine, for example, based on Msg 3 for four-step RA procedure and/or MsgB for 2-step RA procedure, whether the contention resolution being successful or not.

A wireless device may start a contention resolution timer (e.g., ra-ContentionResolutionTimer). The wireless device may restart the contention resolution timer at each HARQ retransmission in the first symbol after the end of a Msg3 1313 transmission (e.g., after the wireless device sends (e.g., transmits), to a base station, the Msg3). A wireless device may determine that the contention resolution not being successful, for example, based on not receiving an indication of a contention resolution until the contention resolution timer expires. The wireless device may discard a TEMPRARY_C-RNTI indicated by an Msg2 1312 (or MsgB 1332), for example, after or in response to an expiration of the contention resolution timer (and/or after or in response to a determination of the contention resolution is unsuccessful).

A wireless device may fall back from a 2-step RA procedure to a four-step RA procedure, for example, based on an explicit and/or implicit indication of a MsgB (e.g., based on receiving a fallbackRAR message). An implicit indication of a MsgB may comprise an RNTI used for detecting a PDCCH scheduling the MsgB (e.g., RA-RNTI or MSGB-RNTI). The wireless device may send (e.g., transmit) Msg3, for example, after or in response to receiving the fallback message (e.g., via resource(s) indicated by an UL grant in the MsgB). The wireless device may follow the four-step RA procedure (e.g., starting the contention resolution timer, and/or determining whether the contention resolution being successful or not being successful).

A wireless device may delay, for a particular period of time (e.g., a backoff time), performing a retransmission of one or more Msg1 1311, Msg1 1321, or Msg A 1331. The wireless device may apply the period of time (e.g., the backoff time) to the retransmission, for example, based on or in response to the RA procedure being contention-based random access (CBRA) (e.g., where a preamble being selected by a MAC entity of the wireless device) and/or based on determining that the RA procedure not being completed, for example, after or in response to a successful RAR reception. A backoff time to the retransmission may be applied (e.g., by the wireless device), based on determining that that the RA procedure not being completed after or in response to an unsuccessful contention resolution. The wireless device may set the backoff time to 0 milliseconds if the RA procedure is initiated as described in connection with step 2010. The wireless device may set (or update) the backoff time, for example, based on the PREAMBLE_BACKOFF determined by a value in the backoff indicator (BI) field of the MAC subPDU and/or one or more RRC messages indicating the scaling factor (e.g., SCALING_FACTOR_BI). The wireless device may determine the backoff time, for example, based on a uniform distribution between 0 and the PREAMBLE_BACKOFF.

A wireless device may initiate a 4-step RA procedure. The wireless device may send (e.g., transmit) a preamble (e.g., Msg1 1311) and/or monitor RAR window for receiving a Msg2. The Msg2 may schedule transmission of a Msg3 comprising a C-RNTI MAC CE. The wireless device may detect a PDCCH addressed to C-RNTI, for example, while a contention resolution timer (e.g., ra-ContentionResolutionTimer) is running. The wireless device may indicate the 4-step RA procedure being successfully completed based on (e.g., in response to) determining that the RA procedure was initiated by the higher layers (e.g., MAC sublayer or by the RRC sublayer), and/or the PDCCH is addressed to the C-RNTI that indicates a UL grant for a new transmission.

The wireless device may include a CCCH SDU in the Msg3. The wireless device may detect a PDCCH addressed to a TEMPORARY_C-RNTI, for example, while a contention resolution timer is running. The wireless device may indicate the 4-step RA procedure being successfully completed, for example, based on (e.g., in response to) determining that a Msg4 comprising a Contention Resolution Identity in the MAC CE matches the CCCH SDU in the Msg3.

A wireless device may initiate a 2-step RA procedure. The wireless device may send (e.g., transmit) the C-RNTI (e.g., C-RNTI MAC CE indicating the C-RNTI) via the MsgA. The wireless device may monitor a downlink control channel with C-RNTI and/or MSGB-RNTI (or RA-RNTI). The wireless device may stop monitoring the downlink control channel with the C-RNTI and/or MSGB-RNTI (or RA-RNTI), for example, based on (e.g., after or in response to) receiving a PDCCH addressed to the C-RNTI. The PDCCH may comprise DCI comprising a downlink assignment. The wireless device may receive a PDSCH (e.g., MAC PDU), for example, based on the DCI. The received PDSCH (e.g., MAC PDU) may comprise a TA command (e.g., TA MAC CE). The wireless device may stop monitoring the downlink control channel with the C-RNTI and/or MSGB-RNTI (or RA-RNTI), for example, based on (e.g., after or in response to) receiving the PDCCH addressed to the C-RNTI and/or the corresponding PDSCH (or MAC CE) comprising the TA command. The wireless device may determine, for example, based on receiving the PDCCH, that the 2-step RA procedure being completed successfully, a reception of MsgB being successful, and/or a contention resolution being completed successfully.

A wireless device may receive at least one response (e.g., a PDCCH addressed to the C-RNTI and/or a PDCCH addressed to the MSGB-RNTI), for example, while monitoring msgB-ResponseWindow. The wireless device may determine that the 2-step RA procedure is successfully completed, for example, based on detecting a PDCCH addressed to the C-RNTI (e.g., included in the MsgA). The PDCCH may indicate a PDSCH (e.g., via a downlink assignment of DCI) comprising a TA command. The wireless device may determine that the 2-step RA procedure is successfully completed, for example, based on determining that a PDCCH addressed to the C-RNTI (e.g., included in the MsgA) being detected. The PDCCH may indicate a PDSCH (e.g., via a downlink assignment of DCI) comprising an UL grant (e.g., if the wireless device is already synchronized). The PDCCH addressed to the C-RNTI may comprise an indication of a success response. The wireless device may detect and/or receive a PDCCH addressed to the MSGB-RANTI. The wireless device may receive and/or decode the PDSCH, for example, based on the downlink assignment (e.g., a response to the MsgA). The response to the MsgA may comprise a preamble identifier (e.g., RAPID) that matches the preamble identifier of the preamble that the wireless device sent (e.g., transmitted) to the base station via the MsgA. The response to the MsgA may comprise an explicit or implicit indicator that indicates a success RAR or a fallback RAR (e.g., fallbackRAR MAC subPDU). The wireless device may determine the 2-step RA procedure successfully completed, for example, based on determining that the MsgA comprises the fallbackRAR MAC subPDU and/or the RAP was not selected, among the contention-based RAPs, by the MAC entity. The wireless device may process the received TA command (e.g., TA MAC CE) and/or UL grant value. The wireless device may indicate the received TA command and/or UL grant value to the lower layers (e.g., physical layer).

A wireless device may maintain a counter counting a number of preamble transmissions (e.g., PREAMBLE_TRANSMISSION_COUNTER). The wireless device may increment the counter by a value of counter step (e.g., by 1), for example, based on (e.g., after or in response to) a RAR reception being unsuccessful and/or based on (e.g., after or in response to) a contention resolution being unsuccessful. The wireless device may determine that the RA procedure being unsuccessfully completed. A MAC entity of the wireless device may indicate a RA problem to upper layer(s), for example, based on (e.g., after or in response to) determining that the number of preamble transmissions reached a configured value (e.g., PREAMBLE_TRANSMISSION_COUNTER=preambleTransMax+1). The wireless device may determine that the RA procedure not being completed. One or more retransmissions of one or more Msg1 1311, Msg1 1321, or Msg A 1331 may be performed, for example, based on (e.g., in response to) determining that the number of preamble transmissions being smaller than the configured value (e.g., PREAMBLE_TRANSMISSION_COUNTER<preambleTransMax+1).

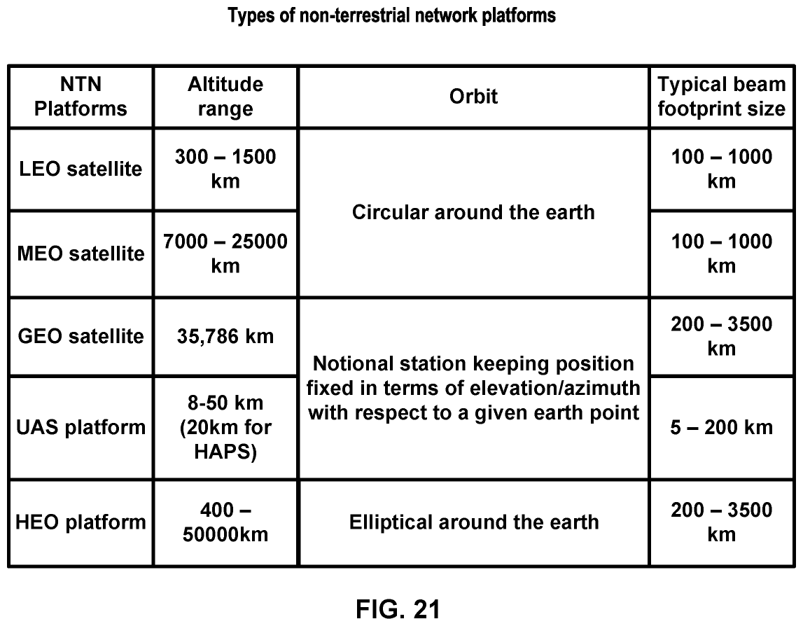

FIG. 21 shows various NTN platforms. An NTN (e.g., a satellite network) may use a space-borne vehicle to embark a transmission equipment relay node (e.g., radio remote unit) or a base station (e.g., an NTN base station). An NTN may comprise a network or a network segment. A terrestrial network may be a network located on the surface of the earth. An NTN may be a network which uses an NTN node (e.g., satellite) as an access network, a backhaul interface network, or both. An NTN may comprise one or more NTN nodes (or space-borne vehicles). An NTN node may embark a bent pipe payload (e.g., transparent payload) or a regenerative payload. The NTN node with transparent payload may comprise transmitter/receiver circuitries without the capability of on-board signal processing (e.g., digital signal processing such as modulation and/or coding). The NTN node may comprise a regenerative payload (e.g., the NTN base station) transmitter/receiver circuitries with the capacity of on-board processing. The capacity of on-board processing may be used to demodulate and/or decode the received signal and/or regenerate the signal before sending it to the earth.

An NTN node may comprise a satellite, a balloon, an air ship, a high-altitude platform station (HAPS), and/or an unmanned aircraft system (UAS). For example, the UAS may be a blimp, a quasi-stationary (or stationary) HAPS, or a pseudo satellite station (e.g., HAPS). A satellite may be placed into a low-earth orbit (LEO) at an altitude between 250 km to 1500 km, with orbital periods ranging from 90-130 minutes. From the perspective of a given point on the surface of the earth, the position of the LEO satellite may change. A satellite may be placed into a medium-earth orbit (MEO) at an altitude between 5000 to 20000 km, with orbital periods ranging from 2 hours to 14 hours. A satellite may be placed into a geostationary satellite earth orbit (GEO) at 35,786 km altitude, and directly above the equator. From the perspective of a given point on the surface of the earth, the position of the GEO may not move.

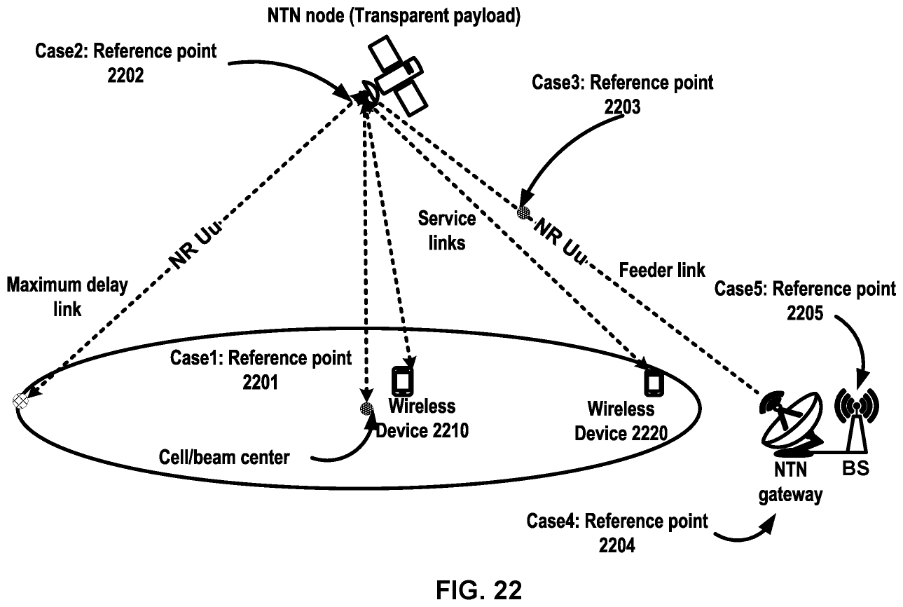

FIG. 22 shows example communications in an NTN. The NTN may comprise one or more transparent NTN platforms (e.g., nodes). The NTN node (e.g., a satellite) may forward a received signal from another satellite (e.g., over inter-link satellite communication links) or a gateway on the ground (e.g., over the feeder communication link) to the earth. The gateway may be collocated with the base station (e.g., the NTN base station), or may be located separately from the base station. The NTN node may forward a received signal, from a wireless device on the Earth, to another NTN node or a gateway on the ground. The signal may be forwarded with amplification and/or a shift between service link frequency (point or a bandwidth) and feeder link frequency.

An NTN node may generate one or more beams over a given area (e.g., a coverage area or a cell). The footprint of a beam (or a cell) may be referred to as a spotbeam. The footprint of a cell/beam may move over the Earth's surface with the satellite movement (e.g., a LEO with moving cells or a HAPS with moving cells). The footprint of a cell/beam may be Earth fixed with some beam pointing mechanism used by the satellite to compensate for the satellite's motion (e.g., a LEO with Earth fixed cells). As shown in FIG. 21, the size of a spotbeam may depend on the system design and may range from tens of kilometers to a few thousand kilometers.

A propagation delay (e.g., between a satellite and the ground or between multiple satellites) may be an amount of time it takes for the head of the signal to travel from a sender (e.g., the NTN base station or the NTN node) to a receiver (e.g., a wireless device) or vice versa. For uplink, the sender may be a wireless device and the receiver may be a base station/access network (e.g., the NTN base station). For downlink, the sender may be a base station/access network (e.g., the NTN base station) and the receiver may be a wireless device. The propagation delay may vary depending on a change in distance between the sender and the receiver (e.g., due to movement of the NTN node, movement of the wireless device, inter-satellite link, and/or feeder link switching).

One or more reference point may be used in an NTN architecture. The configuration of one or more reference points may indicate: uplink timing synchronization (e.g., whether the UL frame and the DL frame are aligned at the base station or not), the pre-compensation of the delay by the base station for UL communications, the pre-compensation of the delay by the wireless device for UL communications, and/or an epoch time for satellite ephemeris data. The one or more reference points in an NTN may allow the wireless device to perform one or more of the following: determining (e.g., estimating/calculating/measuring) the propagation delay (e.g., in the service link), determining (e.g., maintaining/tracking) the propagation delay (or RTD), and/or determining a transmission timing of an UL transmission scheduled by DCI or acting time of a MAC CE.

The base station may configure a reference point 2201 at the cell/beam center (Case 1). In Case 1, the reference point 2201 may be on the ground. The reference point 2201 may have an altitude higher than the wireless devices in the cell/beam (e.g., in order to minimize the propagation delay from the NTN node or base station to the reference point 2201 in the cell/beam. The reference point 2201 may have an altitude above the flight height of commercial airlines. The base station may configure the reference point 2202 at the NTN node (Case 2). In Case 2, the uplink timing synchronization may be achieved at the NTN node, for example, if UL frame and DL frame are not aligned at the base station. The base station may configure the reference point 2203 within the feeder link between the NTN node and the gateway (Case 3). In case 3, the base station may configure the location of the reference point 2203 such that the propagation delay that is pre-compensated by the base station stays fixed despite the movement of the NTN node (e.g., a LEO satellite with Earth fixed cell). The base station may configure the reference point 2204 at the gateway (Case 4). In Case 4, in order to not exposing the location of the gateway to a wireless device (e.g., due to security issues), the reference point 2204 may be considered as an auxiliary reference point. The wireless device may, by determining the auxiliary reference point and a preconfigured compensation time window, determine (e.g., measure/calculate) the feeder link delay without information of the precise location of the gateway. The base station may configure the reference point 2205 at the base station (Case 5). In Case 5, the UL frame and the DL frame may be aligned at the base station (e.g., the NTN base station).

The propagation delay between the base station and the reference point(s) in FIG. 22 may be referred to as a common delay of the cell/beam (e.g., the delay that is experienced by all the wireless devices in the cell/beam). The base station may provide the value of the common delay to all wireless devices in the cell/beam, for example, via a broadcast signaling (e.g., SIB1). The wireless device with GNSS capability may require estimating the propagation delay (or service link delay) based on one or more measurements. The propagation delay may comprise a common delay and one or more other delays. The one or more measurements may indicate the GNSS-acquired location information of the wireless device. The one or more measurements may allow the wireless device to determine (e.g., calculate/estimate) the propagation delay using the GNSS-acquired position and a satellite ephemeris data/information. The one or more measurements may allow the wireless device to determine (e.g., calculate/estimate) the propagation delay using the GNSS-acquired position and the one or more reference points. The one or more measurements may allow the wireless devices to determine estimate/calculate the propagation delay via one or more timestamps (e.g., the timestamp of a configured broadcast signal). The one or more measurements may allow the wireless device to determine (e.g., estimate/measure) a variation rate by which the common delay is changing over a period. The wireless device may determine (e.g., calculate) a drift rate of the common delay, for example, based on the determined (e.g., estimated/measured) variation rate of the common delay. The one or more measurements may allow the wireless device to determine (e.g., estimate/measure) a variation rate (e.g., using the satellite ephemeris data) by which the service link delay may change over a period. The wireless device may determine (e.g., calculate) a drift rate of the service link delay based on the determined (e.g., estimated/measured) variation rate of the service link delay. For a wireless device without a GNSS capability (or when the GNSS precision may not be accurate), the base station may configure the common delay to be equal to a maximum link of the cell/beam. The common delay may be for a group of wireless devices without GNSS capability. Additionally or alternatively, the common delay may be a portion of the propagation delay that is experience by a group of wireless devices (e.g., a feeder link delay plus a portion of a service link delay).

A differential delay within a beam/cell of the satellite may be determined (e.g., calculated), for example, based on the maximum diameter of the beam/cell footprint at nadir (e.g., the maximum delay link). The differential delay may indicate a maximum difference between communication latency that two wireless devices may experience while communicating with the NTN node (e.g., the NTN base station). As described herein, an NTN node (e.g., an NTN base station) may comprise one or more of a terrestrial base station and/or a satellite base station. A differential delay may indicate a difference between communication latency experienced by wireless device 2210 and wireless device 2220. The wireless device 2210 may be located close to the center of the cell/beam. The wireless device 2220 may be located close to the edge of the cell/beam. The wireless device 2210 may experience a smaller RTD compared to the wireless device 2220. The link to the edge of the cell/beam may experience a maximum propagation delay in the cell/beam. The link to a cell/beam center may experience the minimum propagation delay in the cell/beam. For a LEO satellite, the differential RTD may be 3.12 milliseconds.

The base station may configure no reference points. The wireless device may, based on determining that no reference point being configured by the base station, assume the reference point is located at the NTN node. The base station may indicate a portion of the propagation delay that the wireless device is expected to pre-compensate. The indication may be sent via BSI. The wireless device may pre-compensate, based on determining the one or more reference points not being configured, the service link delay and/or a portion of the service link delay.

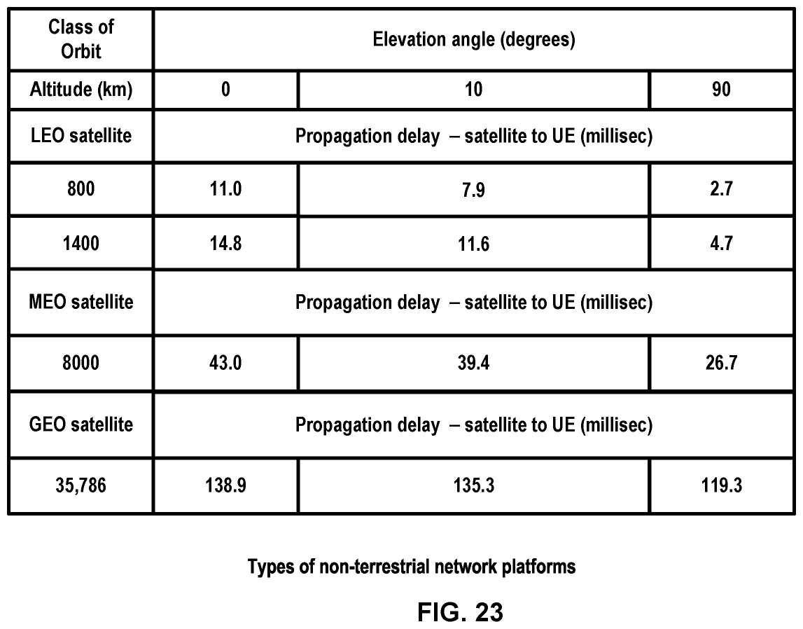

FIG. 23 shows examples of various propagation delays. The various propagation delay may correspond to NTN nodes at different altitudes. The propagation delay may refer to one-way latency. The one-way latency may be an amount of time required to propagate signals through a telecommunication system, for example, from a transmitter to the receiver. For the transparent NTN, the RTD may comprise service link delay (e.g., between the NTN node and the wireless device), feeder link delay (e.g., between the NTN gateway and the NTN node), and/or between the gateway and the base station (e.g., if the gateway and the NTN base station are not collocated). The RTD may be four times of one-way latency, for example, for GEO satellite with transparent payload. For example, as shown in FIG. 23, a one-way delay may be between a wireless device and a satellite, and RTD may be four times the one-way delay. Additionally or alternatively, if a one-way delay corresponds to delay between a wireless device and a base station, then RTD may be two times the one-way delay. For example, a one-way latency for GEO satellite may be 138.9 milliseconds. An RDT for GEO satellite may be approximately 556 milliseconds. An RTD of a terrestrial network may be less than 1 millisecond. An RTD of a GEO satellite may be hundreds of times longer than the one of terrestrial network. An RTD of a terrestrial network (e.g., NR, E-UTRA, LTE) may be negligible compared to the RTD of an NTN. In at least some systems, a maximum RTD of a LEO satellite with transparent payload with altitude of 600 km may be 25.77 milliseconds, and/or for a LEO satellite with transparent payload with altitude of 1200 km, the maximum RTD of may be 41.77 milliseconds.

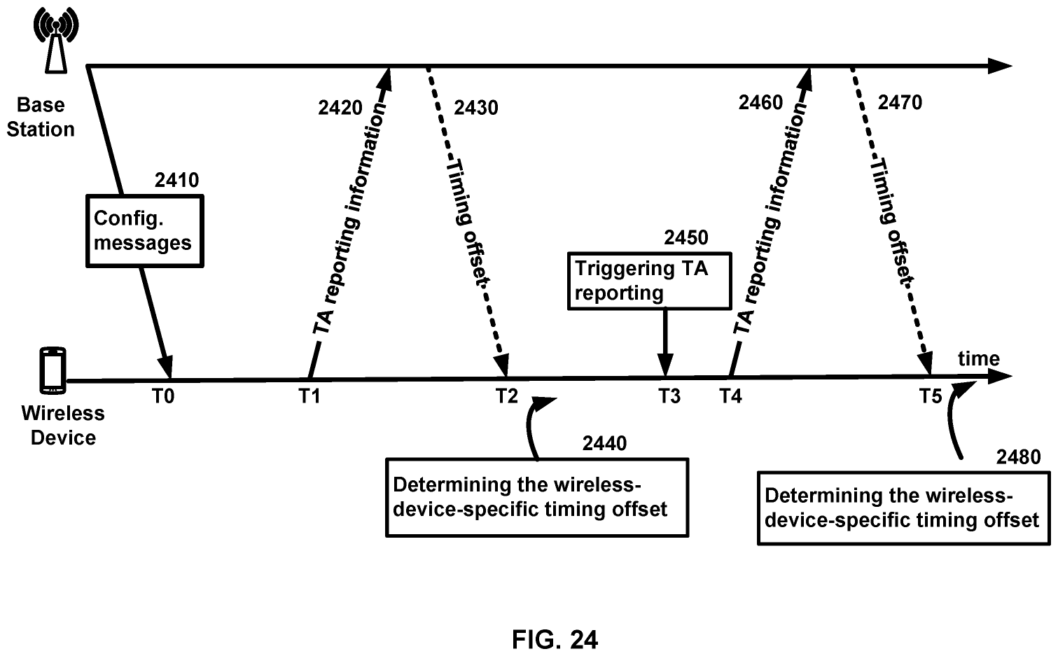

FIG. 24 shows an example of timing advance (TA) reporting in a non-terrestrial network (NTN). TA reporting procedure may be triggered if at least one condition is met. The wireless device may send TA reporting information (e.g., to a base station). The wireless device may send the TA reporting information, for example, based on the triggered TA reporting procedure. The base station may send (e.g., based on the TA reporting information) a timing offset (e.g., a device-specific timing offset). The timing offset may be used to determine a device-specific timing offset. The device-specific timing offset may be used as TA while the wireless device communicates with the base station, for example, in the NTN.

At step 2410, a wireless device may receive (e.g., at or after time TO) one or more configuration messages from the base station. The one or more configuration messages may comprise: one or more first configuration messages, one or more second configuration messages, and/or one or more third configuration messages. The one or more configuration parameters may be received via broadcast information system (SIB). The one or more first configuration messages may comprise/indicate configuration parameters of one or more of: PUCCH resources, RACH configurations one or more BSR configurations, a plurality of SRs configurations, and/or a plurality of configured grant configurations. The second configuration messages may comprise/indicate one or more configuration parameters facilitating and/or managing determination (e.g., calculation) of propagation delay and/or TA (e.g., at the wireless device). The second configuration messages may comprise: one or more satellite ephemeris parameters, one or more common delay (e.g., network-controlled common delay) parameters, one or more TA parameters, one or more reference points, one or more validity periods (also referred to as validity windows, validation periods, and/or validation windows), one or more timing offset parameters, and/or one or more TA margins. The one or more third configuration messages may comprise one or more TA reporting configuration parameters.

The one or more timing offset parameters may comprise one or more first timing offset parameters (e.g., a first timing offset parameter) correspond to cell-specific propagation delay. The base station may determine (e.g., calculate or configure) the first timing offset parameter(s) as a function of the maximum propagation delay of the cell. The wireless device may determine (e.g., calculate or maintain) a cell/beam-specific timing offset, for example, based on the first timing offset parameter(s). The wireless device may determine (e.g., track, update, or maintain) the cell/beam-specific timing offset based on receiving the first timing offset parameter(s) from the base station. The first timing offset parameter(s) may be updated by the base station.

The one or more timing offset parameters may comprise second timing offset parameters corresponding to one or more beam-specific timing offsets. Each of the one or more beam-specific timing offsets may respectively correspond to one or more maximum propagation delays of the one or more corresponding beams in the cell. An n-th entry of the one or more beam-specific timing offsets may correspond to the maximum propagation delay of an n-th beam (e.g., a virtual beam) of the cell, for example, if the cell comprises more than one beam indexed by n. The n-th entry of the one or more beam-specific timing offsets may indicate a difference between the maximum propagation delay of the cell (e.g., indicated in the first timing offset parameters) and the maximum propagation delay of the n-th beam of the cell. The wireless device may determine the cell/beam-specific timing offset, for example, based on the second timing offset parameters and/or the first timing offset parameters. The wireless device may determine the cell-specific timing offset or the beam-specific timing offset, for example, based on a beam indicator/index indicating the beam that is used for communication with the base station (or the NTN node) in the cell.

The one or more timing offset parameters may comprise one or more third timing offset parameters (e.g., a third timing offset). The third timing offset parameter(s) may indicate a portion of the propagation delay that the base station may pre-compensate, for example, in an NTN scenario with a transparent NTN node and/or if the UL frame and DL frame is unaligned at the base station. The third timing offset parameter(s) may indicate the difference between the UL frame timing and the DL frame timing, for example, if the UL frame and/or DL frame is unaligned at the base station. The third timing offset parameter(s) may be absent from the second configuration parameters, for example, in an NTN with a transparent NTN node. The wireless device may set a K_mac timing offset by 0 based on a determination that the third timing offset parameter(s) not being indicated in the second configuration messages.

The one or more reference points may be used by the wireless device to determine the uplink timing synchronization, to determine (e.g., measure or calculate) the feeder link delay (e.g., without knowing the gateway's location), to determine the service link delay (or a portion of the service link delay), to determine the UL/DL frame alignment, and/or to determine (e.g., measure) the epoch time of the satellite ephemeris parameters.

The one or more validity periods may comprise a first validity period that indicates a validity period during which location (e.g., position) information of GNSS-acquired data is considered as accurate. The first validity period may indicate a maximum period in which an acquired GNSS location information stays valid (e.g., comply with required accuracy requirement and/or a maximum tolerable error). The GNSS location information may be acquired by the wireless device. The wireless device may restart the first validity period based on (e.g., in response to or after) acquiring new GNSS location information (e.g., data). The wireless device may acquire new GNSS location information (e.g., based on determining that the first validity period is expired). The wireless device may (re)start the first validity period/window if (e.g., after) the new GNSS location information is acquired.

Transmissions from different wireless devices in a cell/beam may be time-aligned at the base station and/or the NTN node (e.g., satellite) to maintain uplink orthogonality. Time alignment/synchronization may be achieved by using different TA values at different wireless devices to compensate for their different propagation delays (e.g. RTDs). The wireless device may determine (e.g., calculate/measure/maintain) a current TA value (and/or a round trip transmission delay (RTT) between the wireless device and base station), for example, based on a combination of a closed-loop TA procedure/control and an open-loop TA procedure/control. The closed-loop TA procedure/control may be based on receiving a TA (e.g., an absolute TA) command. The TA command may be received from the base station. The TA command may be received from a MAC CE or a Msg2 1312 (or MsgB 1332). The wireless device may determine (e.g., maintain/calculate) a closed-loop TA value based on (e.g., in response to or after) receiving each TA command MAC CE. The open-loop TA procedure/control may be based on GNSS-acquired position of the wireless device and/or the second configuration messages. Combining of the closed-loop TA control/procedure and the open-loop TA procedure/control may comprise resetting the closed-loop TA value (e.g., accumulative closed-loop TA value) to a predefined value (e.g., 0), for example, if a new GNSS-acquired position becomes available and/or if the wireless device acquires (e.g., reads) the second configuration messages. Combining of the closed-loop TA control and the open-loop TA control may comprise adding the open-loop TA value (e.g., derived/calculated based on the open-loop TA procedure/control) to the closed-loop TA value (or a portion of the closed-loop TA procedure/control).

The one or more TA-margins (if provided) may be used by the wireless device to compensate one or more errors induced, for example, while measuring/calculating (e.g., autonomously) the propagation delay and/or the current TA value at the wireless device. The base station may configure the one or more TA-margins based on pre-compensation accuracy requirement(s) and/or UL timing synchronization requirement(s). The wireless device may adjust the current TA value based on the one or more TA-margins, for example, for sending (e.g., transmit) a preamble in a RA procedure. If the one or more TA-margins not being provided, the wireless device may expect receiving a TA command (e.g., via the TAC field of a Msg2 1312 or MsgB 1332) with either a positive value or a negative value (e.g., via a bipolar TA command field) to account for an underestimate or overestimate of the propagation delay at the wireless device, respectively.

The satellite ephemeris parameters may comprise the satellite ephemeris information (e.g., data), an epoch time for the satellite ephemeris information, a second validity period, and/or one or more drift rates corresponding to the satellite ephemeris information. The one or more drift rates may indicate one or more variation rates of the satellite location/movement associated with orbital decay/atmospheric drag. The wireless device may use the satellite ephemeris parameters to determine (e.g., measure/calculate/maintain) movement pattern of the satellite, determine (e.g., estimate/measure) the service link delay, and/or to adjust the current TA value (e.g., via the open-loop TA procedure/control). The wireless device may determine, for example, based on an implemented orbital predictor/propagator model. The one or more drift rates may comprise a drift rate (e.g., a first-order drift rate), a variation rate of the drift rate (e.g., a second order drift rate), and/or a variation rate of the second-order drift rate (e.g., a third order drift rate). The satellite ephemeris information may be configured in one or more satellite ephemeris formats.

The wireless device may determine (e.g., maintain/calculate/update) the propagation delay (e.g., the service link delay or the open-loop TA value). The determination may be based on the one or more satellite ephemeris parameters (e.g., the one or more drift rates). The second validity period may indicate the validity time of the ephemeris (e.g., satellite ephemeris) parameters. The wireless device may skip, during the second validity period, a frequent acquiring (e.g., reading) of the second configuration messages. The wireless device might not acquire a new satellite ephemeris data during the second validity period. The second validity period may indicate (e.g., specify) a maximum period (e.g., corresponding to an orbit predictor/propagator model the wireless device is using to determine the propagation delay and/or a maximum tolerable error in determining the open-loop TA value) during which the wireless device does not update (e.g., read or acquire) the satellite ephemeris parameters. The wireless device may start (e.g., restart) the timer corresponding to the second validity period, for example, based on (in response to or after) acquiring new satellite ephemeris data.

The one or more TA parameters may indicate may indicate a common TA (e.g., common delay), a third validity period (e.g., a common TA validation period), and/or one or more higher-order (e.g., a first-order, a second-order and/or a third-order) drift rates of the common TA. The common TA may be indicated with a predefined granularity, for example, one slot or based on the granularity of the TAC MAC CE. The third validity period may indicate a maximum period during which the wireless device need not to acquire the common TA or the open-loop TA. The third validity period may indicate a maximum period during which the wireless device might not acquire the new second configuration messages. If the third validity period is absent from the second configuration messages, the wireless device may set the third validity period, for example, based on the second validity period. The second-order drift rate of the common TA may indicate the variation rate by which the drift rate of the common TA changes over a predefined period (e.g., the third validity period). A third-order drift rate of the common TA may indicate a variation rate corresponding to the second-order drift rate of the common TA by which the second-order drift rate of the common TA changes over a predefined period (e.g., the third validity period).

The wireless device may start (e.g., restart) the second validity period, for example, based on (e.g., after or in response to) receiving/reading new satellite ephemeris parameters. The wireless device may start (e.g., restart) the third validity period, for example, based on (e.g., after or in response to) reading/receiving new common TA parameters and/or a new common TA. The wireless device may start (e.g., restart) the first validity period, for example, based on (e.g., after or in response to) acquiring a new location information of the wireless device using GNSS data.

The wireless device may acquire updated satellite ephemeris information based on (e.g., in response to or after) determining that the second validity period is expired. The wireless device may acquire an updated common TA, for example, based on (e.g., in response to or after) determining that the third validity period is expired. The wireless device may acquire an updated GNSS location information, for example, based on (e.g., in response to or after) determining that the first validity period/window is expired.

The wireless device may determine (e.g., calculate/measure/update) the current TA value (e.g., the open-loop procedure/control), for example, based on (e.g., in response to or after) receiving (e.g., reading) the updated satellite ephemeris information, updated common TA, and/or the updated GNSS location information. The wireless device may update the current TA value, for example, based on the closed-loop TA procedure/control. The closed-loop TA procedure/control may be based on, for example, receiving the TAC MAC CE.

The wireless device may set the common TA by zero, for example, based on (e.g., in response to or after) determining that the common TA parameters are absent from the second configuration message. The wireless device might not pre-compensate the common TA, for example, if the UL timing synchronization is held at the NTN node. The wireless device might not pre-compensate the common TA, for example, for an NTN with a transparent payload NTN node (e.g., LEO satellite).

The base station may periodically broadcast (e.g., every 160 milliseconds) the second configuration messages and/or the third configuration messages (e.g., via a SIB). The wireless device may determine not to acquire and/or read the second configuration messages, for example, based on determining that the second validity period (and/or the third validity period) are configured and that the second validity period (and/or the third validity period) is larger than the periodicity by which the second configuration messages are sent (e.g., broadcast). The wireless device may determine not to reading and/or acquiring the second configuration messages, for example, if the second validity period (and/or the third validity period) is running. A periodicity, by which the wireless device may acquire the second configuration messages, may be determined (e.g., by the wireless device), for example, based on whether one or more drift rates (e.g., the one or more drift rates of the satellite ephemeris parameters and/or the one or more drift rates of the common TA parameters) are configured. The wireless device may skip reading/acquiring the second configuration messages over a time window that the inaccuracy of the currently maintained/estimated propagation delay is considered tolerable, for example, if the one or more drift rates of the common TA (and/or the one or more drift rates of the satellite ephemeris parameters) are configured. The wireless device may periodically acquire the second configuration messages, for example, based on determining the second validity period (and/or the third validity period) are not configured.

The wireless device may (e.g., autonomously) determine (e.g., adjust/update/recalculate) the current TA value, for example, based on the one or more drift rates (if provided). The base station, by providing the at least one or more drift rates and/or the at least one or more variation rates (via the second configuration messages), may reduce the signaling overhead (e.g., for calculating/maintaining the open-loop TA value. The wireless device may determine (e.g., maintain/track) a change in the propagation delay (or the open-loop TA value) for a period (e.g., 3 seconds). The wireless device may determine (maintain/track) a change in the propagation delay (or the open-loop TA value) for an extended period (e.g., 35 seconds), for example, if the one or more drift rates are provided and the one or more variation rates of the one or more drift rates are provided. A change in propagation delay may depend on how many drift rates are configured (e.g., if one drift rate is configured, then 3 seconds may be used; if three drift rates are configured, then 35 seconds may be used; any other quantity of draft rate may correspond to any other time duration). Additionally or alternatively, a validity timer (e.g., a second validity timer, a third validity timer, or an n-th validity timer where n may be any quantity) may indicate a value of a change in propagation delay. The base station may (e.g., to increase the capability of the wireless device to determine (e.g., track/maintain) the change in the propagation delay) indicate one or more configuration parameters. The one or more configuration parameters may correspond to a third order approximation of the feeder link delay, a third order approximation of the satellite movement, a third order approximation of the common delay, and/or the like.

At step 2420, the wireless device may send (e.g., transmit) TA reporting information to the base station. The TA reporting information may comprise device-specific TA information. The TA reporting information may be based on the current TA value of the wireless device and/or the location information of the wireless device. The TA reporting information may indicate one or more of the following: the current TA value, a portion of the propagation delay that is autonomously calculated/measured by the wireless device, a portion of the propagation delay that is pre-compensated by the wireless device, the service link delay, the propagation delay between the wireless device and a configured reference point (e.g., indicated based on the one or more reference points as described in connection with FIG. 22), a difference between a calculated measurement (e.g., based on the current TA value) by the wireless device and the device-specific timing offset, a difference between a calculated measurement and the cell/beam-specific timing offset, the propagation delay between the base station and the wireless device, the open-loop TA value, a portion of the open-loop TA (e.g., the portion that is autonomously calculated/maintained by the wireless device), the location information of the wireless device, a difference between the cell/beam-specific timing offset and the current TA value, and/or a difference between the device-specific timing offset and the current TA value. The location information of the wireless device may comprise a quantized location of the wireless device or a change in the position of the wireless device. The description provided regarding the TA reporting information should not be considered limited to examples provided in this disclosure. It will be recognized by those of skill in the art recognize variations of TA reporting information may also be applied to examples described herein.

The wireless device may send (e.g., transmit) the TA reporting information via a MAC CE command (e.g., TA reporting MAC CE) or an RRC signaling (e.g., an RRC reconfiguration message). The TA reporting information may be sent, for example, based on a network request (e.g., a MAC CE command and/or a DCI) or during an initial access. As discussed in greater detail below, the TA reporting information may be based on a triggered TA reporting procedure.

The base station may configure a logical channel for the TA reporting information (e.g., corresponding to the RRC signaling or the MAC CE command). The base station may configure the logical channel of the TA reporting information with a pre-configured priority. The wireless device may send (e.g., transmit) the TA reporting information 2420/2460 via available UL-SCH resource(s). Whether the UL-SCH resource(s) for sending (e.g., transmitting)) the TA reporting information is available or not may be based on, for example, a logical channel prioritization procedure. A configured grant (e.g., Type 1 and/or Type 2), random access procedure, and/or an SR for BSR procedure may be used for sending (e.g., transmitting) the TA reporting information.

For sending (e.g., transmitting) the TA reporting information during initial access (e.g., while the wireless device conducting/initiating random access in an RRC_IDLE state and/or an RRC_INACTIVE state), the wireless device may be configured to send (e.g., transmit) the TA reporting information to the base station via RA procedure. The configuration may be based on information in the third configuration messages. The wireless device may be configured to not transmit the TA reporting information to the base station via RA procedure, for example, if the wireless device is in an RRC_CONNECTED mode.

At step 2430, the wireless device may receive a timing offset. The timing offset may be received from the base station. For example, as shown in FIG. 24, the wireless device may receive a timing offset at time T2. The timing offset may be determined (e.g., calculated), by the base station, for example, based on TA reporting information (e.g., received from the wireless device).

The base station may calculate the timing offset, for example, based on the location information of the wireless device. The base station may provide the timing offset, for example, in order to improve UL data transmission efficiency (e.g., reduce the transmission latency) of the wireless device. For example, if the wireless device is located near the cell center or near a beam center (e.g., wireless device 1 at FIG. 22), the difference between the cell/beam-specific timing offset and the propagation delay of the wireless device may become significant (e.g., close to the differential delay of the cell/beam).

The wireless device may receive a message (e.g., an RRC message or a MAC CE command) comprising updated information corresponding to (e.g., indicating) the timing offset, for example, in response to the TA reporting information. The updated information (e.g., timing offset 2430 and/or timing offset 2470) may indicate a difference between the cell/beam-specific timing offset and the timing offset, or a difference between the device-specific timing offset and the timing offset. The base station may determine/calculate the device-specific timing offset. The device-specific timing offset may be greater than a current/prior TA value of the wireless device and/or less than a cell-specific timing offset.

The timing offset may be indicated by a message (e.g., an RRC signaling or a MAC CE command). The RRC signaling may comprise an RRC reconfiguration message. The MAC CE command may comprise a timing offset MAC CE command (e.g., Koffset_UE MAC CE command).

At step 2440, the wireless device may determine (e.g., maintain, set, or calculate) the device-specific timing offset (e.g., Koffset_UE) based on the timing offset. The timing offset may be the same as the device-specific timing offset. The received timing offset may be different from the device-specific timing offset.

The wireless device may determine the device-specific timing offset is not available/maintained, for example, at time T2 when the wireless device receive the timing offset 2430. The device-specific timing offset may be available/maintained after an initial access procedure and/or prior to time T2. The device-specific timing offset may not be available/maintained at the wireless device at time T2, for example, if the wireless device has discarded/deleted the wireless-device-specific timing offset by time T2, and/or if the wireless device did not receive, from the base station via one or more previous communications, the timing offset.

The wireless device may calculate the device-specific timing offset, for example, based on (e.g., in response to or after) receiving the timing offset. For example, the wireless device may determine the device-specific timing offset based on the timing offset from the base station. The wireless device may determine (e.g., maintain/calculate) the device-specific timing offset based on the timing offset from the base station, a prior device-specific timing offset, the third timing offset parameter(s), and/or the cell/beam-specific timing offset. For example, the wireless device may determine a new device-specific offset from a prior/current device-specific offset (e.g., a maintained/available device-specific timing offsets) and a timing offset received from the base station.

The wireless device may be configured, based on the third configuration messages (e.g., the TA reporting configuration messages) to report the TA reporting information in response to or after a reporting request (e.g., a DCI or a MAC CE) that is received from the base station. The configuration may occur while the wireless device is in an RRC_CONNECTED state. The wireless device may determine (e.g., calculate/measure) the current TA and send TA reporting information, for example, based on the reporting request. The wireless device may be configured, for example, based on the third configuration messages, to periodically report the TA reporting information. The third configuration messages may indicate a periodicity by which the TA reporting information is to be sent (e.g., transmitted) and/or UL-SCH resource(s) (e.g., Type 1 or Type 2 configured grants) for sending (e.g., sending (e.g., transmitting)) the TA reporting information.

The third messages may indicate at least one TA condition for triggering the TA reporting procedure. For example, the at least one TA condition may comprise a first TA condition corresponding to a change in the current TA value and/or a second TA condition corresponding to a difference between the device-specific timing offset and the current TA value. The change in the current TA value may be determined, for example, based on a difference between the current TA value and the previous TA value). The previous TA value may be determined (e.g., calculated/measured) before (in time) the current TA value. For example, the previous TA value may correspond to a last TA reporting information. The TA reporting procedure may be triggered based on the first TA condition, for example, where the current TA value is greater than (or less than) a previous TA value (e.g., if variation between a current TA value and a previous TA value is greater than a threshold), and/or the change in the current TA value is greater (or smaller) than a threshold. The TA reporting procedure may be triggered based on the second TA condition, for example, where the difference between the device-specific timing offset and the current TA value is less than a second threshold.

At step 2450, the wireless device may trigger, at time T3, a TA reporting procedure, for example, based on the at least one TA condition being satisfied. At step 2460, the wireless device may send (e.g., transmit) the TA reporting information, for example, based on the triggered TA reporting. The TA reporting information may be sent using available UL-SCH resource(s). Step 2460 may be implemented similar as described at step 2420. At step 2470, the wireless device may receive a timing offset. Step 2470 may be implemented similar as described at step 2430. At step 2480, the wireless device may determine a device-specific timing offset. Step 2480 may be implemented similar to step 2440.

The cell/beam-specific timing offset and/or the device-specific timing offset may be used, by the wireless device, to ensure/guarantee the causality of an uplink grant (e.g., scheduled by a DCI). The wireless device may determine timing of an UL transmission using the cell/beam-specific timing offset and/or the device-specific timing offset. The UL transmission may be scheduled by a DCI, a HARQ-ACK/NACK on PUCCH corresponding to a PDSCH scheduled by a DCI, a HARQ-ACK on PUCCH corresponding to deactivation of semi-persistent scheduling indicated via a PDCCH, a transmission opportunity of a configured grant (e.g., Type 2 configured grant), and/or a PRACH occasion for transmission of a preamble ordered by a PDCCH.

The wireless device may use the cell/beam-specific timing offset (if available or maintained) to determine the transmission timing of one or more of the following: a random access response (RAR) grant scheduled PUSCH (e.g., based on or in response to receiving a Msg2 1312 in a 4-step RA procedure); a fallbackRAR grant scheduled PUSCH (e.g., based on or in response to receiving a MsgB 1332 in a two-step RA procedure); a Msg3 1313 retransmission scheduled by a DCI format 0_0 with/having CRC parity bits scrambled by TC-RNTI; HARQ-ACK on PUCCH indicating the success contention resolution; and/or a PRACH occasion for transmission of a preamble ordered by a PDCCH. A contention resolution PDSCH may be scheduled by DCI format 0_1 with CRC parity bits scrambled by a TC-RNTI in an RA procedure, or by DCI format 0_1 having/with CRC parity bits scrambled by a TC-RNTI in a two-step RA procedure.

If the cell/beam-specific timing offset and/or the device-specific timing offset is available/maintained, the wireless device may refrain from using the beam-specific timing offset to determine the scheduling time of a PUSCH transmission. The PUSCH transmission may be scheduled by one or more of the following: a RAR UL grant; a fallbackRAR UL grant for RACH procedure; and/or PUSCH grant scheduled by a PDCCH addressed to TC-RNTI. The wireless device may use the device-specific timing offset (if available or maintained) to determine the scheduling/transmission time of an UL grant that may not be one or more of the following (e.g., for the following, a wireless device may be required to use a cell-specific timing offset, for example, even if a device-specific timing offset is indicated): a RAR grant scheduled or a fallbackRAR grant; the transmission timing of an aperiodic SRS scheduled by a first DCI; for a CSI reference resource timing corresponding to a CSI reference resource timing; the transmission timing of a CSI reporting over PUSCH scheduled by a second DCI, a HARQ-ACK/NACK on PUCCH corresponding to a contention resolution PDSCH scheduled by detecting a third DCI; a HARQ-ACK on PUCCH corresponding to deactivation of semi-persistent scheduling indicated via a PDCCH; and/or a first transmission opportunity of a configured grant (e.g., Type 2 configured grant). The third DCI may be a DCI format 0_1 having/with CRC parity bits scrambled by or a DCI format 0_1 having/with CRC parity bits scrambled by a TC-RNTI.

The wireless device may use the device-specific timing offset (if available or maintained) to determine a scheduling timing of an UL grant scheduled by a PDCCH. The UL grant may be scrambled/addressed by a C-RNTI, MCS-RNTI, or CS-RNTI. The wireless device may use the device-specific timing offset (if available or maintained) to determine a scheduling timing of a HARQ-ACK/NACK on PUCCH scheduled by a PDCCH that is not addressed to at least one of TC-RNTI, RA-RNTI, and/or MSGB-RNTI.

The wireless device may obtain (e.g., ensure/guarantee) a correct activation time (or the wireless assumption in a downlink configuration or the wireless assumption in an uplink configuration) of a MAC CE command (e.g., a PUCCH spatial relation activation/deactivation MAC CE, semi-persistent CSI reporting on PUCCH activation/deactivation MAC CE, TAC MAC CE, a periodic CSI trigger state sub-selection), for example, based on at least the cell/beam-specific timing offset, the device-specific timing offset, and/or a reception time of a PDSCH carrying the MAC CE command in the downlink configuration.

If the wireless device sends (e.g., transmits) a PUCCH with HARQ-ACK information in an uplink slot n (e.g., based on the TA value) corresponding to a PDSCH carrying a MAC CE command on the uplink configuration, the wireless device's action and/or assumption on the downlink configuration may be applied starting from the first slot that is after slot n+3Nₛₗₒₜ^{subframe,μ}, where μ is the SCS configuration for the PUCCH. If a MAC CE command, received in downlink slot n, is used to indicate to the wireless device about an action in the downlink or an assumption on the downlink configuration, the wireless device may determine (e.g., assume) the command is activated in the downlink slot, which is the first downlink slot after the uplink slot n+k₁+3Nₛₗₒₜ^{subframe,μ}, TA may be assumed to be zero, k₁ may be determined based on the cell/beam-specific timing offset, the third timing offset (if the UL frame and the DL frame are not aligned at the base station), the device-specific timing offset (if available/maintained), and/or the UL slot indexed by n+k₁. The wireless device may send (e.g., transmit) HARQ-ACK corresponding to the received PDSCH carrying the MAC CE command.

The wireless device's action and/or assumption on the uplink configuration may be applied starting from the first slot that is after slot n+3Nₛₗₒₜ^{subframe,μ}, where μ is the SCS configuration for the PUCCH, for example, if the wireless device sends (e.g., transmits) a PUCCH with HARQ-ACK information in an uplink slot n (e.g., based on the TA value) corresponding to a PDSCH carrying a MAC CE command on the uplink configuration. The wireless device may determine the command is activated in the uplink slot n+k₁+3Nₛₗₒₜ^{subframe,μ}+1, for slot example, if a MAC CE command is received in downlink slot n. The MAC CE command may be used to indicate to the wireless device about an action in the uplink or an assumption on the uplink configuration. TA may be assumed to be zero. k₁ may be determined based on the cell/beam-specific timing offset, the device-specific timing offset, and/or the UL slot indexed by n+k₁. The wireless device may send (e.g., transmit) HARQ-ACK corresponding to the received PDSCH carrying the MAC CE command.

The wireless device may, by using the cell/beam-specific timing offset, the third timing offset parameters (if not zero), and/or the second timing offset parameters, obtain (e.g., ensure/guarantee) a correct activation time (or the wireless assumption in a downlink configuration) of the MAC CE command based on a reception time of a PDSCH carrying the MAC CE command in the downlink configuration. The MAC CE command may be one of PUCCH spatial relation activation/deactivation MAC CE, semi-persistent CSI reporting on PUCCH activation/deactivation MAC CE, TAC MAC CE, a periodic CSI trigger state subselection, TCI state indication for device-specific PDCCH MAC CE, and/or TCI state activation/deactivation for device-specific PDSCH MAC CE.

As discussed herein, the base station may configure the wireless device with the at least one TA condition for triggering the TA reporting, for example, if the wireless device communicates with the base station via a NTN. The configuration may be based on one or more configuration messages 2410. The wireless device may send (e.g. transmit) the TA reporting information to the base station, for example, based on (e.g., in response to) the TA reporting procedure being triggered. The wireless device may determine (e.g., maintain/calculate) the device-specific timing offset based on receiving the timing offset.

At least some wireless devices may have difficulties managing TA reporting procedures. For example, a wireless device may encounter difficulties (e.g., ambiguities) to determine whether and/or under what condition a triggered TA reporting procedure needs to be canceled, and/or whether TA reporting information needs to be sent more than one time while the triggered TA reporting procedure is pending. Such difficulties/ambiguities may lead to issues such as increased consumed power of the wireless device and/or increased interference to one or more other wireless devices. For example, having a TA reporting procedure pending for a time period longer than necessary may cause a wireless device to send (and/or re-send) the TA reporting information unnecessarily. Enhancements described herein are provided for managing the TA reporting in an efficient manner.

Additionally or alternatively, for at least some communications, a time at which TA reporting information is sent, after the TA reporting procedure is triggered, may be uncertain, for example, if no uplink (e.g., UL-SCH) resource is available for sending the TA reporting information. If a wireless device triggers an SR for a BSR procedure to send the TA reporting information (e.g., based on no UL-SCH resource being available), transmission latency and/or the power consumption of the wireless device may be increased. Enhancements described herein may provide improvements such as increased efficiency of sending the TA reporting information and/or reduced delay in communicating TA reporting information.

Additionally or alternatively, at least some wireless devices may be unable to determine whether a transmission timing of an uplink grant (e.g., scheduled by DCI) is based on a cell/beam-specific timing offset or a device-specific timing offset. For example, DCI may indicate a transmission time of an UL grant using a cell/beam-specific timing offset (e.g., due to the base station not having information associated with the current device-specific timing offset). A wireless device may communicate with the base station, via the UL grant, based on the device-specific timing offset. The wireless device may, for example, due to a misalignment in timing between the wireless device and a base station, interfere with other wireless devices in the cell/beam. For example, the UL grant may collide/overlap with a second UL transmission (e.g., a fallbackRAR grant, a RAR grant, a successRAR grant, or a preamble transmission corresponding to a PRACH occasion ordered by a PDCCH). This may result in an increase of the power consumption of the wireless device, an increase of the interference on other wireless devises, and/or the need to re-send the UL grant and/or the second UL transmission. Enhancements are described herein for managing the TA reporting procedure, for example, in order to allow a wireless device to determine the transmission timing of an uplink grant correctly (e.g., aligned with a base station), and/or to reduce interference to one or more other wireless devices.

In order to overcome limitations described herein, and/or to overcome other limitations that will be apparent from the descriptions herein, a wireless device may cancel a pending TA reporting procedure based on one or more conditions such as: an expiration of a first timer, a timing offset from the base station being received, and/or no uplink (e.g., UL-SCH) resource(s) being available for sending the TA reporting information. The wireless device may start the first timer based on the TA reporting procedure being triggered. The wireless device may send TA reporting information for one or more times while the TA reporting procedure is pending. The wireless device may determine not to send (e.g., may refrain from sending) the TA reporting information for an additional time after the triggered TA reporting procedure is canceled. Ambiguities in terms of whether and/or when to send TA report information may be reduced by performing operations described herein. Additionally or alternatively, operations described herein may lead to advantages, such as reduced power consumption of the wireless and/or reduced interference to other wireless devices.

As described herein, a wireless device may send (e.g., transmit) TA reporting information one or more times, for example, while the TA reporting procedure is pending and/or based on not receiving the timing offset (e.g., from the base station). The wireless device may cancel the triggered TA reporting procedure, for example, based on determining that the number of times the TA reporting information is to be sent satisfies (e.g., is equal to or greater than) a threshold. The threshold may be indicated by one or more configuration messages described herein. By canceling the triggered TA reporting, power consumption of the wireless device may be reduced, the interference on other wireless devices may be reduced, and/or the transmission efficiency may be improved.

As described herein, a wireless device may send (e.g., transmit) TA reporting information by triggering an SR procedure, for example, based on a TA reporting procedure being pending. The SR may correspond to a SR configuration indicated by the one or more configuration messages as described herein. The one or more messages may comprise one or more SR configuration parameters. The one or more SR configuration parameters may correspond to TA reporting. A wireless device, by triggering an SR, may receive an uplink grant for sending the TA reporting information, for example, instead of an uplink grant for sending any unspecified new data. Based on the operations described herein, uplink transmission efficiency may be improved, and/or data transmission latency may be reduced.

As described herein, a wireless device may determine not to send (e.g., may refrain from sending) TA information via an uplink grant, for example, based on a triggered TA reporting procedure being canceled. A base station may, based on not receiving TA information via the uplink grant, send (e.g., transmit) a timing offset to the wireless device and/or a request (e.g., via DCI or a MAC CE) for the wireless device to send (e.g., transmit) TA reporting information. This operation may provide advantages such as reduced interference to one or more other wireless devices in a cell, reduced complexity of the base station, and/or reduced uplink collision possibility between the uplink grant for TA reporting and another uplink grant (e.g., a fallbackRAR grant scheduled PUSCH and/or a RAR grant scheduled PUSCH).

As described herein, a wireless device may discard/delete/update a previously-maintained device-specific timing offset, for example, based on triggered TA reporting procedure being canceled. The wireless device may, based on a previously-maintained device-specific timing offset being canceled, determine the transmission timing of the UL grant based on another timing offset (e.g., the cell/beam-specific timing offset). A base station may request (e.g., via DCI or a MAC CE) the wireless device to send the TA reporting information, for example, based on the reception time of the uplink grant at the base station corresponding to the other timing offset. This operation may allow the base station to receive TA reporting information that may have been missed previously. Additional advantages may result from operations described herein, for example, for a wireless device, a base station, and/or any other devices in a wireless communication system implementing operations described herein.

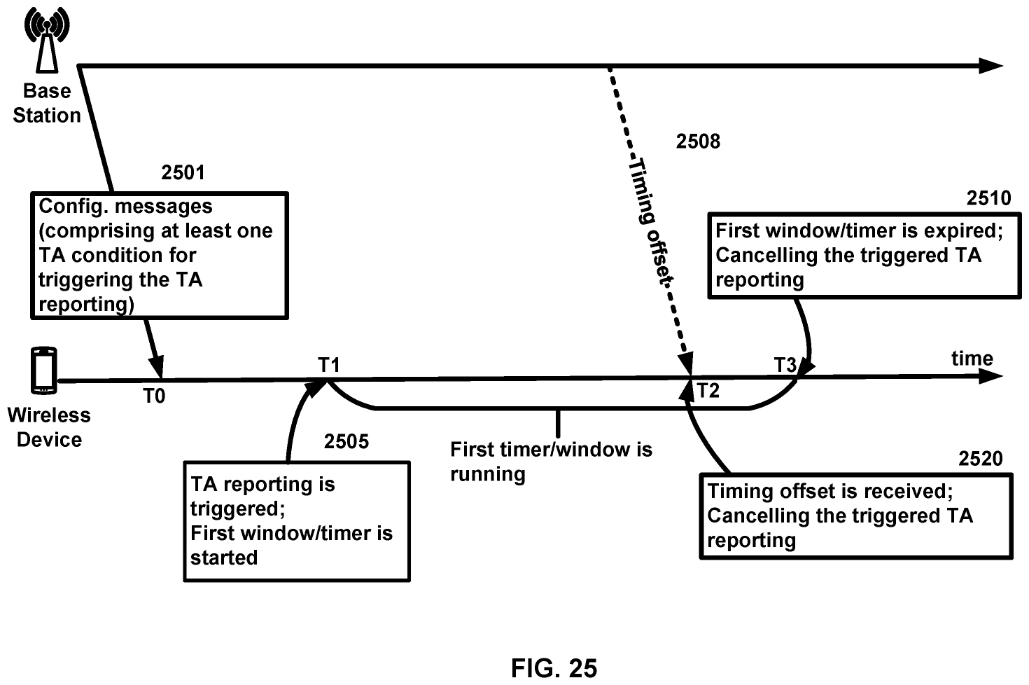

FIG. 25 shows an example of TA reporting. The TA reporting may be performed in an NTN. A wireless device may communicate with a base station. The communication between the wireless device and the base station may be via the NTN. A TA reporting procedure may be triggered (e.g., if at least one TA condition is satisfied). A first timer may starts running based on the triggered TA reporting procedure. The wireless device may send, to the base station, TA reporting information (e.g., as described in connection with FIG. 24) while the TA reporting procedure is triggered. The TA reporting information may be sent one or more times while the TA reporting procedure is triggered. The TA reporting procedure may be canceled, for example, if the first timer expires or if a timing offset (e.g., as described in connection with step 2430 in FIG. 24) is received by the wireless device from the base station.

At step 2501, the wireless device may receive the one or more configuration messages from the base station at time TO. The one or more configuration messages may be implemented similar to as described in connection with FIG. 24. The one or more configuration messages may indicate at least one TA condition for triggering the TA reporting procedure.

At step 2505, the wireless device may trigger the TA reporting procedure (e.g., at time T1), for example, based on the at least one TA condition being satisfied. The wireless device may start, based on (e.g., in response to) the triggered TA reporting procedure, a first timer (e.g., a first time window). The first timer may start at or after time T1. The first timer may end at time T3. A device-specific timing offset may have been maintained, for example, before time T1, at the wireless device. The previously maintained device-specific timing offset may be maintained based on the one or more previous communications (e.g., based on timing offset described with at step 2430 or 2470 in connection with FIG. 24) between the base station and the wireless device.

At step 2520, the wireless device may receive (e.g., at time T2) the timing offset 2508 while the first timer is running. The timing offset 2508 may be received based on (e.g., in response to) the wireless device sending (e.g., transmitting) TA reporting information. The TA reporting information may be described in connection with FIG. 24. The wireless device may stop the first timer based on (e.g., in response to) receiving the timing offset 2508.

At step 2520, the wireless device may cancel the triggered TA reporting procedure based on (e.g., in response to) receiving the timing offset 2508. The wireless device may cancel the triggered TA reporting procedure, for example, at or after time T2.

Additionally or alternatively, if the wireless device did not receive the timing offset 2508 before the first timer expires, at step 2510, the wireless device may cancel the triggered TA reporting based on (in response to) the expiration of the first timer (e.g., at time T3). Not receiving the timing offset may happen due to a variety of reasons. The wireless device may not receive the timing offset 2508, for example, if the base station does not receive the TA reporting information. The wireless device may not receive the timing offset 2508, for example, if the base station does not send the timing offset 2508 based on (e.g., in response to) receiving the TA reporting information. The wireless device may not receive the timing offset 2508 if a decoding failure occurs to the received PDSCH carrying the timing offset 2508. After wireless device cancels the triggered TA reporting procedure, for example, based on (e.g., in response to) the expiration of the first timer, the wireless device may refrain from sending additional the TA reporting information. Determining not to send (e.g., refraining from sending) additional the TA reporting information based on (e.g., after) the expiration of the first timer may reduce power consumption of the wireless device.

The one or more configuration massages may indicate the first timer (e.g., the duration of the first timer). The duration of the first timer may be based on one more one or more of the following: the second validity period described in connection with FIG. 24; the third validity period described in connection with FIG. 24; the first validity period described in connection with FIG. 24; and/or the periodicity of BSI.

The wireless device may trigger the TA reporting procedure, for example, based on the current TA value is valid. The wireless device may determine the current TA value as valid (e.g., up to date) based on one or more TA validity rules. The TA validity rules may correspond to the open-loop TA procedure/control and/or the closed-loop TA procedure/control. The one or more TA validity rules may be based on the first validity period, the second validity period, and/or the third validity period as described in connection with FIG. 24.

The current TA value may be determined as invalid, for example, based on determining that the second validity period is configured, the second validity period has expired, and new satellite ephemeris parameters is not available (e.g., has not been acquired). The current TA value may be determined as invalid, for example, based on determining that the third validity period is configured, the third validity period has expired, and new common TA parameters is not available. The current TA value may be determined as invalid, for example, based on determining that the first validity period is being configured, the first validity period has expired, and new GNSS-acquired position is not available. The current TA may be determined as invalid, for example, based on the expiration of a time alignment timer (e.g., the timeAlignmentTimer) as described in connection with FIG. 19.

The one or more TA validity rules may be based on configuration parameters corresponding to the drift rate(s) of the satellite ephemeris movement and/or the drift rate(s) of the common TA/delay. The wireless device may tolerate the expiry of the second validity period and/or the expiry of the third validity period (e.g., for calculating/measuring the current TA value), for example, based on the drift rate(s). The wireless device may compensate for the expiry of the second validity period and/or the third validity period, for example, using the drift rates. The wireless device may, for example, based on the drift rates and/or an implemented propagator model at the wireless device, determine (e.g., estimate/calculate) the open-loop TA value, if the wireless device has acquired the new satellite ephemeris parameters when the second validity period expires. The wireless device may, for example, based on the drift rates and/or an implemented propagator model at the wireless device, determine (e.g., estimate/calculate) the open-loop TA value, if the wireless device has not acquired the common TA parameters when the third validity period expires.

A wireless device may, refrain from triggering the TA reporting procedure, for example, based on (e.g., in response to) determining that the current TA value is invalid. The wireless device may trigger (e.g., initiate) a RA procedure, for example, based on (in response to) determining the current TA value is invalid and/or the triggered TA reporting procedure has not been canceled.

A wireless device may trigger a TA reporting based on the at least one TA condition being satisfied. The wireless device may attempt to transmit a TA reporting information via available UL-SCH resource(s), for example, based on (e.g., in response to) triggering the TA reporting. The wireless device may refrain from transmitting the TA reporting information, for example, based on (e.g., in response to) determining that the current TA value is invalided and the triggered TA reporting not being cancelled. The wireless device may, trigger/initiate a random access procedure, for example, based on (e.g., in response to) determining that the current TA value is invalid and the triggered TA reporting not being cancelled. For example, despite uplink resources (e.g., PUSCH, PUCCH, etc.) being available for transmitting TA reporting information, the wireless device may not transmit (e.g., may refrain from transmitting) TA reporting information (e.g., if/when the TA value is invalid).

The wireless device may be able to determine how long a triggered TA reporting procedure is pending by using the first timer. The wireless device may refrain from sending the TA reporting information by canceling the triggered TA reporting, for example, based on the expiry of the first timer.

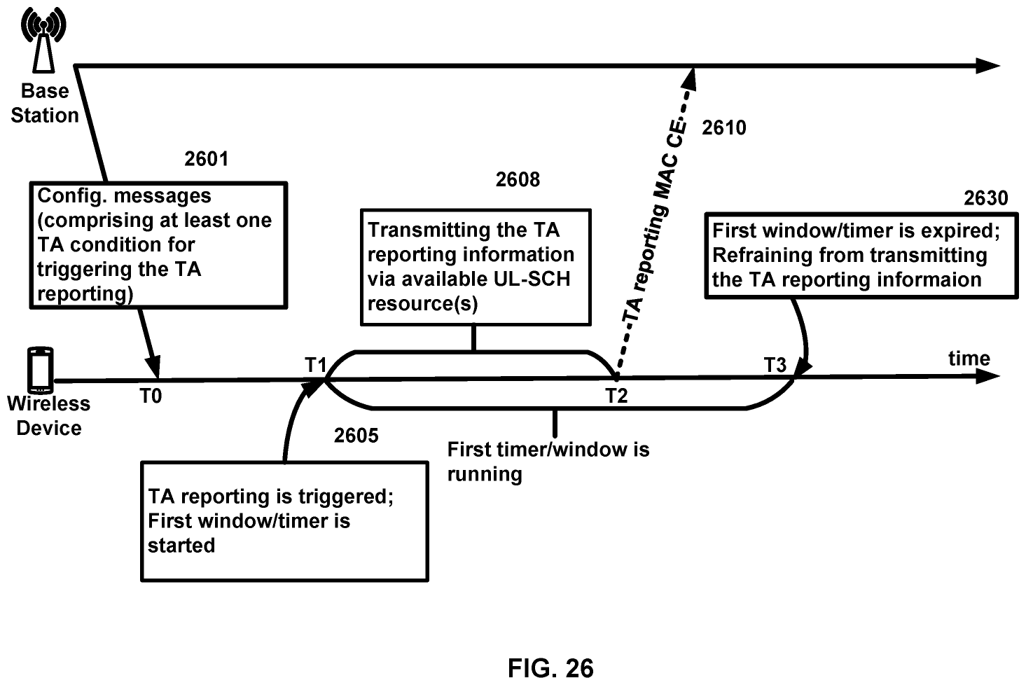

FIG. 26 shows an example of TA reporting. The TA reporting may be performed in an NTN. A wireless device may communicate with a base station. The communication between the wireless device and the base station may be via the NTN. The TA reporting procedure may be canceled, for example, if the wireless device has not received a timing offset, from the base station, after a first timer expires. A previously-maintained device-specific timing offset may be determined as invalid after the first timer expires. Other timing offset parameter(s) (e.g., a cell/beam specific parameter) may be used for uplink transmission. An RA procedure may be triggered after the first timer expires. The wireless device may send TA reporting information via the RA procedure.

At step 2601, the wireless device may receive the one or more configuration messages from the base station, for example, at time TO. The one or more configuration messages may be implemented as described in connection with FIG. 24. The one or more configuration messages may indicate at least one TA condition for triggering the TA reporting procedure.

At step 2605, the wireless device may trigger the TA reporting procedure, for example, at time T1. The wireless device may start a first timer (e.g., a first time window) at time T1, for example, based on the triggered TA reporting procedure. The first timer may start at time T1 and end at time T3. The wireless device may send (e.g., transmit) TA reporting information while the first timer is running. The TA reporting information may be similar as described in connection with FIG. 24. The wireless device may send/re-send (e.g., transmit/re-transmit) the TA reporting information one or more times, for example, if the first timer is running and no timing offset has been received from the base station.

At step 2608, the wireless device may send (e.g., transmit) the TA reporting information via one or more available UL-SCH resource(s). The available UL-SCH resource(s) may be based on a Type 1 configured grant, a Type 2 configured grant, and/or a dynamic grant scheduled by the base station. The available UL-SCH resource(s) may be based on a SR for BSR procedure, and/or one or more logical channel prioritization restrictions.

At step 2630, the wireless device may cancel, based on the expiry of the first timer, the triggered TA reporting procedure. The wireless device may, based on the TA reporting being canceled, refrain from sending the TA reporting information 2610 (e.g., via a MAC CE command) for one or more additional times.

The wireless device may refrain from performing one or more uplink transmissions based on the expiration of the first timer. The one or more uplink transmissions may comprise a PUSCH, a SRS, PUCCH (e.g., other than a PUSCH scheduled by a RAR UL grant or a fallbackRAR UL grant), or a PUCCH with HARQ-ACK information (e.g., in response to a successRAR).

Determining not to perform (e.g., refraining from performing) the one or more uplink transmissions based on (e.g., in response to) the expiry of the first timer may be reduce interfering with the other wireless devices in the cell/beam. Determining not to perform (e.g., refraining from performing) the one or more uplink transmission may also reduce interfering with other uplink transmissions of the wireless device, such as: a random access response (RAR) grant scheduled PUSCH (e.g., based on or in response to receiving a Msg2 1312 in a 4-step RA procedure); a fallbackRAR grant scheduled PUSCH (e.g., based on or in response to receiving a MsgB 1332 in a two-step RA procedure); a Msg3 1313 retransmission scheduled by a PDCCH (e.g., in DCI format 0_0) scrambled by TC-RNTI; a HARQ-ACK on PUCCH indicating the success contention resolution (e.g., a contention resolution PDSCH scheduled by a PDCCH (e.g., in DCI format 0_1) scrambled by a TC-RNTI or a contention resolution PDSCH scheduled by a PDCCH (e.g., in DCI format 0_1) scrambled by a TC-RNTI; and/or a preamble transmission corresponding to a PRACH occasion ordered by a PDCCH.

The base station may, based on not receiving the one or more uplink transmissions, perform one or more of the following: sending (e.g., transmitting) the timing offset; ordering a RA procedure (e.g., via a PDCCH); and/or requesting TA reporting information. The base station may, for example, based on not receiving the TA information via the UL grant, request (e.g., via a MAC CE command and/or a DCI), request the wireless device to send the TA reporting information and/or request (e.g., via a PDCCH) the wireless device to initiate/trigger a RA procedure. The base station may configure the wireless device to autonomously trigger/initiate the RA procedure, for example, based on (e.g., after) the expiry of the first timer. The one or more actions may be taken by the base station may be further based on a determination that the channel quality of the wireless device is unlikely to be the cause of not receiving the one or more uplink transmissions.

The wireless device may determine a device-specific timing offset as being invalid. For example, the wireless device may determine a device specific timing offset, maintained prior to time T1, as invalid (e.g., by discarding, deleting or/ignoring the previously maintained device-specific timing offset) based on (e.g., after) the expiry of the first timer. The wireless device may, based on (e.g., in response to) determining the device-specific timing offset as invalid, determine the scheduling timing of an UL grant (e.g., scheduled by DCI) based on the cell/beam-specific timing offset). The DCI may be having CRC parity bits (e.g., scrambled by a C-RNTI or MCS-RNTI or CS-RNTI). In at least some examples, the UL grant may not be a fallbackRAR grant scheduled PUSCH or a RAR grant scheduled PUSCH. The wireless device may, for example, based on (e.g., in response to or after) determining the previously-maintained device-specific timing offset as invalid, use the cell/beam-specific timing offset to determine a scheduling timing of a HARQ-ACK/NACK on PUCCH (e.g., scheduled by a PDCCH that is not addressed by at least one of TC-RNTI, RA-RNTI, and/or MSGB-RNTI). The wireless device may, based on (e.g., in response to) the previously-maintained device-specific timing offset, the cell/beam-specific timing offset, the third timing offset parameters and/or a reception time of a PDSCH carrying the MAC CE command in the downlink configuration, determine the action time (or an assumption in the uplink/downlink configuration) of a MAC CE command. The cell/beam timing offset and/or the third timing offset parameters may be described in connection with FIG. 24.

Determining a previously-maintained device-specific timing offset as invalid may allow the based station to be informed that: 1) the wireless device cancelled the triggered TA reporting procedure (e.g., due to not receiving the timing offset from the base station); and/or 2) the scheduling timing of the UL grant (e.g., scheduled by DCI) and/or the action timing of the MAC CE command are determined based on timing offset parameters other than the device-specific timing offset). A base station may determine/induce that a device-specific timing offset is invalid, for example, based on one or more of: not receiving an uplink transmission, receiving a preamble, and/or receiving an uplink transmission based on a cell-specific timing offset.

The base station may take one or more actions based on (e.g., in response to) determining that the wireless device is determining the scheduling timing of the UL grant based on the cell/beam-specific timing offset (instead of the device-specific timing offset). The one or more actions may comprise: requesting TA reporting information (e.g., via a MAC CE command and/or DCI); sending (e.g., transmitting) the timing offset based on the reception time of the UL grant; and/or ordering a RA procedure via a PDCCH. For example, the base station may, based on determining that the reception time of the UL grant is based on the cell/beam-specific timing offset instead on the device-specific timing offset, request the wireless device to transmit the TA reporting information. In another example, the base station may, based on determining that the reception time of the UL grant is based on the cell/beam-specific timing offset instead on the device-specific timing offset, may estimate/measure the timing offset and/or transmit the timing offset.

The wireless device may trigger/initiate a RA procedure (e.g., a contention based RA procedure) based on canceling the triggered TA reporting. The wireless device may send the TA reporting information via the RA procedure. sending (e.g., transmitting). The TA reporting information may be included in a MsgA payload 1342 or an UL grant indicated by a MsgB 1332 (e.g., if the RA procedure is a 2-step RA procedure), a Msg3 1313 or an UL grant indicated by a Msg4 1314 (e.g., if the RA procedure being a 4-step RA procedure).

The one or more configuration messages may indicate sending TA reporting information via the RA procedure is enabled, for example, if the wireless device is in an RRC_CONNECTED state (or an RRC_IDLE/RRC_INACTIVE state). The one or more configuration messages may indicate reporting TA reporting information via the RA procedure is disabled (e.g., not configured/enabled), for example, if the wireless device is in an RRC_CONNECTED state (or an RRC_IDLE/RRC_INACTIVE state). For example, the wireless device may trigger/initiate the random access (RA) procedure in response to the expiry of the first timer/window (e.g., which may have a higher priority than a TA reporting configuration) and reporting TA reporting information via the RA procedure being disabled. For example, the wireless device may, based on determining that sending (e.g., transmitting) the TA reporting information via the RA procedure is not configured/enabled, transmit the TA reporting information via an UL grant indicated via a MsgB 1332 (e.g., the RA procedure is a 2-step RA procedure). For example, the wireless device may, based on determining that sending (e.g., transmitting) the TA reporting information via the RA procedure is not configured/enabled, transmit the TA reporting information via an UL grant indicated via a Msg4 1314 (e.g., the RA procedure is a 4-step RA procedure). In an example embodiment, the wireless device may cancel the triggered TA reporting based on sending (e.g., transmitting) the TA reporting information.

The wireless device may refrain from triggering the RA procedure based on (e.g., in response to) the expiry of the first timer and that reporting TA reporting information via the RA procedure is disabled. The wireless device may, based on (e.g., in response to) the expiry of the first timer and sending the TA reporting information via the RA procedure not being configured/enabled, cancel the triggered TA reporting.

Triggering/initiating an RA procedure based on the expiry of the first timer may allow the wireless device to 1) send the TA reporting information via the RA procedure, and/or 2) inform the base station that the a previously-maintained device-specific timing offset is determined as invalid.

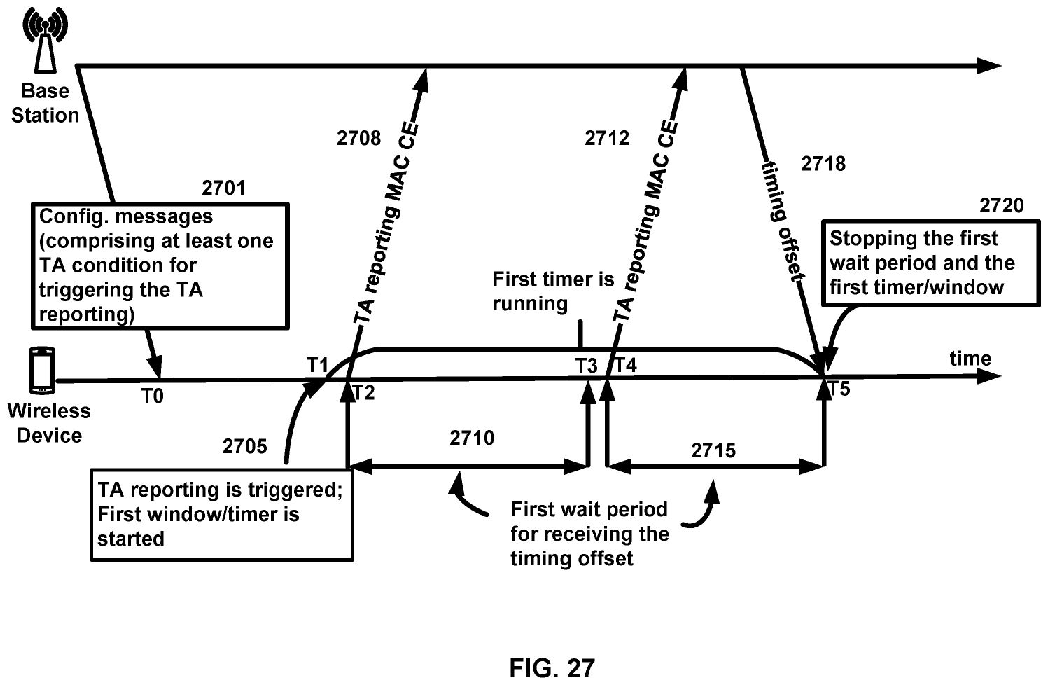

FIG. 27 shows an example of TA reporting. The TA reporting may be performed in an NTN. A wireless device may communicate with a base station. The communication between the wireless device and the base station may be via an NTN. While a TA reporting procedure is pending, the wireless device may wait, after sending TA reporting information to the base station, a wait period before re-sending the TA reporting information for an additional time. A maximum transmission times of TA reporting information may be configured. The wireless device may send TA reporting information for no more than the maximum transmission times during a TA reporting procedure.

At step 2701, the wireless device may receive the one or more configuration messages from the base station at time TO. The one or more configuration messages may be implemented similar to as described in connection with FIG. 24.

At step 2705, the wireless device may trigger TA reporting procedure at time T1. The wireless device may start, based on (e.g., in response to) the triggered TA reporting procedure, a first timer (e.g., at or after time T1). The first timer may start at time T1 and end at or after time T5. A triggered TA reporting procedure may be canceled in a way similar to as described in FIG. 25.

A wireless device may, based on (e.g., in response to) the TA reporting being triggered, send TA reporting information while the first timer is running. The TA reporting information may be implemented similar as described in connection with FIG. 24. The wireless device may send (or re-send) the TA reporting information one or more times while the first timer is running. For example, TA reporting information 2708 may be sent at time T2. The wireless device may wait for a wait period (e.g., a first wait period 2710). The first wait period 2710 may start at time T2 and end at time T3. The wireless device may refrain from re-sending the TA reporting information during the first wait period 2710.

The duration of a wait period (e.g., the first wait period 2710) may be pre-configured. The duration of a wait period may be determined (e.g., by the wireless device), for example, based on one or more of the following: the current TA value; the cell/beam-specific timing offset; the current device-specific timing offset; the propagation delay between the wireless device and the base station; a drx-RetransmissionUL (if a DRX cycle is configured); and/or a sr_ProhibitTimer of a SR configuration.

After the first wait period 2710 expires, the wireless device may re-send TA reporting information 2712 (e.g., at time T4), if the first timer is running, and no timing offset has been received from the base station. The wireless device may wait for a second wait period 2715 after the TA reporting information 2712 has been sent. The duration of the second wait period 2715 may be the same as the duration of the first wait period 2710, or may be different from the first wait period 2710. The second wait period 2715 may start at time T4 (e.g., when the TA reporting information 2712 is sent), and end at a time at or after time T5. The wireless device may refrain from re-sending TA reporting information during the second wait period 2715.

The wireless device may receive the timing offset at time T5. At step 2720, the wireless device may stop the second wait period 2715 and/or the first timer. The wireless device may cancel the triggered TA reporting based on receiving the timing offset. The wireless device may determine (e.g., maintain/calculate), based on the timing offset, the device-specific timing offset. The determination may be described in connection with FIG. 24.

If the second wait period 2720 ends before the wireless device receives the timing offset (e.g., from the base station) and before the first timer expires, the wireless device may re-send TA reporting information for one or more additional times (e.g., after the second wait period 2720 ends but before the first timer expires). The wireless device may start a new wait period after each TA reporting information is sent. The wireless device may refrain from re-sending the TA reporting information from an additional time during the wait period. The wireless device may cancel the triggered TA reporting procedure based on (e.g., in response to or after) the first timer expires. The wireless device may refrain, based on canceling the triggered TA reporting, from sending the TA reporting information for additional times.

The one or more configuration messages may comprise a value indicating the maximum transmission (or retransmission) times of the TA reporting information. The wireless device may determine the maximum transmission times of the TA reporting information, for example, based on a maximum number of preamble transmission (e.g., the preambleTransMax) of a RACH configuration or a maximum number of SR transmission (e.g., sr-TransMax) of a SR configuration. The wireless device may refrain from sending TA reporting information more than the maximum transmission times.

The wireless device may maintain a counter to count the number of times that the TA reporting information is sent during a triggered TA reporting procedure. The wireless device may set the counter by an initial value (e.g., zero or the maximum transmission times).

The wireless device may increment the counter (e.g., by one) after each time TA reporting information is sent, for example, if the counter is initialized by zero. The wireless device may send the TA reporting information for example, based on the counter indicate a number smaller than the maximum transmission times. The wireless device may start await period before sending TA reporting information for an additional time. The wireless device may cancel the triggered TA reporting procedure and/or stop the first timer, for example, based on the counter is initialized by zero and indicates a number equal to or greater than the maximum transmission times.

The wireless device may decrement the counter (e.g., by 1) after each time TA reporting information is sent, for example, if the counter is initialized by the maximum transmission times. The wireless device may send the TA reporting information, for example, based on the first counter being greater than zero. The wireless device may start the wait period after the TA reporting information is sent. The wireless device may stop the first timer and/or cancel the triggered TA reporting procedure, for example, based on the counter is initialized by the maximum transmission times and indicates a number equal to or smaller than zero.

Sending TA reporting procedure for multiple times may improve the success decoding of a PUSCH carrying the TA reporting information at the base station, and/or improve the success decoding of a PDSCH carrying the timing offset at the wireless device. Limiting the maximum transmission times of sending (e.g., transmitting) the TA reporting information and/or waiting for a wait period before re-sending TA reporting information for an additional time may reduce unnecessary retransmission of the TA reporting information, even if the wireless device does not receive the timing offset from the base station soon after the TA reporting information is sent (e.g., due to a long propagation delay in an NTN and the decoding time at the base station). Reducing unnecessary retransmission may reduce the power consumption of the wireless device.

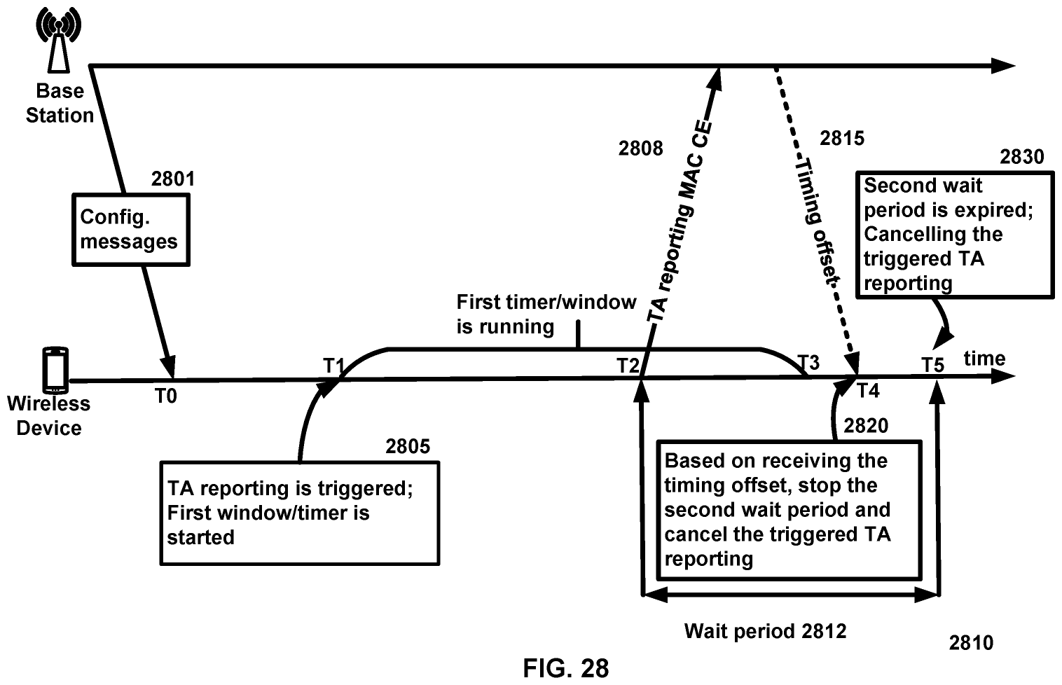

FIG. 28 shows an example of TA reporting. The TA reporting may be performed in an NTN. A wireless device may communicate with a base station. The communication between the wireless device and the base station may be via the NTN. The wireless device may start a wait period after TA reporting information is sent. The wireless device may, after the expiry of the first timer, determine not to cancel the triggered TA reporting procedure, for example, based on no timing offset has been received and the wait period has not been expired.

At step 2801, the wireless device may receive the one or more configuration messages from the base station at time TO. The one or more configuration messages may be implemented as described in connection with FIG. 24.

As step 2805, the wireless device may trigger a TA reporting procedure at time T1. The wireless device may start, based on the triggered TA reporting procedure, the first timer (e.g., at time T1). The first timer may start at time T1 and end at time T3. The wireless device may send, based on (e.g., in response to) the TA reporting procedure being triggered, TA reporting information 2808 (e.g., at time T2) while the first timer is running.

At step 2810, the wireless device may start a wait period 2812 for receiving the timing offset, for example, based on (e.g., after) the TA reporting information is sent. The wait period 2812 may start at the time when the TA reporting information is sent. For example, the wait period 2812 may start at time T2 and end at time T5. At time T3 (when the first timer expires), the wireless device may determine not to cancel the triggered TA reporting procedure, for example, based on the timing offset has not been not received and the wait period 2812 has not expired (which may indicate that the TA reporting information is sent prior to the expiry of the first timer). The wireless device may wait until the wait period 2812 expires to cancel the TA reporting procedure.

At step 2815, the wireless device may receive the timing offset (e.g., at time T4) during the wait period 2812. The wireless device may cancel the triggered TA reporting procedure, for example, based on the timing offset is received. At step 2830, the wireless device may cancel the triggered TA reporting procedure, for example, based on the expiry of the wait period 2812 (e.g., at time T5), if the wireless device does not receive the timing offset by the time the wait period 2812 expires.

The duration of the wait period 2812 may be determined (e.g., pre-configured) by the wireless device, for example, based on one or more of the following: the current TA value; the cell/beam-specific timing offset; the current device-specific timing offset; the propagation delay between the wireless device and the base station; a drx-RetransmissionUL (if a DRX cycle is configured); and/or a sr_ProhibitTimer of a SR configuration. The duration of the wait period 2812 may be determined based on the duration of the wait period 2710 or 2720 as described in connection with FIG. 27.

After TA reporting information is sent, refraining from canceling the triggered TA reporting until a wait period 2812 expires may reduce a possibility of early cancelation of the triggered TA reporting and increase the chance of receiving timing offset from the base station. This may be helpful, for example, if the TA reporting information is sent near the end of the time period while the first timer is running. By increasing the chance of receiving the timing offset, the wireless device may reduce the need of triggering/initiating a RA procedure after the expiry of the first timer, and/or the possibility of unnecessarily discarding/deleting the previously-maintained device-specific timing offset.

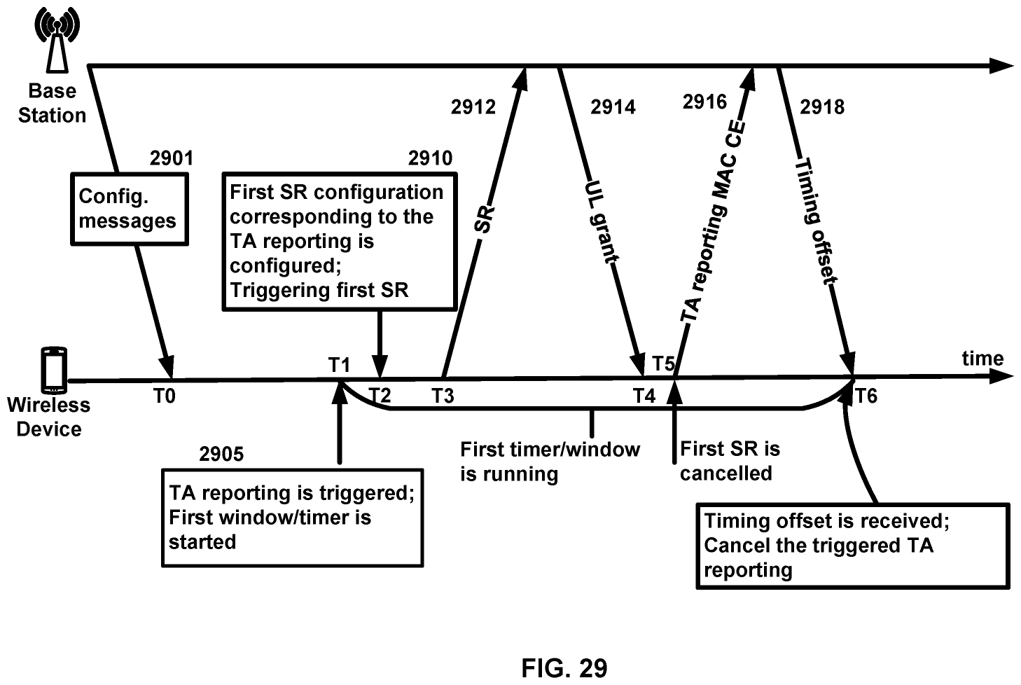

FIG. 29 shows an example of TA reporting. The TA reporting may be performed in an NTN. A wireless device may communicate with a base station. The communication between the wireless device and the base station may be via the NTN. A plurality of SR configuration parameters may be used to configure a SR procedure for TA reporting. After a TA reporting procedure is triggered, one or more SR may be sent to request a UL grant for sending TA reporting information.

At step 2901, the wireless device may receive the one or more configuration messages from the base station at time TO. The one or more configuration messages may be implemented as described in connection with FIG. 24. The one or more configuration messages may comprise a plurality of SR configuration parameters and/or at least one TA condition for triggering the TA reporting. The plurality of SR configuration parameters may correspond to TA reporting procedure. The plurality of SR configuration parameters may comprise one or more configuration parameters indicating: a SR prohibit timer (e.g., sr_ProhibitTimer); a maximum number of SR transmission (e.g., sr_TransMax); a parameter indicating a periodicity and offset of a SR transmission in slots (e.g., periodicityAndOffset) for a PUCCH transmission conveying a SR for TA reporting; PUCCH resource corresponding to the SR; and/or a number of symbols for a PUCCH transmission conveying the SR (e.g., nrofSymbols).

At step 2905, the wireless device may trigger a TA reporting procedure at time T1, for example, based on the at least one TA condition being satisfied. The wireless device may start, based on (e.g., in response to) the TA reporting being triggered, the first timer. The first timer may start at time T1 and/or end at time T6. The first timer may be configured and/or used similar to the first timer described in FIG. 25.

At step 2910, the wireless device may trigger a SR procedure (e.g., at time T2) based on the plurality of SR configuration parameters. At step 2912, the wireless device may send (e.g., transmit), based on the SR procedure is triggered, a SR (e.g., at time T3) associated with TA reporting. The SR may be sent using the PUCCH resource corresponding to the SR procedure, which is configured based on the plurality of SR configuration parameters. The MAC layer of the wireless device may instruct the physical layer of the wireless device to send (e.g., signal/transmit) the SR via the PUCCH resource corresponding to the SR procedure. The wireless device may maintain a SR transmission counter (e.g., SR_COUNTER), for example, based on the plurality of SR configuration parameters. The wireless device may increment, based on (e.g., after) a SR is sent, the SR transmission counter. The wireless device may initialize the SR transmission counter by a first SR value (e.g., 0) before any SR procedure for TA reporting is triggered (or is pending).

The wireless device may start a SR prohibit timer, for example, based on (e.g., after) a SR is sent. The wireless device may monitor one or more PDCCH candidates to receive an UL grant for sending (e.g., transmitting) TA reporting information.

At step 2914, the UL grant may be received (e.g., at time T4). As described in greater detail below, the wireless device may send TA reporting information via the received UL grant. If the wireless device does not receive the UL grant after the SR prohibit timer expires and if the first timer had not expired when the SR prohibit timer expires, the wireless device may send, based on the SR prohibit timer expires, the SR_COUNTER indicates a number that is smaller than the sr_TransMax, and/or the first timer is running, the SR for TA reporting for an additional time. The wireless device may perform, for example, based on (e.g., after) re-sending the SR, at least one of the following: incrementing the SR_COUNTER; starting another SR prohibit timer; and/or monitoring the one or more PDCCHs for receiving an UL grant. For example, for each triggered TA reporting (e.g., as long as it is pending) one SR procedure may be ongoing (e.g., if/after an SR is triggered).

If the first timer expires before the SR prohibit timer expires and the wireless device does not receive an UL grant by the time when the first timer expires, the wireless device may, based on the expiry of the first timer and the SR prohibit timer being running, wait for the SR prohibit timer to expire before cancelling the triggered TA reporting information. The wireless device may receive an UL grant for sending the TA reporting information while the SR prohibit timer is running. If an UL grant is received (e.g., before the SR prohibit timer expires), the wireless device may send the TA reporting information via the UL grant and may perform, based on (e.g., after) sending the TA reporting information via the UL grant, one or more of the following: stopping the SR prohibit timer; canceling the SR procedure; and/or canceling the triggered TA reporting. If the wireless device does not receive an UL grant for sending the TA reporting information while the SR prohibit timer is running, the wireless device may cancel, based on (e.g., after) the expiry of the first timer and the expiry of the SR prohibit timer, the SR procedure and/or the trigger TA reporting procedure. The wireless device may refrain from sending the SR for an additional time. The wireless device may trigger/initiate an RA procedure, for example, based on the SR procedure and/or the triggered TA reporting procedure being canceled. The wireless device may send the TA reporting information via the RA procedure, for example, based on determining that sending TA reporting information via the RA procedure is enabled (e.g., configured). Enabling or disabling sending TA reporting information via RA procedure may be described in connection with FIG. 26.

If the wireless device does not receive the UL grant by the expiry of the SR prohibit timer and the SR_COUNTER is equal or greater than the sr_TransMax, the wireless device may, based on the SR_COUNTER, release PUCCHs for one or more serving cells, release SRSs for the one or more serving cells, clear one or more configured downlink assignments and/or uplink grants, and/or cancel the pending SR procedure. The wireless device may trigger/initiate, based on canceling the SR procedure, an RA procedure. The wireless device may cancel, based on the triggered RA procedure and/or sending TA reporting information via the RA procedure, the triggered TA reporting procedure. The wireless device may cancel the triggered TA reporting, for example, based on (e.g., in response to) sending the TA reporting information via the RA procedure (e.g., if sending TA reporting information via the RA procedure is enabled/configured (e.g., for an RRC_CONNECTED state)). The wireless device may cancel the triggered TA reporting, for example, based on (e.g., in response to) sending TA reporting information via the RA procedure being disabled (e.g., for an RRC_CONNECTED state).

At step 2916, the wireless device may send TA reporting information (e.g., a MAC CE comprising TA reporting information) at time T5. sending (e.g., transmitting) The wireless device may cancel, for example, based on the TA reporting information being sent, the SR procedure. The wireless device may stop, based on the first SR being cancelled, the SR prohibit timer.

At step 2918, the wireless device may receive the timing offset from the base station (e.g., at time T6). The timing offset may be implemented as described in connection with FIG. 24 and/or FIG. 25. For example, the wireless device may perform at least one or more of the following: stopping the first timer; canceling the triggered TA reporting procedure; and/or determining (e.g., maintaining/calculating) the device-specific timing offset.

The wireless device may refrain from canceling the triggered TA reporting procedure during a wait period after the TA reporting information is sent. The wait period may be similar to the wait period 2812 as described in connection with FIG. 28. The wireless device may determine the previously-maintained device-specific timing offset as valid, for example, before the wait period expires and/or a timing offset from the base station is received. The wireless device may receive the timing offset while the wait period is running. The wireless device may cancel, based on receiving the timing offset, the triggered TA reporting procedure.

If the wireless device does not receive the timing offset during the wait period the wireless device may cancel, based on the expiry of the wait period, the triggered TA reporting procedure. Similar as described in connection with FIG. 26, the wireless device may trigger/initiate, based on the expiry of the wait period and not receiving the timing offset, an RA procedure. The wireless device may cancel the triggered TA reporting based on (e.g., in response to) triggering/initiating the RA procedure and/or sending the TA reporting information via the RA procedure. Having SR configuration corresponding to the TA reporting procedure may reduce transmission delay of sending the TA reporting information and/or improving the spectral efficiency.

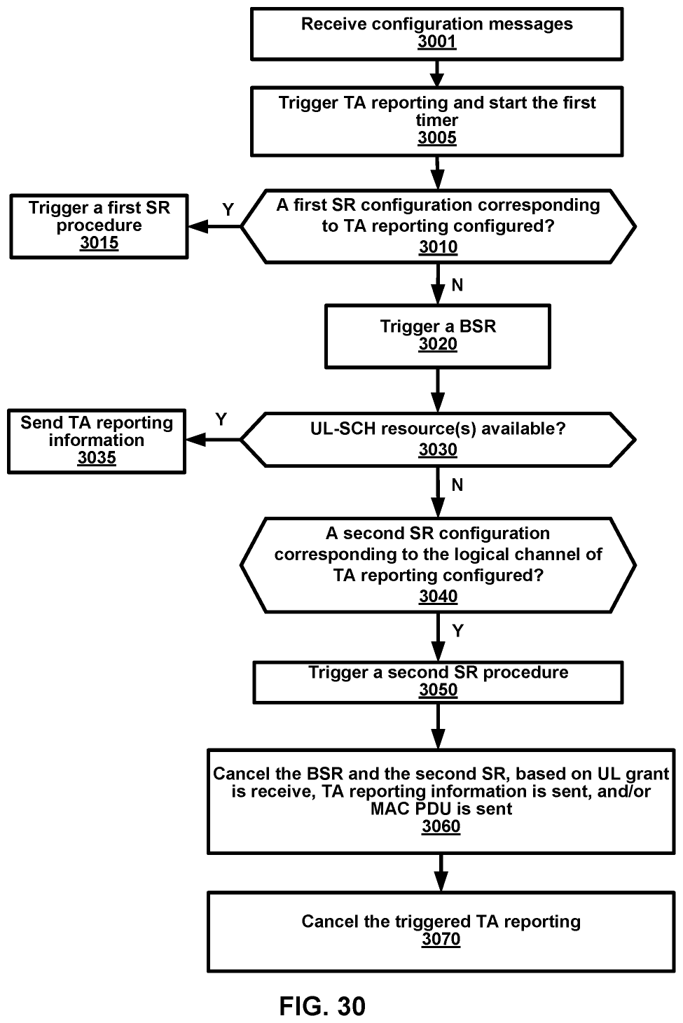

FIG. 30 shows an example of TA reporting. The TA reporting may be performed in an NTN. A wireless device may communicate with a base station. The communication between the wireless device and the base station may be via the NTN. A BSR procedure may be triggered, for example, based on a triggered TA reporting procedure. The wireless device may send TA reporting information via a UL grant received based on the BSR procedure.

At step 3001, the wireless device may receive the one or more configuration messages from the base station. The one or more configuration messages may be implemented as described in connection with FIG. 24. The one or more configuration messages may comprise one or more SR configuration parameters and/or one or more BSR configuration parameters.

At step 3005, the wireless device may trigger a TA reporting procedure, for example, based on at least one TA condition being satisfied. The TA reporting procedure may be triggered as described in connection with FIG. 24 and/or FIG. 25. The wireless device may start, based on the TA reporting being triggered, a first timer. The first timer may be configured and/or used as described in connection with FIG. 25.

At step 3010, the wireless device may determine whether a first SR procedure for TA reporting is configured (e.g., based on the one or more configuration messages). The first SR procedure for TA reporting may be configured as described in connection with FIG. 29. If the wireless device determines that the first SR procedure is not configured (e.g., configuration parameters associated with the first SR procedure is missing/absent from the one or more configuration messages), the method may proceed to step 3020. If the wireless device determines that the first SR procedure is configured, (e.g., configuration parameters associated with the first SR is present in the one or more configuration messages), the method may proceed to step 3015.

At step 3015, the wireless device may trigger a first SR procedure for TA reporting. A SR procedure for TA reporting may be implemented as described in connection with FIG. 29. At step 3020, the wireless device may trigger a BSR procedure. The wireless device may trigger the BSR procedure, for example, based on (e.g., in response to) the LCH corresponding to TA reporting having new data for transmission (e.g., due to the triggered TA reporting procedure). For example, if a wireless device is required to and/or expected to report its coordination via an RRC message (e.g., via a secured channel), then a dedicated LCH should may be configured. The LCH of the TA reporting information may belong to a first LCG. The wireless device may trigger the BSR procedure, for example, based on a determination that the LCG corresponding to TA reporting has higher priority than the priority of one or more other LCHs (e.g., belonging to this or other LCG(s)) with available data for transmission. The wireless device may send, to the base station and based on the triggered BSR procedure, a BSR. The BSR may be the first type of BSR, the second type of BSR (e.g., padding BSR), the third type of BSR, and/or the fourth type of BSR as described in connection with FIG. 18. During a BSR procedure, a wireless device may initially check to see if there are available resources for transmission of a BSR. The wireless device may trigger an SR, for example, if there are no resources available for transmission of a BSR.

At step 3030, the wireless device may, based on triggering the BSR procedure, determine whether any UL-SCH resource(s) are available for sending the TA reporting information. If the wireless device determines that UL-SCH resource(s) are available, the method may proceed to step 3035. At step 3035, the wireless device may send TA reporting information via the available UL-SCH resource(s). If the wireless device determines that no UL-SCH resource(s) are available, the method may proceed to step 3040.

The wireless device may determine no UL-SCH resource(s) is available for the TA reporting information if: no UL-SCH resource(s) being available for new transmission (e.g., Type 1 configured grant, Type 2 configured grant, or a dynamic UL grant is not available); the UL-SCH resource(s) are not available for sending the TA reporting information, for example, due to one or more logical channel prioritization restrictions (e.g., the UL-SCH resource(s) for sending the TA reporting information does not satisfy the LCP mapping restrictions); and/or the logicalChannelSR-Mask of the LCH of the TA reporting information is set to false (e.g., by higher layers of the wireless device).

As step 3040, the wireless device may determine whether a second SR procedure corresponding to the LCH for the TA reporting is configured. If the second SR procedure is configured, the method may proceed to step 3050.

At step 3050, the wireless device may trigger the second SR procedure corresponding to the LCH for TA reporting. The wireless device may, based on (e.g., in response to) triggering the second SR procedure, initialize a SR_COUNTER by an initial value. The initial value may be Oif no other SR procedures, corresponding to LCH for TA reporting, are pending. The wireless device may, based on the second SR procedure being triggered, perform one or more of the following: instructing the physical layer of the wireless device to send a second SR corresponding to the second SR procedure; starting a SR prohibit timer (e.g., indicated by the second SR configuration); and/or monitoring one or more PDCCH candidates to receive an UL grant. The wireless device may determine the at least one valid PUCCH resource for re-sending the second SR, for example, if the wireless device does not receive the UL grant before the SR prohibit timer expires. The wireless device may re-send the second SR and increment the SR_COUNTER, for example, based on the SR prohibit timer has expired, the first timer is running, and/or the SR_COUNTER indicate a number smaller than a maximum number of SR transmission. The wireless device may start, based on re-sending the second SR, a new SR prohibit timer. The wireless device may, while the new SR prohibit timer is running, monitor one or more candidate PDCCHs for receiving an UL grant and refrain from res-ending another second SR.

If the wireless device does not receive the UL grant by the expiry of the SR prohibit timer and the SR_COUNTER (e.g., as described in connection with FIG. 29) is equal to or greater than the sr_TransMax, the wireless device may, based on the SR_COUNTER, release PUCCHs for one or more serving cells, release SRs for the one or more serving cells, clear one or more configured downlink assignments and/or uplink grants, and/or cancel the second SR procedure. The wireless device may initiate, based on canceling the second SR procedure, an RA procedure for sending TA reporting information. The wireless device may cancel, based on the triggered RA procedure and/or sending TA reporting information via the RA procedure, the triggered TA reporting procedure (e.g., as described in connection with FIG. 26).

If the first timer expires while the SR prohibit timer is running, the wireless device may, based on the SR prohibit timer being running, refrain from cancelling the triggered TA reporting procedure until the SR prohibit timer to expire.

At step 3060, the wireless device may receive, based on the second SR procedure, a UL grant for TA reporting. The wireless device may (e.g., based on receiving the UL grant for TA reporting, the UL grant accommodate data associated with TA reporting information, MAC PDU is sent via the UL grant, and/or TA reporting information is sent via the UL grant) cancel the second SR procedure, stop the SR prohibit timer, and/or cancel the BSR procedure. The UL grant may accommodate at least a portion of data (e.g., all pending data) available to be sent. The data may comprise the TA reporting information (e.g., TA reporting MAC CE or the RRC signaling). The wireless device may send, via the UL grant, a MAC PDU that comprises a BSR MAC CE. The BSR MAC CE may be a Long BSR MAC CE or a Short BSR MAC CE. The BSR MAC CE may comprises the BSR. The wireless device may receive, based on (e.g., in response to) sending the Long/Short BSR MAC CE, a second UL grant for sending the pending data that comprises the TA reporting information. The wireless device may send, via the second UL grant, the TA reporting information.

The wireless device may not cancel (e.g., may refrain from canceling) the triggered TA reporting procedure during a second wait period after the TA reporting information is sent, as described in connection with FIG. 28. If the wireless device receives the timing offset (e.g., from the base station) during the second wait period, the wireless device may cancel the triggered TA reporting. The wireless device may, based on the received timing offset, determine (e.g., maintain/calculate) the device-specific timing offset. The wireless device may cancel the BSR in response to canceling the triggered TA reporting. If the wireless device does not receive the timing offset during the second wait period, the wireless device may cancel, based on the expiry of the second wait period, the triggered TA reporting procedure. The wireless device may trigger an RA procedure. The wireless device may, based on the triggered RA procedure, perform similar to as described above in connection with FIG. 26.

If the wireless device does not receive the second UL grant for sending the TA reporting information and/or the UL grant for sending the Long/Short BSR MAC CE before the first timer expires, the wireless device may refrain from re-sending the second SR. The wireless device may, based on the expiry of the first timer, cancel the second SR procedure, the triggered TA reporting procedure, and/or the BSR procedure.

The wireless device may trigger/initiate a RA procedure, for example, based on the second SR procedure being canceled. The wireless device may cancel the triggered TA reporting based on (e.g., in response to) sending the TA reporting information via the RA procedure if sending TA reporting information via the RA procedure is enabled/configured (e.g., for an RRC_CONNECTED state). The wireless device may cancel the triggered TA reporting based on (e.g., in response to) determining that sending TA reporting information via the RA procedure being disabled (e.g., for an RRC_CONNECTED state). The wireless device may cancel the BSR based on (e.g., in response to) canceling the triggered TA reporting.

At step 3070, the wireless device may receive, based on (e.g., in response to) the TA reporting information, the timing offset (e.g., from the base station). The wireless device may stop the first timer and/or cancel the triggered TA reporting. Sending TA reporting information via a SR for BSR procedure may provide advantages such as reducing the signaling overhead.

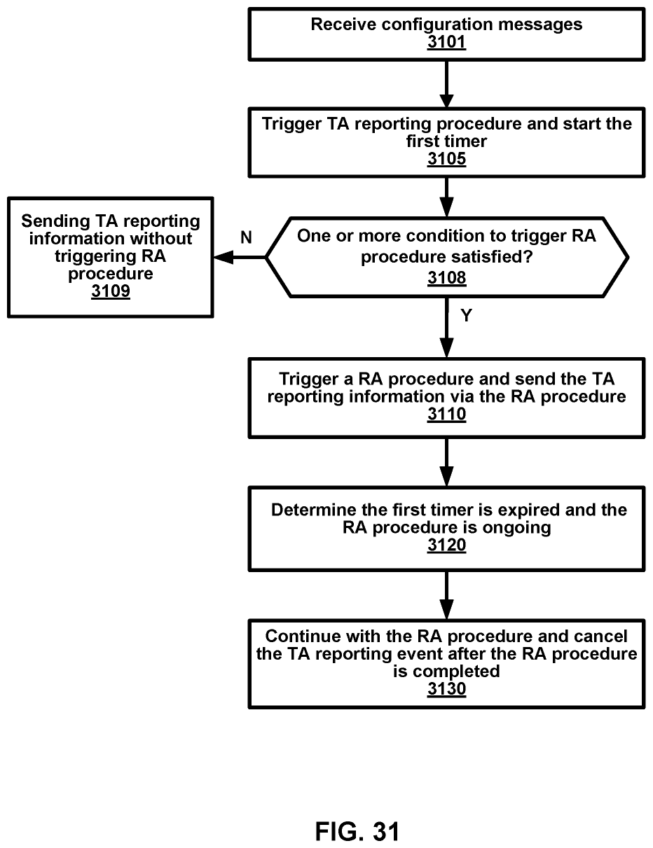

FIG. 31 shows an example of TA reporting. The TA reporting may be performed in an NTN. A wireless device may communicate with a base station. The communication between the base station and the wireless device may be via the NTN. An RA procedure may be triggered based on a TA reporting procedure. The TA reporting information may be sent via the RA procedure. The wireless device may allow the RA procedure be completed before cancelling the triggered TA procedure.

At step 3101, the wireless device may receive the one or more configuration messages from the base station. The one or more configuration messages may be implemented as described in FIG. 24. The one or more configuration messages may comprise at least the configuration parameters of a plurality of SR configurations, one or more BSR configurations, one or more RACH configuration messages, and/or a plurality of configured grant configurations (e.g., one or more Type 1 configured grant configurations and/or one or more Type 2 configured grant configurations).

At step 3105, the wireless device may trigger a TA reporting procedure, for example, based on at least one TA condition being satisfied. The wireless device may start the first timer based on the triggered TA reporting procedure. The TA reporting procedure, the at least one TA condition and/or the first timer may be implemented as described in connection with FIG. 25.

At step 3108, the wireless device may determine whether one or more conditions to trigger an RA procedure for TA reporting is satisfied. If the one or more conditions are satisfied, the method may proceed to step 3110. If the one or more conditions are not satisfied, the method may proceed to step 3109.

The one or more conditions may comprise sending (e.g., transmitting) the TA reporting information via the RA procedure is enabled (e.g., configured). The one or more conditions may further comprise one or more of: the time to a next available UL-SCH resource (e.g., based on Type 1 or Type 2 configured grant) occasion is greater than a time to the next available PRACH occasion; the time to a first available UL-SCH resource (e.g., based on Type 1 or Type 2 configured grant) occasion is greater than a time to a first available MsgA PUSCH occasion; one or more UL-SCH resources (e.g., corresponding to Type 1 and/or Type 2 configured grants) are not available for sending the TA reporting information (e.g., due to logical channel prioritization procedure); the configuration parameters of a plurality of the configurated grant configurations being absent from the one or more configuration messages; a SR configuration correspond to the TA reporting (e.g., described in connection with FIG. 29) being absent from the one or more configuration messages; and/or a second SR configuration correspond to the logical channel of the TA reporting information (e.g., as described in connection with FIG. 30) being absent from the one or more configuration messages.

If the one or more configuration messages indicate a SR configuration correspond to the TA reporting (as described in connection with FIG. 29), the one or more conditions may further comprise a time to the next available PUCCH resource corresponding to the SR configuration is greater than a time to the first available PRACH occasion (e.g., the first available MsgA PUSCH occasion).

If the one or more configuration messages indicate a second SR configuration correspond to the logical channel of the TA reporting information (e.g., as described in connection with FIG. 30), the one or more conditions may comprise a time to the next available PUCCH resource corresponding to the second SR configuration is greater than a time to the first available PRACH occasion (e.g., the first available MsgA PUSCH occasion).

The wireless device may trigger a BSR procedure (e.g., corresponding to the first type of BSR as described in connection with FIG. 18). The BSR procedure may be implemented as described in connection with FIG. 30. The BSR procedure may be triggered before triggering the RA procedure. The BSR procedure may be triggered, for example, based on the first SR configuration not being configured (e.g., based on the one or more configuration messages). The one or more conditions may comprise: the BSR being triggered, no UL-SCH resource(s) being available for sending the TA reporting information; and the second SR configuration corresponding to the LCH of the TA reporting information not being configured. If the RA procedure is triggered (e.g., due to the second SR not being configured with valid PUCCH resource) the wireless device may cancel the RA procedure, for example, based on one or more of the following: sending a MAC PDU via an UL grant other than a second UL grant is provided by a RAR (e.g., a fallback RAR) of the RA procedure; the MAC PDU comprising a BSR MAC CE which comprises buffer status corresponding to (and/or comprising) a last event that triggered the BSR prior to the MAC PDU assembly (e.g., the BSR prior to the MAC PDU assembly and/or a last event prior to the MAC PDU assembly), and/or the UL grant accommodates pending data available for transmission (e.g., including the TA reporting information). The wireless device may cancel the BSR based on canceling the RA procedure.

At step 3109, the wireless device may send TA reporting information in a way similar as described in connection with FIG. 25 to FIG. 30. The wireless device may cancel the TA reporting procedure, for example, based on the one or more conditions not being satisfied. The wireless device may stop the first timer. The wireless device may cancel a BSR procedure for TA reporting, if a BSR procedure is triggered as a result of the triggered TA reporting procedure.

The wireless device may trigger/initiate an RA procedure for sending (e.g., transmitting) TA reporting information, for example, based on (e.g., in response to) one or more conditions (e.g., one or more conditions not being satisfied). For example, when sending (e.g., transmitting) the TA reporting information via the RA procedure being disabled, the BSR being triggered as a result of the triggered TA reporting, and no UL-SCH resource(s) being available for sending (e.g., transmitting) the TA reporting, the wireless device may trigger/initiate the RA procedure. For example, triggering RA may be undesirable, however, a wireless device may be configured to trigger RA based on at least some condition(s) (e.g., to give the wireless device a higher priority to report its location).

At step 3110, the wireless device may trigger the RA procedure. The wireless device may send the TA reporting information via the RA procedure. The wireless device may send the TA information via the RA procedure by sending a MsgA payload 1342 comprising the TA reporting information (e.g., based on the RA procedure being a 2-step RA procedure), or a Msg3 1313 comprising the TA reporting information (e.g., based on the RA procedure being a 4-step RA procedure). The wireless device may send the TA reporting information via the RA procedure by sending the TA reporting information via an UL grant indicated by a MsgB 1332 (e.g., based on the RA procedure being a 2-step RA procedure), or via an UL grant indicated by a Msg4 1314 (e.g., based on the RA procedure being a 4-step RA procedure).

The wireless device may receive the timing offset (e.g., from the base station) while the first timer is running and the RA procedure is ongoing. The wireless device may, based on receiving the timing offset, cancel the RA procedure and/or the triggered TA reporting procedure.

At step 3120, the wireless device may determine that the first timer expires (e.g., while the RA procedure is ongoing). The wireless device may continue with the RA procedure without canceling the triggered TA reporting procedure.

At step 3130, the wireless device may cancel the triggered TA reporting procedure based on (e.g., after) completing the ongoing RA procedure. The RA procedure may be completed successfully or unsuccessfully. A successful RA procedure may be indicated, for example, by a wireless device receiving a contention resolution identity. Additionally or alternatively, the wireless device may cancel the RA procedure and the TA reporting procedure, for example, based on the first timer expires.

A wireless device may receive, from a base station, one or more configuration messages configuring at least one TA condition to trigger a TA reporting procedure. The wireless device may trigger the TA reporting procedure based on the at least one TA condition being satisfied. Based on the triggered TA reporting procedure, the wireless device may start a first timer for receiving a timing offset (e.g., from the base station). The wireless device may cancel the triggered TA reporting, for example, based on (e.g., in response to) the first timer being expired and/or receiving the timing offset from the base station.

A wireless device may determine (e.g., maintain/calculate) a device-specific timing offset based on the received timing offset (e.g., from the base station). A wireless device may use the device-specific timing offset for determining the transmission time of an uplink grant (e.g., scheduled/indicated by DCI). In at least some examples, the DCI may be with CRC that does not have CRC parity bits scrambled by a RA radio network temporary identifier (RA-RNTI), MSGB-RNTI, or a temporary C-RNTI (TC-RNTI). In at least some examples, the DCI may be in lack of an indication that indicates a RA preamble index. In at least some examples, the DCI may be not in DCI format 1_0 indicating a retransmission of a Msg3 during an ongoing RA procedure. In at least some examples, the uplink grant may not be a RAR grant scheduled PUSCH or a fallbackRAR grant scheduled PUSCH. In at least some examples, the uplink grant may not be a HARQ ACK on PUCCH indicating a success contention resolution.

A wireless device may not perform (e.g., may refrain from performing) a transmission of the uplink grant, for example, based on the device-specific timing offset being available from one or more previous transmissions, and/or the triggered TA reporting being cancelled (e.g., based on the first timer being expired and the timing offset not being received). A wireless device may discard/delete the device-specific timing offset, for example, based on the device-specific timing offset being available from one or more previous transmissions, and/or the triggered TA reporting being cancelled (e.g., based on the first timer being expired and the timing offset not being received).

A wireless device may send TA reporting information based on the timing offset not being received while the first timer is running. A wireless device may stop the first timer based on receiving the timing offset. A wireless device may maintain a first counter for counting the number of times the TA reporting information is sent (or re-sent) while the first timer is running. The first counter may be set to zero (e.g., based on the triggered TA reporting procedure).

A wireless device may send (or re-send) the TA reporting information (e.g., based on the first counter being smaller than a maximum transmission (or retransmission) times of the TA reporting information, the first timer being running, the timing offset not being received, and/or a first wait period being expired). The wireless device may increment the first counter, for example, based on the sending or re-sending the TA reporting information. The wireless device may start a first wait period based on (e.g., in response to) sending or re-sending the TA reporting information. The wireless device may refrain from sending the TA reporting information during the first wait period. The wireless device may stop the first wait period based on (e.g., in response to) receiving the timing offset.

A wireless device may, based on the first timer being running and/or the first counter being equal or greater than the maximum transmission (or retransmission) times of the TA reporting information, stop the first timer. The wireless device may cancel the triggered TA reporting procedure. The duration of the first wait period may be determined (e.g., by the wireless device) based on a propagation delay between the wireless device and the base station, or a cell/beam-specific timing offset provided via a BSI.

A wireless device may be configured with a first value of TA reporting information transmission. The first value may indicate the maximum transmission (or retransmission) times of the TA reporting information. The wireless device may not be configured with a first value of TA reporting information transmission. The wireless device may determine the first value of TA reporting information transmission (e.g., based on a maximum number of RA preamble transmission or a maximum number of SR transmission).

A wireless device may start a second wait period in response to sending the TA reporting information. The wireless device may refrain from sending the TA reporting information for an additional time while the second wait period is running. The wireless device may stop the second wait period (e.g., based on receiving the timing offset).

A wireless device may not cancel (e.g., may refrain from canceling), based on the expiry of the first timer, the triggered TA reporting procedure during the second wait period. A wireless device may cancel the TA reporting procedure (e.g., based on the expiry of the second wait period and/or receiving the timing offset). The duration of the second wait period may be determined based on a propagation delay between the wireless device and the base station or a cell/beam-specific timing offset (e.g., provided via BSI).

A wireless device may trigger/initiate a RA procedure based on the expiry of the first timer. Sending a TA reporting information via the RA procedure may be enabled/configured via the one or more configuration messages. Sending a TA reporting information via the RA procedure maybe disabled via the one or more configuration messages. In at least some examples, the wireless device may cancel the triggered TA reporting (e.g., based on triggering/initiating the RA procedure). A wireless device may cancel the triggered TA reporting (e.g., based on sending TA reporting information via the RA procedure). A wireless device may not trigger/initiate a RA procedure (e.g., based on the first timer being expired, and/or sending TA reporting information via the RA procedure being disabled). Sending the TA reporting information may be via one or more available UL-SCH resource(s).

A wireless device may trigger/initiate (e.g., based on sending the TA reporting information via a RA procedure being enabled/configured) the RA) procedure for sending the TA reporting information. The wireless device may stop the RA procedure based on the first timer being expired/stopped. The wireless device may stop the RA procedure based on the triggered TA reporting being cancelled. The wireless device may not stop/interrupt (e.g., may refrain from stopping/interrupting) the RA procedure (e.g., based on the first window being expired and/or not receiving the timing offset). The wireless device may cancel the triggered TA reporting procedure (e.g., based on the RA procedure being completed and/or receiving the timing offset). The RA procedure may be unsuccessfully completed or successfully completed.

A wireless device may triggering a first SR procedure based on a first SR configuration corresponding to the TA reporting. The first SR configuration may indicate a first SR prohibit timer and/or a first SR transmission value indicating the maximum number of the first SR transmissions. The wireless device may send a first SR, for example, based on (e.g., in response to) the first SR not being cancelled, the first timer being running, the first SR prohibit timer not being running, and/or a first SR counter being smaller than the first SR transmission value. The wireless device may cancel the first SR procedure and/or stop the first SR prohibit timer, for example, based on sending the first SR, the wireless device may increment the first SR counter, start the first SR prohibit timer, and/or monitor one or more candidate PDCCHs while the first SR prohibit timer is running. Based on sending a MAC PDU comprising a TA reporting MAC CE.

A wireless device may initiate a first SR counter. The first SR counter may be configured to count the number of times that the first SR is sent. The first SR counter may be initialized by zero. The first SR counter may be initiated based on (e.g., in response to) the first SR being triggered and/or no other SR corresponding to the first SR configuration being triggered.

A wireless device may trigger/initiate a RA procedure, for example, based on the first timer being expired, and/or the first SR procedure not being canceled. The wireless device may trigger/initiate a RA procedure, for example, based on the first timer being running and/or the first SR counter being equal or greater than the first SR transmission value. The wireless device may cancel, based on the triggering/initiating the RA procedure, the first SR procedure.

A wireless device may trigger (e.g., based on the first SR configuration not being configured) a BSR procedure, for example, based on the priority of a LCH for the TA reporting information being greater than any other LCH(s) with data for transmission in the same LCG as the LCH for TA reporting information. The wireless device may trigger the BSR procedure, for example, based on no other LCH, in the same LCG with the LCH for the TA reporting information, has data for transmission.

A wireless device may trigger (e.g., based on a triggered BSR procedure) a second SR, for example, based on an UL-SCH resource not being available for sending the TA reporting information, and/or the LCH for the TA reporting information being configured with a second SR configuration. The second SR configuration may indicate: a second SR prohibit timer and/or a second SR transmission value indicating the maximum number of the second SR transmission. The wireless device may send a second SR, for example, based on the second SR procedure not being cancelled, the first timer being running, the second SR prohibit timer not being running, and/or a second SR counter being smaller than the second SR transmission value. Based on sending the second SR, the wireless device may increment the second SR counter, start the second SR prohibit timer, and/or monitor one or more candidate PDCCHs while the second SR prohibit timer is running. The wireless device may cancel the second SR, for example, based on the triggered BSR being cancelled.

A wireless device may cancel the triggered BSR (e.g., based on a MAC PDU comprising the TA reporting information being sent, a MAC PDU comprising Short/Long BSR MAC CE being sent, and/or the triggered TA reporting being canceled). A wireless device may trigger/initiate a RA procedure, for example, based on the first timer being expired and the second SR procedure not being cancelled, or the first timer being running and the second SR counter being equal or greater than the second SR transmission value. The wireless device may cancel, based on the triggering/initiating the RA procedure, the second SR procedure.

A wireless device may initialize the second SR counter for counting the number of times that the second SR being sent. The second SR counter may be initialized by zero (e.g., based on the second SR procedure being triggered and no other SR corresponding to the second SR configuration being triggered).

A wireless device may trigger/initiate (e.g., based on the triggered BSR procedure and the LCH of the TA reporting information not being configured with the second SR configuration) a RA procedure to send the TA reporting information. A wireless device may cancel the triggered TA reporting, for example, based on the BSR being triggered and the LCH of the TA reporting information not being configured with a second SR configuration. The wireless device may send the TA reporting information via a RA procedure not being configured/enabled. In at least some examples, the wireless device may cancel the BSR procedure, for example, based on canceling the triggered TA reporting.

At least one TA condition may be satisfied based on: a change in a current TA value compared to a previous TA value, or a difference between the device-specific timing offset and the current TA value. In at least some examples, the time of determining (e.g., calculating/maintaining) the current TA value may be after the time of determining (calculating/maintaining) the previous TA value. In at least some examples, the current TA value and/or the previous TA value may be determined (e.g., maintained/calculated) by the wireless device. The current TA value and/or the previous TA value may be determined, for example, based on a combination of a closed-loop TA procedure/control and/or an open-loop TA procedure/control.

An open-loop TA procedure/control may be based on: one or more satellite ephemeris parameters; one or more common delay/TA parameters; location information (e.g., a GNSS-acquired position) of the wireless device; or a third timing offset (as described in connection with FIG. 24). In at least some examples, the closed-loop TA procedure/control may be based on receiving TA MAC CE and/or absolute TA MAC CE.

A timing offset may be indicated via a MAC CE command or an RRC signaling (e.g., a RRC reconfiguration message). In at least some examples, the TA reporting information may be based on a MAC CE command (e.g., TA reporting MAC CE) or an RRC signaling (e.g., a RRC reconfiguration message).

A wireless device may communicate with the base station via an NTN. In at least some examples, the TA reporting information may be based on: a device-specific TA value; an open-loop TA value; a propagation delay between the wireless device and an NTN node; a location information (e.g., a GNSS-acquired position) of the wireless device; a difference between a cell/beam-specific timing offset and a current TA value; and/or a difference between the device-specific timing offset and the current TA value. In at least some examples, the first timer may be configured via the one or more configuration messages.

A duration of the first timer may be determined by the wireless device. The duration may be determined based on at least one of: a first validity window of GNSS-acquired position of the wireless device; a second validity window of a satellite (or an NTN node) ephemeris data/information; a third validity window of a common TA/delay; or a periodicity of BSI.

A wireless device may not trigger (e.g., may refrain from triggering) a TA reporting based on one or more of: a time alignment timer being expired; a first validity window corresponding to a GNSS-acquired location information being expired and the wireless device not being able to acquire a new GNSS-acquired location information; a second validity window corresponding to a satellite ephemeris parameters being expired and the wireless device not being able to acquire a new satellite ephemeris parameters; or a third validity window corresponding to a common TA/delay being expired and the wireless device not being able to acquire a new common TA/delay parameters. A device-specific timing offset may be different than the timing offset received from the base station. In at least some examples, the device-specific timing offset may be the same as the timing offset received from the base station.

A wireless device may perform a method comprising multiple operations. The wireless device may receive one or more scheduling request (SR) configuration parameters corresponding to timing advance (TA) reporting. The wireless device may trigger, based on the one or more SR configuration parameters and based on a triggered TA reporting procedure, an SR. The wireless device may send, via an uplink channel, the triggered SR. The wireless device may receive an indication of a time duration. The wireless device may start, based on the triggered TA reporting procedure, a timer corresponding to the time duration. The wireless device may cancel the triggered TA reporting procedure based on at least one of: expiration of the timer; or receiving, from a base station, a timing offset. The wireless device may send a medium access control (MAC) protocol data unit (PDU) comprising TA reporting information associated with the triggered TA reporting procedure; and/or send a MAC control element (MAC CE) comprising TA reporting information associated with the triggered TA reporting procedure. The wireless device may cancel, based on sending at least one of the MAC PDU or the MAC CE, the triggered SR. The wireless device may send TA reporting information associated with the triggered TA reporting procedure, wherein sending the TA reporting information may be by the wireless device, to a base station, and via a non-terrestrial network (NTN). The wireless device may send TA reporting information associated with the triggered TA reporting procedure, wherein the TA reporting information may comprise at least one of: a current TA value associated with the wireless device; a propagation delay associated with communications between the wireless device and abase station; a propagation delay associated with communications between the wireless device and a reference point in a network; a location of the wireless device; and/or a device-specific timing offset associated with the wireless device. The wireless device may receive a timing offset. The wireless device may, based on the receiving the timing offset, cancel the triggered TA reporting procedure. The wireless device may comprise one or more processors; and memory storing instructions that, when executed by the one or more processors, cause the wireless device to perform the described method, additional operations and/or include the additional elements. A system may comprise the wireless device configured to perform the described method, additional operations, and/or include the additional elements; and a base station configured to communicate with the wireless device (e.g., to send and/or to receive one or more messages received and/or sent by the wireless device). A computer-readable medium may store instructions that, when executed, cause performance of the described method, additional operations and/or include the additional elements.

A base station may perform a method comprising multiple operations. The base station may send one or more scheduling request (SR) configuration parameters corresponding to timing advance (TA) reporting. The base station may receive a first SR for transmission of TA reporting information. The base station may send, based on the first SR, an uplink grant indicating an uplink channel. The base station may receive, via the uplink channel, the TA reporting information. The base station may send an indication of a time duration. The base station may start, based on a triggered TA reporting procedure, a timer corresponding to the time duration. The base station may cancel the triggered TA reporting procedure based on at least one of: expiration of the timer; or sending, to a wireless device, a timing offset. Receiving the TA reporting information may comprise at least one of: receiving a medium access control (MAC) protocol data unit (PDU) comprising the TA reporting information; and/or receiving a MAC control element (MAC CE) comprising the TA reporting information. The base station may cancel, based on sending at least one of the MAC PDU or the MAC CE, the triggered SR. Receiving the TA reporting information may be by the base station, from a wireless device, and via a non-terrestrial network (NTN). Receiving the TA reporting information may be based on logical channel prioritization of the uplink channel. The base station may send a timing offset. The base station may, based on sending the timing offset, cancel a triggered TA reporting associated with the TA reporting information. The base station may comprise one or more processors; and memory storing instructions that, when executed by the one or more processors, cause the base station to perform the described method, additional operations and/or include the additional elements. A system may comprise the base station configured to perform the described method, additional operations, and/or include the additional elements; and one or more wireless devices configured to communicate with the base station (e.g., to send and/or to receive one or more messages received and/or sent by the base station). A computer-readable medium may store instructions that, when executed, cause performance of the described method, additional operations and/or include the additional elements.

A wireless device may perform a method comprising multiple operations. The wireless device may receive one or more configuration messages associated with time advance (TA) reporting, wherein the one or more configuration messages may indicate a time duration. The wireless device may start, based on a TA reporting procedure being triggered, a timer corresponding to the time duration. The wireless device may cancel the triggered TA reporting procedure based on at least one of: expiration of the timer; and/or receiving, from a base station, a timing offset. The one or more configuration messages may further comprise one or more scheduling request (SR) configuration parameters corresponding to the TA reporting procedure. The wireless device may trigger, based on the one or more SR configuration parameters and based on the TA reporting procedure, the SR. The wireless device may send, via an uplink channel, the triggered SR. The wireless device may determine, based on receiving the timing offset, a device-specific timing offset (e.g., a wireless device-specific timing offset). The wireless device may invalidate, based on the canceling the triggered TA reporting procedure, a device-specific timing offset (e.g., a wireless device-specific timing offset). The wireless device may initiate a random access (RA) procedure. Initiating the RA procedure may be based a determination that a timing offset has not been received, from the base station, while the timer is running. The wireless device may send, via message associated with the RA procedure, TA reporting information. The wireless device may send TA reporting information associated with the triggered TA reporting procedure. The TA reporting information may comprise at least one of: a current TA value associated with the wireless device; a propagation delay associated with communications between the wireless device and abase station; a propagation delay associated with communications between the wireless device and a reference point in a network; a location of the wireless device; and/or a device-specific timing offset associated with the wireless device. The wireless device may send, to the base station and based on a medium access control control element (MAC CE) command or radio resource control (RRC) signaling, TA reporting information. The wireless device may determine a quantity of times TA information is sent during the TA reporting procedure. The wireless device may, based on the quantity of times exceeding a threshold, cancel the triggered TA reporting procedure. The one or more configuration parameters may indicate the threshold. The timer may be a first timer. The wireless device may send a first message comprising TA information associated with the triggered TA reporting procedure. The wireless device may start, based on the sending the first message, a second timer. The wireless device may send, before the first timer expires and after the second timer expires, a second message comprising the TA information. The wireless device may send a first message comprising TA information associated with the triggered TA reporting procedure. The wireless device may start, based on the sending the first message, a second timer. The wireless device may refrain, while the second timer is running, from sending a second message comprising the TA information while the first wait period is running. The wireless device may start, based on sending TA information during the TA reporting procedure, a third timer. Canceling the TA reporting procedure may be further based on expiration of the third timer. The TA reporting procedure may be triggered based on at least one TA condition comprising: a difference between a current TA value and a previous TA value satisfying a first threshold; and/or a difference between a device-specific timing offset and the current TA value satisfying a second threshold. The wireless device may determine, based on a combination of a closed-loop TA procedure and an open-loop TA procedure, a current TA value. The time duration may be based on at least one of: a first validity window of GNSS-acquired position of the wireless device; a second validity window of satellite ephemeris information; a third validity window of a common TA; and/or a periodicity of a broadcast system information. The wireless device may determine to refrain from triggering a second TA reporting procedure based on at least one of: expiration of a time alignment timer; expiration of a first validity window corresponding to GNSS-acquired location information and the wireless device not being able to acquire new GNSS-acquired location information; expiration of a second validity window corresponding to a satellite ephemeris parameter and the wireless device not being able to acquire a new satellite ephemeris parameter; or expiration of a third validity window corresponding to a common TA and the wireless device not being able to acquire a new common TA parameter. The wireless device may comprise one or more processors; and memory storing instructions that, when executed by the one or more processors, cause the wireless device to perform the described method, additional operations and/or include the additional elements. A system may comprise the wireless device configured to perform the described method, additional operations, and/or include the additional elements; and a base station configured to communicate with the wireless device (e.g., to send and/or to receive one or more messages received and/or sent by the wireless device). A computer-readable medium may store instructions that, when executed, cause performance of the described method, additional operations and/or include the additional elements.

A wireless device may perform a method comprising multiple operations. The wireless device may receive one or more configuration messages indicating at least one timing advance (TA) condition to trigger a TA reporting. The wireless device may trigger the TA reporting based on the at least one TA condition being satisfied. The wireless device may transmit, via an uplink resource, TA information associated with the triggered TA reporting. The wireless device may receive a timing offset based on the TA information. The wireless device may cancel, based on the receiving the timing offset, the triggered TA reporting. The wireless device may comprise one or more processors; and memory storing instructions that, when executed by the one or more processors, cause the wireless device to perform the described method, additional operations and/or include the additional elements. A system may comprise the wireless device configured to perform the described method, additional operations, and/or include the additional elements; and a base station configured to communicate with the wireless device (e.g., to send and/or to receive one or more messages received and/or sent by the wireless device). A computer-readable medium may store instructions that, when executed, cause performance of the described method, additional operations and/or include the additional elements.

A wireless device may perform a method comprising multiple operations. The wireless device may receive one or more configuration messages indicating at least one timing advance (TA) condition to trigger a TA reporting. The wireless device may trigger the TA reporting based on the at least one TA condition being satisfied. The wireless device may trigger, based on the triggered TA reporting, a buffer status report (BSR) corresponding to a logical channel of associated with TA information. The wireless device may, based on transmitting a medium access control (MAC) protocol data unit (PDU) comprising the TA information, cancel the BSR. Canceling the BSR may be further based on the triggered TA reporting being canceled. The MAC PDU may comprise a BSR command MAC CE. The BSR command MAC CE may comprise a Long BSR command MAC CE and/or a Short BSR command MAC CE. The wireless device may trigger the BSR based on at least one of: determining a first SR configuration corresponding to the TA reporting not being configured; the priority of the logical channel (LCH) of the TA information being greater than any other logical channel, belonging to a logical channel group (LCG), having data for transmission; and/or no other LCH belonging to an LCG, except the LCH of the TA information, has data for transmission. The wireless device may receive, from a base station, one or more configuration messages indicating a scheduling request (SR) configuration corresponding to a logical channel of the TA information. The wireless device may trigger an SR corresponding to the SR configuration based on at least one of: the triggered BSR; and/or an uplink shared channel (UL-SCH) resource not being available for transmitting the TA information. The wireless device may transmit, based on the triggered SR, the SR. The wireless device may cancel, based on the BSR being cancelled, the triggered SR. The wireless device may initialize an SR counter, for counting the number of times that the SR being transmitted, to zero, based on at least one of: triggering the SR; and/or determining that there is no other SR triggered corresponding to the SR configuration. The wireless device may initiate a random access (RA) procedure in response to the SR counter exceeding a SR transmission value. The wireless device may cancel, based on the initiating the RA procedure, the SR. Canceling the triggered TA reporting may be further based on transmitting the TA reporting via the RA procedure. Transmitting the TA reporting via RA procedure may be enabled. Transmitting the TA reporting via RA procedure may be disabled. The wireless device may initiate a random access (RA) procedure to transmit the TA information based on at least one of: the triggered BSR; and/or the logical channel of the TA information not being configured with an SR configuration. The wireless device may cancel the triggered TA reporting based on determining that transmitting the TA information via the random access (RA) procedure is not enabled. The wireless device may communicate with a base station via a non-terrestrial network (NTN). The at least one TA condition may be satisfied based on at least one of: a change in a current TA value compared to a previous TA value, wherein the time of calculating the current TA value is after the time of calculating the previous TA value; and/or a difference between the device-specific timing offset and the current TA value. The wireless device may calculate the current TA value based on a combination of a closed-loop TA procedure and an open-loop TA procedure. The wireless device may calculate the previous TA value based on a combination of the closed-loop TA procedure and the open-loop TA procedure. The one or more configuration parameters may indicate the length of the first window. The wireless device may determine a length of a first timer based on at least one of: a first validity window of GNSS-acquired position of the wireless device; a second validity window of a satellite ephemeris information; a third validity window of a common TA; and/or a periodicity of a broadcast system information. The wireless device may comprise one or more processors; and memory storing instructions that, when executed by the one or more processors, cause the wireless device to perform the described method, additional operations and/or include the additional elements. A system may comprise the wireless device configured to perform the described method, additional operations, and/or include the additional elements; and a base station configured to communicate with the wireless device (e.g., to send and/or to receive one or more messages received and/or sent by the wireless device). A computer-readable medium may store instructions that, when executed, cause performance of the described method, additional operations and/or include the additional elements.

A wireless device may perform a method comprising multiple operations. The wireless device may receive one or more configuration messages indicating at least one timing advance (TA) condition to trigger a TA reporting. The wireless device may trigger the TA reporting based on the at least one TA condition being satisfied. The wireless device may initiate, for the triggered TA reporting, a random access (RA) procedure for transmitting a TA information irrespective of whether transmitting the TA information via the RA procedure being enabled or not. The wireless device may stop the RA procedure based on receiving a timing offset. The wireless device may comprise one or more processors; and memory storing instructions that, when executed by the one or more processors, cause the wireless device to perform the described method, additional operations and/or include the additional elements. A system may comprise the wireless device configured to perform the described method, additional operations, and/or include the additional elements; and a base station configured to communicate with the wireless device (e.g., to send and/or to receive one or more messages received and/or sent by the wireless device). A computer-readable medium may store instructions that, when executed, cause performance of the described method, additional operations and/or include the additional elements.

A wireless device may perform a method comprising multiple operations. The wireless device may receive one or more configuration messages indicating at least one timing advance (TA) condition to trigger a TA reporting. The wireless device may trigger the TA reporting based on the at least one TA condition being satisfied. The wireless device may initiate, for the triggered TA reporting, a random access (RA) procedure for transmitting TA information. The wireless device may, based on receiving a timing offset, stop the RA procedure. Initiating the RA procedure may be based on at least one of: the one or more configuration messages indicating transmitting the TA information via the RA procedure being enabled; the one or more configuration messages indicating transmitting the TA information via the RA procedure being disabled; the one or more configuration messages not indicating transmitting the TA information via the RA procedure; the triggered TA reporting being cancelled due to expiration of a first timer; a failure of a scheduling request (SR) triggered for transmitting the TA information; no uplink shared channel (UL-SCH) resource being available for transmitting the TA information; and/or a time difference between a configured UL-SCH resource and the triggering time of the TA reporting being greater than a threshold. The wireless device may cancel, based on the RA procedure being completed, the triggered TA reporting. The RA procedure being completed may comprise the RA procedure being one of unsuccessfully completed or successfully completed. The wireless device may comprise one or more processors; and memory storing instructions that, when executed by the one or more processors, cause the wireless device to perform the described method, additional operations and/or include the additional elements. A system may comprise the wireless device configured to perform the described method, additional operations, and/or include the additional elements; and a base station configured to communicate with the wireless device (e.g., to send and/or to receive one or more messages received and/or sent by the wireless device). A computer-readable medium may store instructions that, when executed, cause performance of the described method, additional operations and/or include the additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability(ies) depending on wireless device category and/or capability(ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, or other 3GPP or non-3GPP technology.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, one or more scheduling request (SR) configuration parameters corresponding to timing advance (TA) reporting;
triggering, based on the one or more SR configuration parameters and based on a triggered TA reporting procedure, an SR; and
sending, via an uplink channel, the triggered SR.

2. The method of claim 1, further comprising:
receiving an indication of a time duration;
starting, based on the triggered TA reporting procedure, a timer corresponding to the time duration; and
canceling the triggered TA reporting procedure based on:
expiration of the timer; or
receiving, from a base station, a timing offset.

3. The method of claim 1, further comprising at least one of:
sending a medium access control (MAC) protocol data unit (PDU) comprising TA reporting information associated with the triggered TA reporting procedure; or
sending a MAC control element (MAC CE) comprising TA reporting information associated with the triggered TA reporting procedure.

4. The method of claim 3, further comprising:
canceling, based on sending at least one of the MAC PDU or the MAC CE, the triggered SR.

5. The method of claim 1, further comprising sending TA reporting information associated with the triggered TA reporting procedure, wherein the sending the TA reporting information is by the wireless device, to a base station, and via a non-terrestrial network (NTN).

6. The method of claim 1, further comprising sending TA reporting information associated with the triggered TA reporting procedure, wherein the TA reporting information comprises at least one of:
a current TA value associated with the wireless device;
a propagation delay associated with communications between the wireless device and a base station;
a propagation delay associated with communications between the wireless device and a reference point in a network;
a location of the wireless device; or
a device-specific timing offset associated with the wireless device.

7. The method of claim 1, further comprising:
receiving a timing offset; and
based on the receiving the timing offset, cancelling the triggered TA reporting procedure.

8. A method comprising:
sending, by a base station, one or more scheduling request (SR) configuration parameters corresponding to timing advance (TA) reporting;
receiving a first SR for transmission of TA reporting information;
sending, based on the first SR, an uplink grant indicating an uplink channel; and
receiving, via the uplink channel, the TA reporting information.

9. The method of claim 8, further comprising:
sending an indication of a time duration;
starting, based on a triggered TA reporting procedure, a timer corresponding to the time duration; and
canceling the triggered TA reporting procedure based on:
expiration of the timer; or
sending, to a wireless device, a timing offset.

10. The method of claim 8, wherein the receiving the TA reporting information comprises at least one of:
receiving a medium access control (MAC) protocol data unit (PDU) comprising the TA reporting information; or
receiving a MAC control element (MAC CE) comprising the TA reporting information.

11. The method of claim 10, further comprising:
canceling, based on sending at least one of the MAC PDU or the MAC CE, the triggered SR.

12. The method of claim 8, wherein the receiving the TA reporting information is by the base station, from a wireless device, and via a non-terrestrial network (NTN).

13. The method of claim 8, wherein the receiving the TA reporting information is based on logical channel prioritization of the uplink channel.

14. The method of claim 8, further comprising:
sending a timing offset; and
based on the sending the timing offset, cancelling a triggered TA reporting associated with the TA reporting information.

15. A method comprising:
receiving, by a wireless device, one or more configuration messages associated with time advance (TA) reporting, wherein the one or more configuration messages indicate a time duration;
starting, based on a TA reporting procedure being triggered, a timer corresponding to the time duration; and
canceling the triggered TA reporting procedure based on:
expiration of the timer; or
receiving, from a base station, a timing offset.

16. The method of claim 15, wherein the one or more configuration messages further comprises one or more scheduling request (SR) configuration parameters corresponding to the TA reporting procedure, and wherein the method further comprises:
triggering, based on the one or more SR configuration parameters and based on the TA reporting procedure, the SR; and
sending, via an uplink channel, the triggered SR.

17. The method of claim 15, further comprising:
determining, based on receiving the timing offset, a wireless device-specific timing offset.

18. The method of claim 15, further comprising:
invalidating, based on the canceling the triggered TA reporting procedure, a device-specific timing offset.

19. The method of claim 15, further comprising:
initiating a random access (RA) procedure, wherein the initiating is based a determination that a timing offset has not been received, from the base station, while the timer is running; and
sending, via message associated with the RA procedure, TA reporting information.

20. The method of claim 19, wherein the TA reporting information comprises at least one of:
a current TA value associated with the wireless device;
a propagation delay associated with communications between the wireless device and a base station;
a propagation delay associated with communications between the wireless device and a reference point in a network;
a location of the wireless device; or
a device-specific timing offset associated with the wireless device.
